(19) United States
(12) Patent Application Publication
(10) Pub. No.: US 2025/0392702 A1
(43) Pub. Date: Dec. 25, 2025

(54) VIDEO ENCODING METHOD AND APPARATUS, VIDEO DECODING METHOD AND APPARATUS, DEVICE, SYSTEM, AND STORAGE MEDIUM

(71) Applicant: GUANGDONG OPPO MOBILE TELECOMMUNICATIONS CORP., LTD., Dongguan (CN)

(72) Inventor: Luhang XU, Dongguan (CN)

(21) Appl. No.: 19/317,490

(22) Filed: Sep. 3, 2025

Related U.S. Application Data
(63) Continuation of application No. PCT/CN2023/080155, filed on Mar. 7, 2023.

(51) Int. Cl. H04N 19/107; H04N 19/159; H04N 19/176; H04N 19/196

(52) U.S. Cl. CPC H04N 19/107; H04N 19/159; H04N 19/176; H04N 19/196

(57) ABSTRACT

A video encoding method, a video decoding method and apparatus, and a storage medium are provided. The decoding method includes that: angular accuracy corresponding to the intra prediction mode candidate list is determined, the first angular accuracy is used for indicating a search range of an angular prediction mode in the intra-frame prediction mode candidate list; the intra prediction mode candidate list is constructed on the basis of the first angular accuracy; and the prediction for the current block is performed on the basis of the constructed intra prediction mode candidate list.

### CROSS-REFERENCE TO RELATED APPLICATION

This is a continuation application of International Patent Application No. PCT/CN2023/080155, filed on Mar. 7, 2023, the contents of which are hereby incorporated by reference in its entirety.

### BACKGROUND

A digital video technology may be integrated into multiple video apparatuses, such as a digital TV, a smart phone, a computer, an e-reader, or a video player, etc. With the development of the video technology, a large amount of data is included in video data. In order to facilitate transmission of the video data, the video apparatus performs a video compression technology to transmit or store the video data more efficiently.

Since there is a temporal or spatial redundancy in the video, the redundancy in the video may be eliminated or reduced through prediction, to improve compression efficiency. At present, in order to improve a prediction effect, a current block may be predicted by using multiple prediction modes, for example, an intra prediction mode candidate list is constructed, and multiple prediction modes are selected from the intra prediction mode candidate list, to predict the current block. However, the intra prediction mode candidate list constructed at present is not accurate enough, which reduces encoding and decoding effects of the current block.

### SUMMARY

Embodiments of the disclosure provide a method and apparatus for video encoding, a method and apparatus for video decoding, a device, a system, and a storage medium, which may improve accuracy of construction of the intra prediction mode candidate list, thereby improving accuracy of prediction for the current block, and improving encoding and decoding performance.

The disclosure relates to the field of video encoding and decoding technologies, and in particular to a method and apparatus for video encoding, a method and apparatus for video decoding, a device, a system, and a storage medium.

According to a first aspect, the disclosure provides a method for video decoding, the method is applied to a decoder, and includes the following operations.

A first angular accuracy corresponding to an intra prediction mode candidate list for a current block is determined, here the first angular accuracy indicates a search range of angular prediction modes in the intra prediction mode candidate list.

The intra prediction mode candidate list is constructed based on the first angular accuracy.

The current block is predicted based on the intra prediction mode candidate list, to acquire a prediction value for the current block.

According to a second aspect, an embodiment of the disclosure provides a method for video encoding, the method includes the following operations.

A first angular accuracy corresponding to an intra prediction mode candidate list for a current block is determined, here the first angular accuracy indicates a search range of angular prediction modes in the intra prediction mode candidate list.

The intra prediction mode candidate list is constructed based on the first angular accuracy.

The current block is predicted based on the intra prediction mode candidate list, to acquire a prediction value of the current block.

According to a third aspect, the disclosure provides an apparatus for video decoding, the apparatus is configured to perform the method in the above first aspect or implementations thereof. Specifically, the apparatus includes functional units configured to perform the method in the above first aspect or implementations thereof.

### BRIEF DESCRIPTION OF THE DRAWINGS

FIG. 1 is a schematic block diagram of a video encoding and decoding system involved in an embodiment of the disclosure.

FIG. 2 is a schematic block diagram of a video encoder involved in an embodiment of the disclosure.

FIG. 3 is a schematic block diagram of a video decoder involved in an embodiment of the disclosure.

FIG. 4A is a schematic diagram of intra prediction.

FIG. 4B is a schematic diagram of intra prediction.

FIG. 5A to FIG. 5I are schematic diagrams of intra prediction.

FIG. 6 is a schematic diagram of an intra prediction mode.

FIG. 7 is a schematic diagram of an intra prediction mode.

FIG. 8 is a schematic diagram of an intra prediction mode.

FIG. 9 is a schematic diagram of neighbouring blocks.

FIG. 10 is a schematic diagram of a Matrix-based Intra Prediction (MIP).

FIG. 11 is a schematic diagram of weight allocation.

FIG. 12 is a schematic diagram of weight allocation.

FIG. 13 is a schematic diagram of templates.

FIG. 14A is a schematic diagram of a Decoder-side Intra Mode Derivation (DIMD) principle.

FIG. 14B is a schematic diagram of a Template-based Intra Mode Derivation (TIMD) principle.

FIG. 15A to FIG. 15D are schematic diagrams of a Position-Dependent Intra Prediction Combination (PDPC) principle.

FIG. 16 is a schematic flowchart of a method for video decoding according to an embodiment of the disclosure.

FIG. 17 is a schematic diagram of neighbouring positions.

FIG. 18 is another schematic diagram of neighbouring positions.

FIG. 19 is a schematic diagram of neighbouring positions and non-neighbouring positions.

FIG. 20 is another schematic diagram of neighbouring positions and non-neighbouring positions.

FIG. 21 is a schematic diagram of correspondences between angular directions and indices of a traditional prediction mode.

FIG. 22 is a schematic diagram of reconstructed pixels.

FIG. 23 is a schematic flowchart of a method for video encoding according to an embodiment of the disclosure.

FIG. 24 is a schematic block diagram of an apparatus for video decoding according to an embodiment of the disclosure.

FIG. 25 is a schematic block diagram of an apparatus for video encoding according to an embodiment of the disclosure;

FIG. 26 is a schematic block diagram of an electronic device according to an embodiment of the disclosure.

FIG. 27 is a schematic block diagram of a video encoding and decoding system according to an embodiment of the disclosure.

### DETAILED DESCRIPTION

The disclosure may be applied to the field of picture encoding and decoding, the field of video encoding and decoding, the field of video encoding and decoding through hardware, the field of video encoding and decoding through a dedicated circuit, the field of real-time video encoding and decoding, etc. For example, solutions of the disclosure may be combined with an Audio Video coding Standard (abbreviated as AVS), such as a H.264/Audio Video Coding (abbreviated as AVC) standard, a H.265/High Efficiency Video Coding (abbreviated as HEVC) standard, and a H.266/Versatile Video Coding (abbreviated as VVC) standard. Alternatively, the solutions of the disclosure may be operated in combination with other proprietary or industry standards, and the standards include ITU-TH.261, ISO/IECMPEG-1 Visual, ITU-TH.262 or ISO/IECMPEG-2Visual, ITU-TH.263, ISO/IECMPEG-4Visual, ITU-TH.264 (also referred to as ISO/IECMPEG-4AVC), including Scalable Video Codec (SVC) and Multiview Video Codec (MVC) extensions. It should be understood that technologies of the disclosure are not limited to any specific encoding and decoding standard or technology.

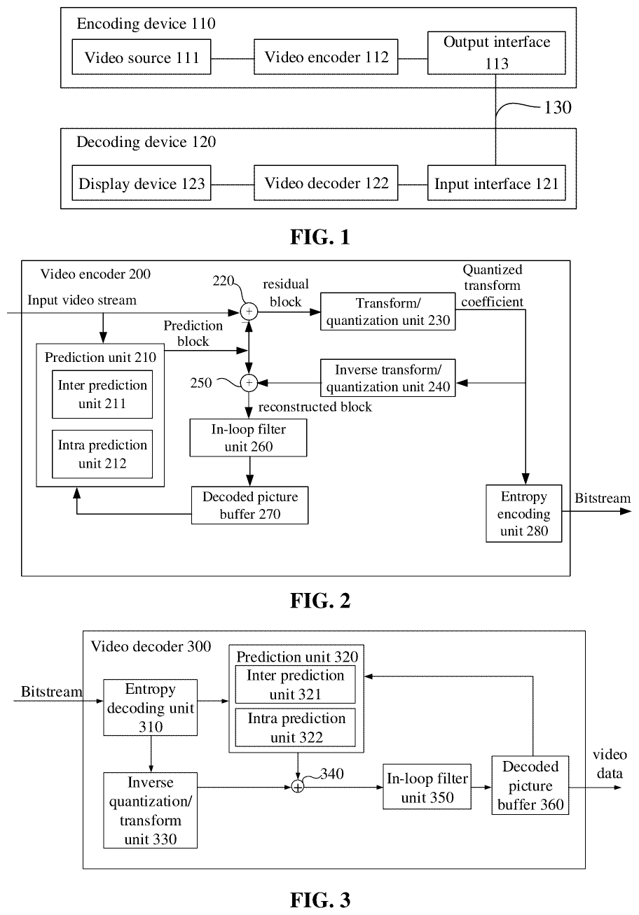

In order to facilitate understanding, a video encoding and decoding system involved in the embodiments of the disclosure is introduced first with reference to FIG. 1.

FIG. 1 is a schematic block diagram of a video encoding and decoding system involved in an embodiment of the disclosure. It should be noted that FIG. 1 is only an example, and the video encoding and decoding system of the embodiment of the disclosure includes, but is not limited to that shown in FIG. 1. As shown in FIG. 1, the video encoding and decoding system 100 includes an encoding device 110 and a decoding device 120. The encoding device is configured to encode (which may be understood as “compress”) video data to generate a bitstream, and transmit the bitstream to the decoding device. The decoding device decodes the bitstream generated by the encoding device, to acquire decoded video data.

The encoding device 110 of the embodiment of the disclosure may be understood as a device with a video encoding function, and the decoding device 120 may be understood as a device with a video decoding function, that is, the embodiment of the disclosure includes a wider range of devices for the encoding device 110 and the decoding device 120, for example, the devices include a smartphone, a desktop computer, a mobile computing device, a notebook (such as laptop) computer, a tablet computer, a set-top box, a TV, a camera, a display device, a digital media player, a video game console, a vehicle-mounted computer, etc.

In some embodiments, the encoding device 110 may transmit encoded video data (such as the bitstream) to the decoding device 120 through a channel 130. The channel 130 may include one or more media and/or devices capable of transmitting the encoded video data from the encoding device 110 to the decoding device 120.

In an example, the channel 130 includes one or more communication media that enable the encoding device 110 to directly transmit the encoded video data to the decoding device 120 in real time. In this example, the encoding device 110 may modulate the encoded video data according to a communication standard, and transmit the modulated video data to the decoding device 120. The communication media include a wireless communication medium, such as a Radio Frequency (RF) spectrum. Optionally, the communication media may also include a wired communication medium, such as one or more physical transmission lines.

In another example, the channel 130 includes a storage medium, and the storage medium may store the encoded video data from the encoding device 110. The storage medium includes multiple locally accessible data storage media, such as an optical disk, a Digital Video Disc (DVD), a flash memory, etc. In this example, the decoding device 120 may acquire the encoded video data from the storage medium.

In another example, the channel 130 may include a storage server, and the storage server may store the encoded video data from the encoding device 110. In this example, the decoding device 120 may download the stored encoded video data from the storage server. Optionally, the storage server may store the encoded video data and transmit the encoded video data to the decoding device 120, for example, the storage server is a web server (such as, used for a website), a File Transfer Protocol (FTP) server, etc.

In some embodiments, the encoding device 110 includes a video encoder 112 and an output interface 113. The output interface 113 may include a modulator/demodulator (modem) and/or a transmitter.

In some embodiments, the encoding device 110 may include a video source 111 in addition to the video encoder 112 and the output interface 113.

The video source 111 may include at least one of a video acquisition device (such as a video camera), a video archive, a video input interface, or a computer graphics system. The video input interface is configured to receive video data from a video content provider, and the computer graphics system is configured to generate video data.

The video encoder 112 encodes the video data from the video source 111, to generate a bitstream. The video data may include one or more pictures or a sequence of pictures. The bitstream includes encoded information of the pictures or the sequence of pictures in form of a bit stream. The encoded information may include encoded picture data and associated data. The associated data may include a Sequence Parameter Set (abbreviated as SPS), a Picture Parameter Set (abbreviated as PPS) and other syntax structures. The SPS may include parameters applied to one or more sequences. The PPS may include parameters applied to one or more pictures. The syntax structure refers to a set of zero or multiple syntax elements arranged in a specified order in the bitstream.

The video encoder 112 directly transmits the encoded video data to the decoding device 120 through the output interface 113. The encoded video data may also be stored in a storage medium or a storage server for subsequently reading by the decoding device 120.

In some embodiments, the decoding device 120 includes an input interface 121 and a video decoder 122.

In some embodiments, the decoding device 120 may include a display device 123 in addition to the input interface 121 and the video decoder 122.

The input interface 121 includes a receiver and/or a modem. The input interface 121 may receive the encoded video data through the channel 130.

The video decoder 122 is configured to decode the encoded video data to acquire decoded video data, and transmit the decoded video data to the display device 123.

The decoded video data is displayed on the display device 123. The display device 123 may be integrated with the decoding device 120 or located externally to the decoding device 120. The display device 123 may include multiple display devices, such as a Liquid Crystal Display (LCD), a plasma display, an Organic Light Emitting Diode (OLED) display, or other types of display devices.

Furthermore, FIG. 1 is only an example, and the technical solutions of the embodiments of the disclosure are not limited to FIG. 1. For example, the technologies of the disclosure may also be applied to video encoding at a single side or video decoding at a single side.

A video coding framework involved in an embodiment of the disclosure will be introduced below.

FIG. 2 is a schematic block diagram of a video encoder involved in an embodiment of the disclosure. It should be understood that the video encoder 200 may be configured to perform lossy compression on a picture, or may be configured to perform lossless compression on the picture. The lossless compression may be visually lossless compression or mathematically lossless compression.

The video encoder 200 may be applied to picture data in a luma and chroma (YCbCr, YUV) format. For example, a ratio of YUV may be 4:2:0, 4:2:2 or 4:4:4, Y represents luma, Cb(U) represents blue chroma, Cr(V) represents red chroma, and U and V represent chroma to describe colour and saturation. For example, in a colour format, 4:2:0 means that every 4 pixels have 4 luma components and 2 chroma components (YYYYCbCr), 4:2:2 means that every 4 pixels have 4 luma components and 4 chroma components (YYYYCbCrCbCr), and 4:4:4 means full-pixel display (YYYYCbCrCbCrCbCrCbCr).

For example, the video encoder 200 reads video data, and for each picture of the video data, the video encoder 200 partitions a picture into several Coding Tree Units (CTUs). In some examples, CTB may be referred to as a “tree block”, a “Largest Coding Unit” (abbreviated as LCU) or a “Coding Tree Block” (abbreviated as CTB). Each CTU may be associated with a pixel block of equal size within the picture. Each pixel may correspond to one luma (luminance or luma) sample and two chroma (chrominance or chroma) samples. Therefore, each CTU may be associated with one luma sample block and two chroma sample blocks. For example, the CTU has a size of 128×128, 64×64, 32×32, etc. The CTU may be further continuously partitioned into several Coding Units (CUs) for encoding, and the CU may be a rectangular block or a square block. The CU may be further partitioned into Prediction Units (abbreviated as PUs) and Transform Units (abbreviated as TUs), such that encoding, prediction and transform are separated for more flexible processing. In an example, the CTU is partitioned into CUs in a quadtree manner, and the CU is partitioned into the TU and the PU in a quadtree manner.

The video encoder and the video decoder may support various PU sizes. Assuming that a particular CU has a size of 2N×2N, the video encoder and the video decoder may support PU sizes of 2N×2N or N×N for intra prediction, and support symmetric PUs with sizes of 2N×2N, 2N×N, N×2N, N×N or similar sizes for inter prediction. The video encoder and the video decoder may also support asymmetric PUs with sizes of 2N×nU, 2N×nD, nL×2N and nR×2N for inter prediction.

In some embodiments, as shown in FIG. 2, the video encoder 200 may include a prediction unit 210, a residual unit 220, a transform/quantization unit 230, an inverse transform/quantization unit 240, a reconstruction unit 250, an in-loop filter unit 260, a decoded picture buffer 270, and an entropy encoding unit 280. It should be noted that the video encoder 200 may include more, fewer, or different functional components.

Optionally, in the disclosure, a current block may be referred to as a current CU or a current PU, etc. A prediction block may also be referred to as a prediction picture block or a picture prediction block, and a reconstructed picture block may also be referred to as a reconstructed block or a picture-reconstruction picture block.

In some embodiments, the prediction unit 210 includes an inter prediction unit 211 and an intra prediction unit 212. Since there is a strong correlation between neighbouring pixels in a picture of a video, an intra prediction method is used in video encoding and decoding technologies to eliminate a spatial redundancy between neighbouring pixels. Since there is a strong similarity between neighbouring pictures in a video, an inter prediction method is used in video encoding and decoding technologies to eliminate a temporal redundancy between neighbouring pictures, thereby improving encoding efficiency.

The inter prediction unit 211 may be used for inter prediction. The inter prediction may include motion estimation and motion compensation, and may refer to picture information of different pictures. The inter prediction finds a reference block from a reference picture by using motion information, and generates a prediction block according to the reference block, to eliminate the temporal redundancy. Pictures used for the inter prediction may be a P picture and/or a B picture, the P picture refers to a forward prediction picture, and the B picture refers to a bi-directional prediction picture. The inter prediction finds a reference block from a reference picture by using motion information, and generates a prediction block according to the reference block. The motion information includes a reference picture list where the reference picture is located, a reference picture index, and a motion vector. The motion vector may be integer pixel or fractional pixel. If the motion vector is fractional pixel, it needs to use interpolation filtering in the reference picture, to generate a required fractional pixel block. Here, the integer pixel or fractional pixel block in the reference picture found based on the motion vector is referred to as the reference block. Some technologies may directly use the reference block as the prediction block, and some technologies may generate a prediction block by further processing based on the reference block. “generate a prediction block by further processing based on the reference block” may also be understood as using the reference block as prediction block, and then processing based on the prediction block to generate a new prediction block.

The intra prediction unit 212 refers to only information of the same picture, to predict pixel information in a current picture block to eliminate the spatial redundancy. Pictures used for the intra prediction may be an I picture.

There are multiple prediction modes for the intra prediction. Taking an H series of international digital video coding standards as an example, the H.264/AVC standard has 8 angular prediction modes and 1 non-angular prediction mode, and H.265/HEVC is extended to 33 angular prediction modes and 2 non-angular prediction modes. Intra prediction modes used for HEVC include a planar mode (Planar), Direct Current (DC) and 33 angular modes, which are 35 prediction modes in total. Intra modes used for VVC include Planar, DC and 65 angular modes, which are 67 prediction modes in total.

It should be noted that with the increase of angular modes, the intra prediction will be more accurate and comply with requirements of development of high-definition and ultra-high-definition digital videos better.

The residual unit 220 may generate a residual block for the CU based on a pixel block of the CU and a prediction block for the PU of the CU. For example, the residual unit 220 may generate the residual block for the CU, such that each sample in the residual block has a value equal to a difference between a sample in the pixel block of the CU and a corresponding sample in the prediction block for the PU of the CU.

The transform/quantization unit 230 may quantize transform coefficients. The transform/quantization unit 230 may quantize transform coefficients associated with the TU of the CU based on a Quantization Parameter (QP) value associated with the CU. The video encoder 200 may adjust a degree of quantization applied to the transform coefficients associated with the CU by adjusting the QP value associated with the CU.

The inverse transform/quantization unit 240 may apply inverse quantization and inverse transform to quantized transform coefficients respectively, to reconstruct the residual block from the quantized transform coefficients.

The reconstruction unit 250 may add samples of the reconstructed residual block to corresponding samples of one or more prediction blocks generated by the prediction unit 210, to generate reconstructed picture block associated with the TU. By reconstructing the sample block of each TU of the CU in this manner, the video encoder 200 may reconstruct the pixel block of the CU.

The in-loop filter unit 260 is configured to process the inverse transformed and inverse quantized pixels, to compensate for distortion information and provide a better reference for encoding the pixels subsequently. For example, the in-loop filter unit 260 may perform a deblocking filtering, to reduce block effects of the pixel blocks associated with the CU.

In some embodiments, the in-loop filter unit 260 includes a deblocking filter unit and a Sample Adaptive Offset/Adaptive Loop Filter (SAO/ALF) unit, here the deblocking filter unit is configured to remove the block effects, and the SAO/ALF unit is configured to remove a ringing artifacts.

The decoded picture buffer 270 may store the reconstructed pixel blocks. The inter prediction unit 211 may perform inter prediction on PU(s) of other pictures by using a reference picture including the reconstructed pixel blocks. Furthermore, the intra prediction unit 212 may perform the intra prediction on other PU(s) in the same picture as the CU by using the reconstructed pixel blocks in the decoded picture buffer 270.

The entropy encoding unit 280 may receive the quantized transform coefficients from the transform/quantization unit 230. The entropy encoding unit 280 may perform one or more entropy encoding operations on the quantized transform coefficients, to generate entropy-encoded data.

FIG. 3 is a schematic block diagram of a video decoder involved in an embodiment of the disclosure.

As shown in FIG. 3, the video decoder 300 includes an entropy decoding unit 310, a prediction unit 320, an inverse quantization/transform unit 330, a reconstruction unit 340, a in-loop filter unit 350, and a decoded picture buffer 360. It should be noted that the video decoder 300 may include more, fewer, or different functional components.

The video decoder 300 may receive a bitstream. The entropy decoding unit 310 may parse the bitstream to extract syntax elements from the bitstream. As a part of parsing the bitstream, the entropy decoding unit 310 may parse entropy-encoded syntax elements in the bitstream. The prediction unit 320, the inverse quantization/transform unit 330, the reconstruction unit 340, and the in-loop filter unit 350 may decode video data, that is, generate decoded video data, according to the syntax elements extracted from the bitstream.

In some embodiments, the prediction unit 320 includes an intra prediction unit 322 and an inter prediction unit 321.

The intra prediction unit 322 may perform intra prediction to generate a prediction block for the PU. The intra prediction unit 322 may use an intra prediction mode to generate the prediction block for the PU based on pixel block(s) of spatially neighbouring PU(s). The intra prediction unit 322 may also determine an intra prediction mode for the PU based on one or more syntax elements parsed from the bitstream.

The inter prediction unit 321 may construct a first reference picture list (list 0) and a second reference picture list (list 1) based on the syntax element(s) parsed from the bitstream. Furthermore, if the PU is encoded by using the inter prediction, the entropy decoding unit 310 may parse motion information of the PU. The inter prediction unit 321 may determine one or more reference blocks for the PU based on the motion information of the PU. The inter prediction unit 321 may generate a prediction block for the PU based on one or more reference blocks of the PU.

The inverse quantization/transform unit 330 may inversely quantize (that is, de-quantize) transform coefficients associated with the TU. The inverse quantization/transform unit 330 may use a QP value associated with the CU of the TU to determine a degree of quantization.

After inverse quantizing the transform coefficients, the inverse quantization/transform unit 330 may apply one or more inverse transforms to the inverse quantized transform coefficients, to generate a residual block associated with the TU.

The reconstruction unit 340 uses the residual block associated with the TU of the CU and the prediction block for the PU of the CU, to reconstruct the pixel block of the CU. For example, the reconstruction unit 340 may add samples of the residual blocks to corresponding samples of the prediction blocks, to reconstruct the picture block of the CU, to acquire reconstructed picture block.

The in-loop filtering unit 350 may perform a deblocking filtering, to reduce block effect of the pixel block associated with the CU.

The video decoder 300 may store a reconstructed picture of the CU in the decoded picture buffer 360. The video decoder 300 may use the reconstructed picture in the decoded picture buffer 360 as a reference picture for subsequent prediction, or transmit the reconstructed picture to a display device for rendering.

A basic flow of video encoding and decoding is as follows. At an encoding end, a picture is partitioned into blocks, and for the current block, the prediction unit 210 generates a prediction block for the current block by using the intra prediction or the inter prediction. The residual unit 220 may calculate a residual block based on an original block of the current block and the prediction block, that is, a difference between the original block of the current block and the prediction block, and the residual block may also be referred to as residual information. Transform and quantization or other processes are performed on the residual block through the transform/quantization unit 230, which can remove information that is not sensitive to human eyes, to eliminate visual redundancy. Optionally, the residual block before performing transform and quantization through the transform/quantization unit 230 may be referred to as a temporal residual block, and the temporal residual block after performing transform and quantization through the transform/quantization unit 230 may be referred to as a frequency residual block or frequency-domain residual block. The entropy encoding unit 280 receives quantized transform coefficients output by the transform/quantization unit 230, and may perform entropy encoding on the quantized transform coefficients and output a bitstream. For example, the entropy encoding unit 280 may eliminate character redundancy based on a target context model and probability information of a binary bitstream.

At a decoding end, the entropy decoding unit 310 may parse the bitstream to acquire prediction information, a quantization coefficient matrix, or the like for the current block. The prediction unit 320 uses the intra prediction or the inter prediction for the current block based on the prediction information, to generate a prediction block of the current block. The inverse quantization/transform unit 330 uses the quantization coefficient matrix acquired from the bitstream to perform inverse quantization and inverse transform on the quantization coefficient matrix, to acquire a residual block. The reconstruction unit 340 adds the prediction block to the residual block to acquire the reconstructed block. The reconstructed blocks constitute a reconstructed picture, and the in-loop filtering unit 350 performs in-loop filtering on the reconstructed picture based on the picture or blocks, to acquire a decoded picture. The encoding end also requires operations similar to those at the decoding end, to acquire a decoded picture. The decoded picture may also be referred to as a reconstructed picture, and the reconstructed picture may be used as a reference picture for the inter prediction of subsequent pictures.

It should be noted that block partitioning information determined by the encoding end, as well as mode information or parameter information such as prediction, transform, quantization, entropy encoding, in-loop filtering or the like are signalled in the bitstream if necessary. The decoding end parses the bitstream, and determines the same block partitioning information, as well as mode information or parameter information such as prediction, transform, quantization, entropy encoding, in-loop filtering or the like as the encoding end by analyzing based on existing information, thereby ensuring that the decoded picture acquired by the encoding end is identical to the decoded picture acquired by the decoding end.

The above descriptions are the basic flow of video encoding and decoding under a block-based hybrid coding framework. With the development of technologies, some modules or operations of the framework or flow may be optimized. The disclosure is applicable to the basic flow of video encoding and decoding under the block-based hybrid coding framework, but is not limited to the framework and flow.

In the embodiments of the disclosure, the current block may be the current CU or the current PU, etc. Due to requirements of parallel processing, a picture may be partitioned into slices, etc. Slices in the same picture may be processed in parallel, that is, there is no data dependency between the slices. Furthermore, “frame” is a commonly used term, and it may be usually understood that a frame is a picture. In the disclosure, the frame may also be replaced by the picture or the slice, etc.

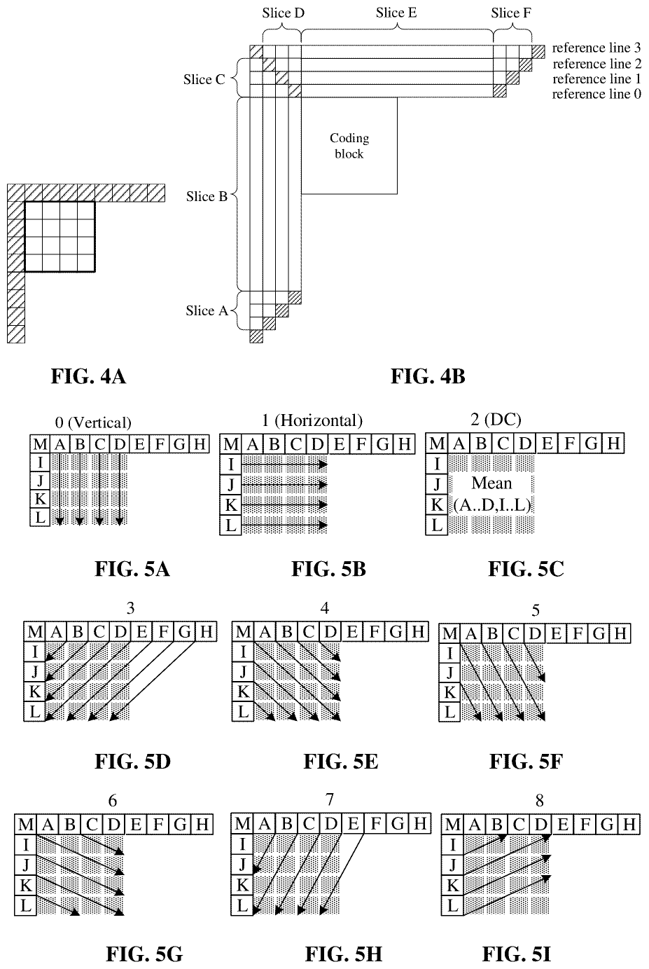

The intra prediction usually predicts a current coding block by means of angular modes and non-angular modes, to acquire a prediction block. Based on rate distortion information calculated from the prediction block and the original block, an optimal prediction mode for the current coding unit is selected, and then this prediction mode is transmitted to the decoding end through the bitstream. The decoding end parses the prediction mode, to predict and acquire a predicted picture for a current coding block, and then adds the predicted picture to residual pixels transmitted through the bitstream, to acquire the reconstructed picture. An intra prediction method uses reconstructed pixels (that have been encoded and decoded) around the current block as reference pixels to predict the current block. FIG. 4A is a schematic diagram of intra prediction. As shown in FIG. 4A, the current block has a size of 4×4, and pixels in a left row and an above column of the current block are reference pixels of the current block. The intra prediction performs the prediction for the current block by using these reference pixels. All of these reference pixels may be available, that is, all of these reference pixels have been encoded/decoded. Alternatively, part of these reference pixels may be unavailable, for example, if the current block is at the leftmost of the entire frame, then reference pixels at the left of the current block are unavailable. Alternatively, when the current block is encoded/decoded, and a bottom-left part of the current block has not been encoded/decoded, reference pixels at the bottom-left are also unavailable. In case that reference pixels are unavailable, padding may be performed by using available reference pixels or certain values or methods, or no padding may be performed.

FIG. 4B is a schematic diagram of intra prediction. As shown in FIG. 4B, a Multiple Reference Line (MRL) intra prediction method may use more reference pixels to improve encoding and decoding efficiency, for example, 4 reference rows/columns are used as reference pixels of the current block.

Furthermore, there are multiple prediction modes for the intra prediction. FIG. 5A to FIG. 5I are schematic diagrams of intra prediction. As shown in FIG. 5A to FIG. 5I, intra prediction performed on a 4×4 block in H.264 may mainly include 9 modes. Mode 0 as shown in FIG. 5A copies pixels above the current block to the current block in a vertical direction, to be used as prediction values; mode 1 as shown in FIG. 5B copies reference pixels at the left of the current block to the current block in a horizontal direction, to be used as prediction values; mode 2 of DC as shown in FIG. 5C uses an average value of 8 points A to D and I to L as a prediction value of all points, and modes 3-8 as shown in FIG. 5D to FIG. 5I copy reference pixels of the current block to corresponding positions of the current block at a certain angle respectively, since some positions of the current block cannot correspond to the reference pixels exactly, and in this case, it may need to use a weighted average value of the reference pixels, or fractional pixels of interpolated reference pixels.

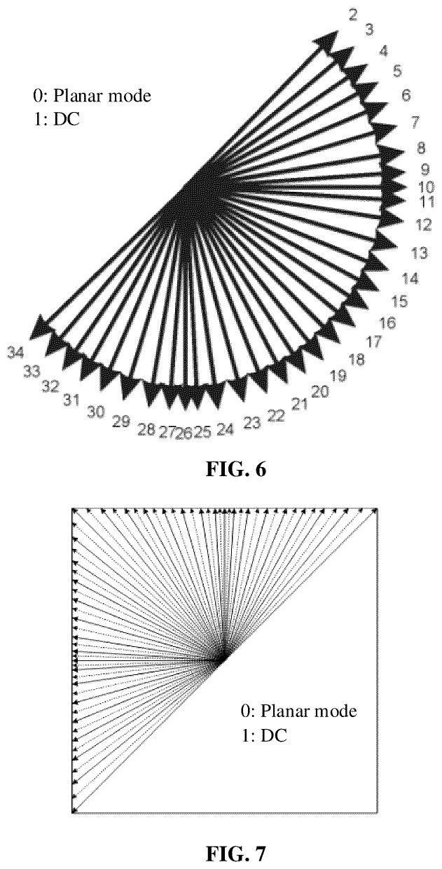

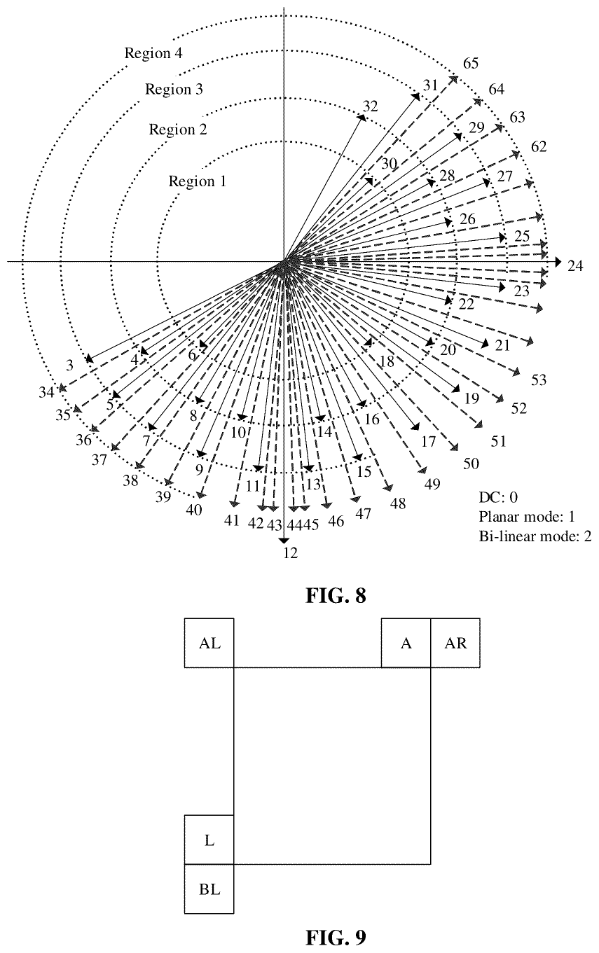

In addition, there are modes such Plane mode and Planar mode. With the development of technologies and expansion of blocks, the number of angular prediction modes also increases. FIG. 6 is a schematic diagram of an intra prediction mode. As shown in FIG. 6, intra prediction modes used in HEVC include Planar, DC and 33 angular modes, which are 35 prediction modes in total. FIG. 7 is a schematic diagram of an intra prediction mode. As shown in FIG. 7, intra modes used in VVC include Planar, DC and 65 angular modes, which are 67 prediction modes in total. FIG. 8 is a schematic diagram of an intra prediction mode. As shown in FIG. 8, VS3 uses DC, Plane, Bilinear, PCM and 62 angular modes, which are 66 prediction modes in total.

Furthermore, there are also some technologies to improve prediction, for example, improving interpolation of fractional pixels of reference pixels, filtering predicted pixels, etc. For example, a Multiple Intra Prediction Filter (MIPF) in AVS3 uses different filters for different block sizes, to generate prediction values. For pixels at different positions in the same block, one filter is used for pixels close to the reference pixel, to generate prediction values; and another filter is used for pixels away from the reference pixel, to generate prediction values. Technologies for filtering the predicted pixels, such as an Intra Prediction Filter (IPF) in AVS3, may filter the prediction values by using the reference pixels.

According to statistical characteristics, pixel regions closer to the current block is often more likely to select the same (intra) prediction mode as the current block. Based on such characteristics, a Most Probable Mode (MPM) technology is used in HEVC, VVC and Enhanced Compression Model (ECM) (based on a VTM-10.0 reference software, which is a reference software integrating various new tools to further explore encoding and decoding performance). An intra mode encoding technology with a MPM list (MPM) may be used in the intra prediction to improve encoding and decoding efficiency. A mode list is constituted by using intra prediction modes (such as neighbouring modes) of surrounding encoded/decoded blocks, intra prediction modes derived based on the intra prediction modes of surrounding encoded/decoded blocks, and some intra prediction modes that are commonly used or used in a relative high probability, such as DC, Planar, Bilinear mode, etc. A spatial correlation is used when reference is made to the intra prediction modes of surrounding encoded/decoded blocks. Since textures may have a certain degree of continuity in space. The MPM may be serve as a prediction of the intra prediction mode. That is, it is considered that a probability of using the MPM for the current block may be higher than a probability of not using the MPM for the current block. Therefore, during binarization, fewer codewords may be used for the MPM, thereby saving overhead and improving encoding and decoding efficiency. The MPM in the ECM are classified into an MPM and a secondary MPM. The MPM and the secondary MPM are lists with lengths of 6 and 16 respectively. The MPM list is filled with intra prediction modes that are most likely to be selected for the current prediction block. As shown in FIG. 9, these modes are determined by intra prediction modes selected for blocks at the above-left (AL), above (A), above-right (AR), left (L) and bottom-left (BL) positions of the current block, as well as intra prediction modes similar to these modes.

The secondary MPM in the ECM is composed of some main angles other than the MPM.

Specifically, among six modes in the MPM in the ECM, the Planar mode is always at a first position of the MPM, and the remaining five positions sequentially occur by the following three operations. If there are more than five modes, the extra modes will automatically enter the secondary MPM.
a) Prediction modes selected for five surrounding neighbouring prediction blocks.
b) Modes derived from surrounding reconstructed pixels based on a gradient histogram.
c) Angles related to two angular modes derived first in operations a) and b).

When existing intra prediction modes are insufficient to fill up both the MPM and the secondary MPM, modes in a default intra mode list are used to fill up both the MPM and the secondary MPM without repetition.

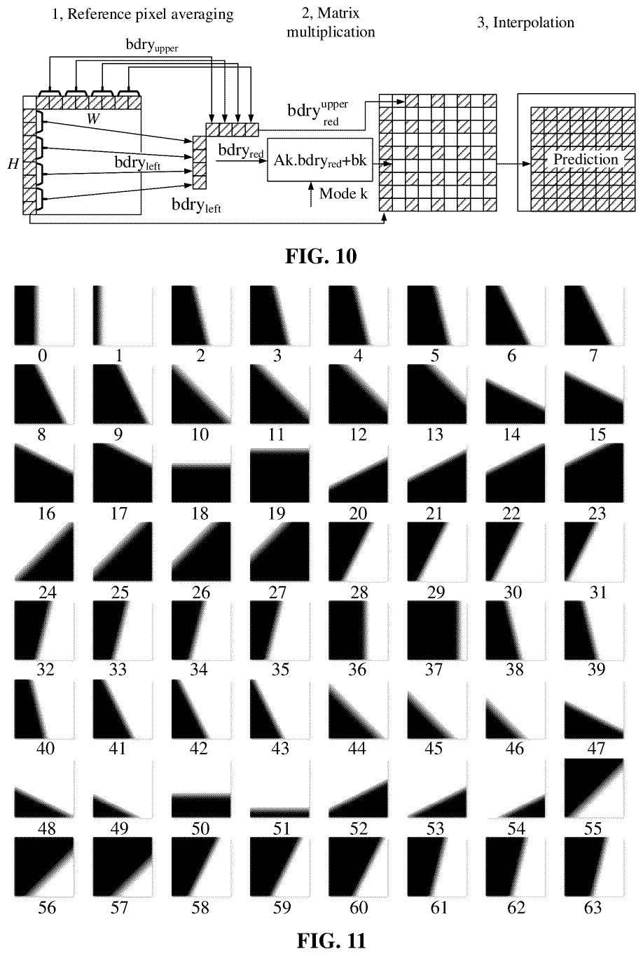

In some embodiments, a Matrix-based Intra Prediction (MIP) (which is also called as Matrix weighted Intra Prediction) may be used for the intra prediction. As shown in FIG. 10, in order to predict a block with a width of W and a height of H, the MIP requires H reconstructed pixels in a column at the left side of the current block and W reconstructed pixels in a row at the upper side of the current block as inputs. The MIP generates a prediction block in the following three operations: reference pixel averaging (Averaging), matrix multiplication (Matrix Vector Multiplication), and interpolation (Interpolation). The matrix multiplication is a core of the MIP. The MIP may be considered as a process of generating a prediction block by using input pixels (reference pixels) in a matrix multiplication manner. The MIP provides multiple matrices, and difference in prediction manners is reflected by difference in matrices. Different results may be acquired from the same input pixel using different matrices. Processes of the reference pixel averaging and the interpolation are a design that balances performance and complexity. For a block with a larger size, an effect similar to downsampling may be achieved through the reference pixel averaging, such that the inputs may be adapted to a relatively small matrix, while an upsampling effect is achieved through the interpolation. In this way, it is unnecessary to provide a MIP matrix for each size of block, instead, only matrices for one or more specific sizes may be provided. With the increase of requirements of compression performance and the improvement of hardware capabilities, MIPs with higher complexity may appear in a next generation of standards.

The MIP is somewhat similar to Planar, however, it is apparent that the MIP is more complex and more flexible than Planar.

In Versatile Video Coding (VVC) video encoding and decoding standards under development at present, there is an inter prediction mode referred to as Geometric Partitioning Mode (GPM). In Audio Video coding Standard (AVS) video encoding and decoding standards under development at present, there is an inter prediction mode referred to as Angular Weighted Prediction (AWP). Although these two modes differ in name and specific implementation, they have some common in principle.

It should be noted that a traditional unidirectional prediction finds only a reference block with the same size as the current block; and a traditional bi-directional prediction uses two reference blocks with the same size as the current block, and a pixel value of each point in a prediction block is an average of corresponding positions of the two reference blocks, that is, each point in each reference block accounts for a proportion of 50%. A bi-directional weighted prediction allows proportions of the two reference blocks to be different, for example, each point in a first reference block accounts for a proportion of 75%, and each point in a second reference block accounts for a proportion of 25%. However, proportions of all points in the same reference block are the same. However, proportions of all points in the same reference block are the same. Some other optimization manners such as those using Decoder-side Motion Vector Refinement (DMVR) technology, a Bi-directional Optical Flow (BIO) or the like, may cause some variations of reference pixels or predicted pixels, which are unrelated to the above principles. The BIO may also be abbreviated as BDOF. Furthermore, the GPM or the AWP also uses two reference blocks with the same size as the current block; however, 100% of pixel values of corresponding positions of the first reference block are used at some pixel positions, and 100% of pixel values of corresponding positions of the second reference block are used at some pixel positions, and pixel values of corresponding positions of the two reference blocks are used in a certain proportion at a boundary region or a transition region. Weights of the boundary region are also gradually transitioned. Specifically, how these weights are distributed is determined by modes of the GPM or the AWP. A weight of each pixel position is determined based on the modes of the GPM or the AWP. Of course, in some cases, for example in case that the block has a very small size, it may not guarantee in some modes of the GPM or the AWP that 100% of the pixel values of the corresponding positions of the first reference block are certainly used at some pixel positions, and 100% of the pixel values of the corresponding positions of the second reference block are certainly used at some pixel positions. It may also be considered that the GPM or the AWP uses two reference blocks with sizes different from the current block, that is, by selecting only the necessary parts as reference blocks. That is, parts with weights not equal to 0 are used as reference blocks, and parts with weights equal to 0 are removal. This is an implementation problem, and is not the focus of discussion of the disclosure.

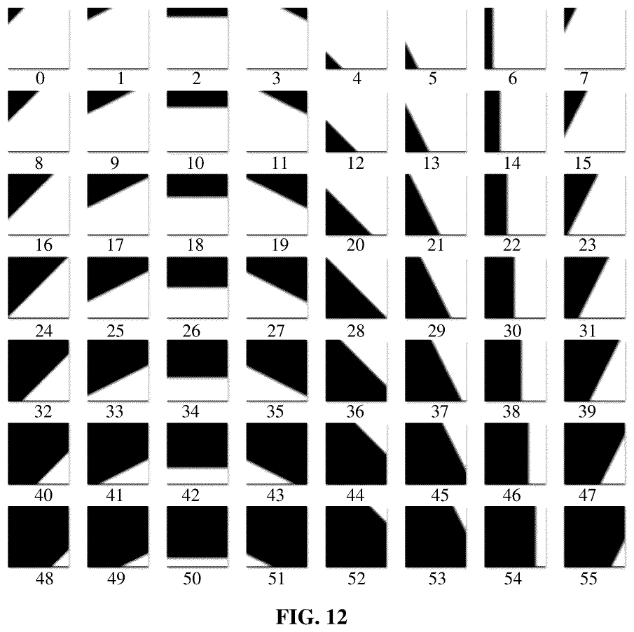

Exemplarily, FIG. 11 is a schematic diagram of weight allocation. As shown in FIG. 11, a schematic diagram of weight allocation of multiple partitioning modes of the GPM on a 64×64 current block according to an embodiment of the disclosure is shown, here the GPM has 64 partitioning modes. FIG. 12 is a schematic diagram of weight allocation. As shown in FIG. 12, a schematic diagram of weight allocation of multiple partitioning modes of the AWP on a 64×64 current block according to an embodiment of the disclosure is shown, here the AWP has 56 partitioning modes. No matter in FIG. 11 or FIG. 12, in each partitioning mode, a black region indicates that a weight value of a corresponding position of the first reference block is 0%, a white region indicates that a weight value of a corresponding position of the first reference block is 100%, a gray region indicates that a weight value of a corresponding position of the first reference block is a certain weight value greater than 0% and less than 100% based on different shades of colour, and a weight value of a corresponding position of the second reference block is a value acquired by subtracting the weight value of the corresponding position of the first reference block from 100%.

A GPM weight derivation method is that the GPM determines an angle and an offset based on each mode, and then calculates a weight matrix for each mode.

It should be understood that in early encoding and decoding technologies, all partitioning manners-whether for the CU, the PU or the TU-were limited to rectangular shape. However, the GPM achieves a non-rectangular partitioning effect for prediction without partitioning. The GPM uses a mask of weights of two reference blocks, that is, the above weight map. This mask determines weights of the two reference blocks when generating a prediction block; or, it may be simply understood that part of positions of the prediction block are sourced from the first reference block, part of the positions of the prediction block are sourced from the second reference block, and the transition region (a blending area) is acquired by weighting corresponding positions of the two reference blocks, such that the transition is smoother. The GPM does not partition the current block into two CUs or PUs based on a partitioning line, then transform, quantization, inverse transform, inverse quantization or the like of residuals after prediction are also performed by treating the current block as a whole.

From the above descriptions, the GPM is an inter partitioning prediction mode, which partitions an inter block to be predicted into two parts, and the two parts may use different intra prediction or inter prediction modes.

A Spatial Geometric Partition Mode (SGPM) is an intra partitioning prediction mode, which partitions an intra block to-be-predicted into two parts, and the two parts are predicted by using different intra prediction modes respectively.

In an ECM reference software, the SGPM supports 26 out of a total of 64 different direction or position partitions, compared to the GPM.

The 64 partitions include a total of 32 partitioning angles, which may be compared to traditional intra prediction angles in Table 1 below.

TABLE 1
Comparison table of indices of SGPM and GPM angle
partitioning and indices of intra prediction modes

| angleIdx | 0 | 1 | 2 | 3 | 4 | 5 | 6 | 7 |
|---|---|---|---|---|---|---|---|---|
| intraMode | 50 | 0 | 44 | 41 | 34 | 27 | 0 | 0 |
| angleIdx | 8 | 9 | 10 | 11 | 12 | 13 | 14 | 15 |
| intraMode | 18 | 0 | 0 | 9 | 66 | 59 | 56 | 0 |
| angleIdx | 16 | 17 | 18 | 19 | 20 | 21 | 22 | 23 |
| intraMode | 50 | 0 | 44 | 41 | 34 | 27 | 0 | 0 |
| angleIdx | 24 | 25 | 26 | 27 | 28 | 29 | 30 | 31 |
| intraMode | 18 | 0 | 0 | 9 | 66 | 59 | 56 | 0 |

angleIdx represents 32 partitioning angles, and intraMode represents indices of 67 traditional intra prediction modes (planar, DC and 65 angular modes).

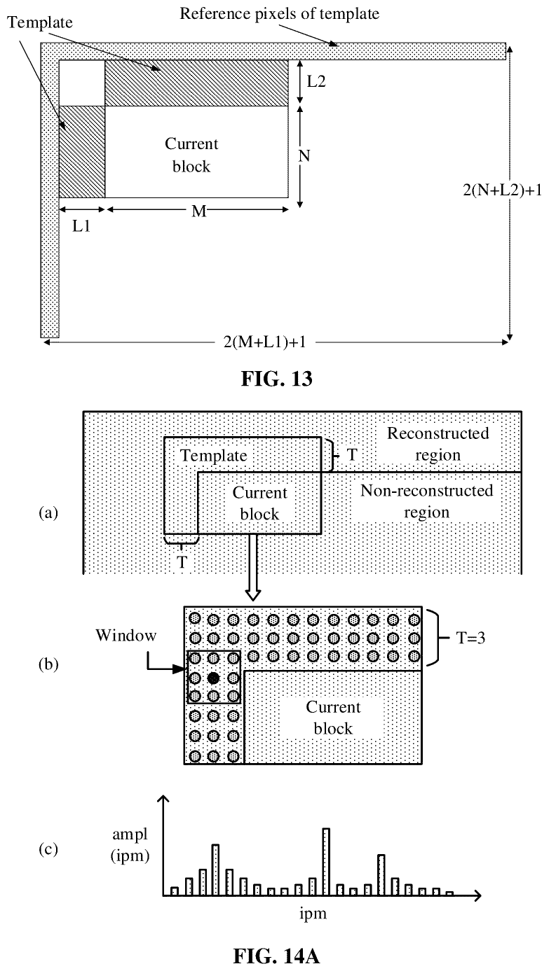

In some embodiments, a Template-based Intra Mode Derivation (TIMD) intra prediction technology may be used. The TIMD is a technology of deriving information of intra prediction modes by using several rows of pixel values reconstructed around the current prediction block, to derive one or more traditional intra prediction modes. Exemplarily, as shown in FIG. 13, for the current block, regions at left and upper sides of the current block are used as templates. Except for a case of boundary, during encoding or decoding the current block, reconstructed values may be acquired for regions at the left and upper sides of the current block theoretically. This is also a basis of many template matching methods. The TIMD uses regions at left and upper sides of the current block shown in FIG. 13 as templates, and pixels of regions at left and upper sides of the templates are used as reference pixels for the templates. The decoder may use a certain intra prediction mode to predict on the templates, and compare prediction values to reconstructed values to acquire a cost of this intra prediction mode on the templates. For example, a Sum of Absolute Differences (SAD), a Sum of Absolute Transformed Differences (SATD), a Sum of Squared Errors (SSE), etc. Since the templates and the current block are neighbouring each other and there is a correlation between them, performance of a prediction mode on the template may be used to estimate performance of the prediction mode on the current block. The TIMD uses some candidate intra prediction modes to predict on the templates, acquires their costs on the templates, and takes one or two intra prediction modes with lowest costs as intra prediction values for the current block.

It is found by research that if a difference between costs of two intra prediction modes on the template is not large, weighted averaging of prediction values of the two intra prediction modes may achieve improvement of compression performance. Weights of the prediction values of the two prediction modes are related to the above costs. In some embodiments, the weights are inversely proportional to the costs.

In general, the TIMD select intra prediction modes by using prediction effects of the intra prediction modes on the templates, and may weight the two intra prediction modes based on their costs on the templates. Advantages of the TIMD are that if the TIMD mode is selected for the current block, it is unnecessary to indicate which intra prediction mode is specifically used, instead, it is derived by the decoder itself through the above flows, which saves overhead to a certain extent.

In an ECM-7.0 reference software, a derivation method of the TIMD may derive at most four intra prediction modes: a TIMD mode (timdMode), a secondary TIMD mode (timdSecondaryMode), a TIMD horizontal mode (timdVer) and a TIMD vertical mode (timdHor) respectively. Different from 65 traditional angular prediction modes, the mode derived by the TIMD may be further angularly refined, further refined from 65 angles to 129 angles, that is, a finer angle may be added between every two originally neighbouring angles.

A standard for the TIMD to select intra prediction modes lies in values of costs at positions of the templates (the SATD is used as the cost in ECM). As shown in FIG. 13, an L2 row above the current block to be predicted is an upper template, an L1 column at the left of the current block is a left template, and values of a row of reconstructed pixels (Reference of the template) outside the regions of the templates are used as reference pixels, to predict on the regions of the templates in a given intra prediction mode. On the regions of the templates, there are SAD, SATD, SSE or other costs between reconstructed values and prediction results in the given prediction mode.

In the four intra prediction modes derived by the derivation method of the TIMD:
the TIMD mode (timdMode) is a mode with a minimum sum of SATD values on the upper template and the left template;
the secondary TIMD mode (timdSecondaryMode) is a mode with a second minimum sum of SATD values on the upper template and the left template;
the TIMD vertical mode (timdVer) is a mode with a minimum SATD value on the upper template;
the TIMD horizontal mode (timdHor) is a mode with a minimum SATD value on the left template.

In the current ECM, the TIMD mode and the secondary TIMD mode may be adaptively weighted, that is, a prediction result of the TIMD mode for the current block and a prediction result of the secondary TIMD mode for the current block are weighted. Whether weighting is performed and weights of the weighting are related to SATD values of the two modes.

Furthermore, the TIMD may also determine whether to finally use a prediction mode with a minimum SATD or to perform weighting for the mode with the minimum SATD and a mode with a second minimum SATD, according to the following manners.

Assuming that the TIMD mode is the mode with the minimum SATD and its SATD is cost0, and a second TIMD mode is the mode with the second minimum SATD and its SATD is cost1.

When cost10*2>cost1, prediction results of the two modes for the current block are weighted, otherwise, the prediction result of the TIMD mode is used directly.

Exemplarily, a weighting formula is shown in formula (1):

$$Pred = {Pred}_{timdMode} \times w 0 + P r e {d}_{timdSecondaryMode} \times w 1 \qquad ( 1 )$$

Pred_{timdMode} is the prediction result of the TIMD mode for the current prediction block, Pred_{timdSecondaryMode} is the prediction result of the second TIMD mode for the current prediction block,

$$w 0 = \frac{cost 1}{cost 0 + cost 1} , w 1 = \frac{cost 0}{cost 0 + cost 1} .$$

During actual implementation, in order to avoid floating point calculation and division calculation, a value of w0+w1 is scaled up to 64, and division calculations of w0 and w1 are also implemented by using look-up tables. A final weighting process is shown in formula (2):

$$Pred = ( P r e {d}_{timdMode} \times w 0 + P r e {d}_{timdSecondaryMode} \times w 1 ) >> 6 \qquad ( 2 )$$

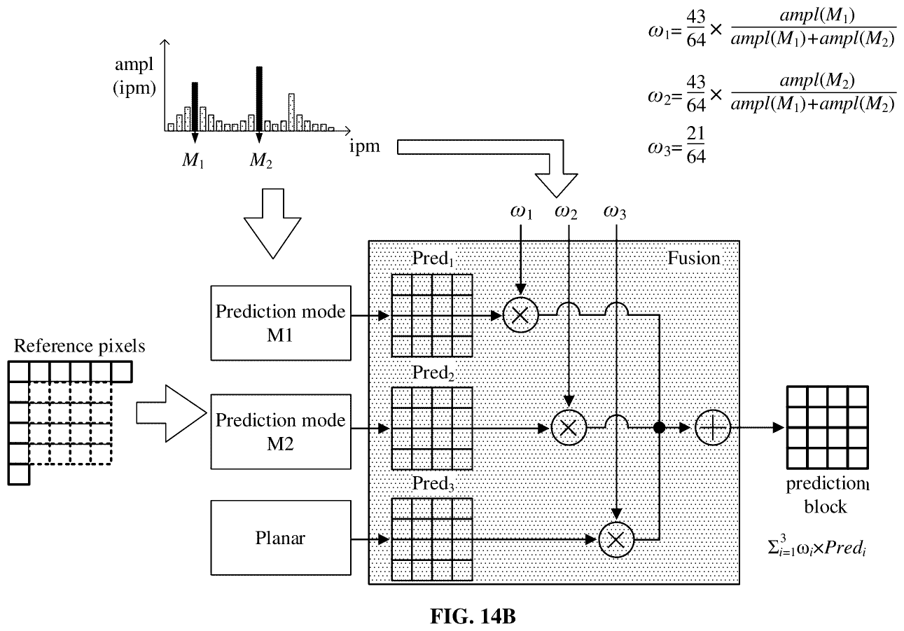

In some embodiments, a Decoder-side Intra Mode Derivation (DIMD) intra prediction technology may be used. As shown in FIG. 14A, the DIMD uses pixel values in T rows and T columns (T is equal to 3) of a reconstructed region around the current block as template, as shown in (a) of FIG. 14A; scans on each 3×3 region on the template through an operator sobel and calculates gradients in horizontal and vertical directions, as shown in (b) of FIG. 14A; and calculates an amplitude value Amp=Dx+Dy and an angle value angle=arctan (Dy/Dx) at each position based on gradients Dx and Dy calculated in horizontal and vertical directions. The angle of each position on the template corresponds to a traditional angular prediction mode. By sliding a window as shown in (b) of FIG. 14A, for multiple amplitude values and corresponding angle values of neighbouring reconstructed parts, amplitude values in the same angular mode are accumulated, to acquire a histogram of amplitude values and angular modes (as shown in (c) of FIG. 14A), and one or more angular modes are selected based on an ascending order of the amplitude values. One or more angular modes are modes derived by the DIMD.

When no angular mode can be derived from neighbouring reconstructed values, prediction mode of the DIMD will be set to a Planar prediction mode.

When one or more angular modes are derived, the prediction mode for the DIMD will be set to weighting of a result of Planar and a result of one and multiple angular prediction modes.

In an example, a prediction process of the DIMD is shown in FIG. 14B, where two intra prediction modes that are highest in the histogram, that is, intra prediction modes corresponding to M1 and M2 respectively, along with the planar mode, are selected, resulting in a total of three intra prediction modes. Weights ω1, ω2 and ω3 corresponding to the three intra prediction modes respectively are determined, and prediction values Pred1, Pred2 and Pred3 corresponding to the three intra prediction modes respectively are determined. The prediction values corresponding to the three intra prediction modes respectively are weighted based on the weights corresponding to the three intra prediction modes respectively, to acquire a final prediction block.

As may be known from the above descriptions, the DIMD selects intra prediction modes by using gradient analysis of reconstructed pixels, and may weight two intra prediction modes and planar mode based on results of the analysis. Advantages of the DIMD are that if the DIMD mode is selected for the current block, it is unnecessary to indicate which intra prediction mode is specifically used, instead, it is derived by the decoder itself through the above flows, which saves overhead to a certain extent.

The TIMD and the DIMD have many similarities, and even in some embodiments, their names are reversed. Both of them support weighting of prediction values of two or more intra prediction modes.

In some embodiments, a Template-based Multiple Reference Line intra prediction (abbreviated as TMRL) intra prediction technology may be used.

The TMRL intra prediction technology is newly adopted in ECM-7.0. The TMRL technology is a Multiple Reference Line (MRL) intra prediction technology based on template matching. A prediction process of the TMRL intra prediction technology may be substantially divided into the following two operations:
1) In a stage of parsing bitstream: the bitstream is parsed to determine that the TMRL technology is used for the current block, and a TMRL list index is further parsed;
2) In a stage of prediction and reconstruction stage of the current block: a TMRL candidate list is constructed first.

The selected element in a TMRL list is determined based on the TMRL candidate list and the decoded list index, each element is composed of an intra prediction mode and a reference line index. Prediction, reconstruction or other processes are performed on the current block by using the determined intra prediction mode and corresponding reference line.

Construction of the TMRL list is an operation that both the encoder and the decoder need to perform. It is applied to the candidate list, an actual selected reference line is determined based on an index (represented by encoding/decoding) in a reference line candidate list and a sorted candidate list, and then prediction is performed by using this reference line and the selected intra prediction mode (a traditional prediction mode).

The TMRL sorts at most 5×10 combinations of at most five predefined extended reference lines (reference lines 1, 3, 5, 7 and 12, depending on a position of the current block in the current CTU; less than five extended reference lines may be used) and ten predefined prediction modes, by using a SAD of prediction values (pred) and reconstructed values (reco) on template region.

Exemplarily, (x,−1) and (−1, y) are coordinates relative to a position of an upper left corner (0, 0) of the current block respectively, and a SAD corresponding to a region with 1 row and 1 column of the template is calculated according to formula (3):

$$S A D = {\sum }_{x = 0}^{w - 1} \vert pre {d}_{( x , - 1 )} - r e c {o}_{( x , - 1 )} \vert + {\sum }_{y = 0}^{h - 1} \vert pre {d}_{( - 1 , y )} - r e c {o}_{( - 1 , y )} \vert \qquad ( 3 )$$

In some embodiments, a PDPC technology may also be used. In order to compensate for deficiencies of the above simple intra prediction mode in utilizing the spatial redundancy, VVC introduces a method of adaptively selecting reference sample information at an angle in an opposite direction based on the position of the current sample and the angle of the intra prediction mode, as a new relatively complementary intra prediction; and then performing a weighted average on this intra prediction and the original angular intra prediction based on sample distance. An effect is to allow the original angular prediction to fully utilize reference sample information corresponding to positive and negative directions at the prediction angle as much as possible, thereby improving prediction performance.

The PDPC uses reconstructed pixel values that are not subjected to smoothing filtering, and the reconstructed pixel values and prediction values are weighted at different weights based on different prediction positions in the block, such that the prediction values are more accurate. A calculation process of applying the PDPC to predicted pixels is shown by the following formula (4)

$$pred ( x ’ , y ’ ) = ( w L \times {R}_{- 1 , y ’} + w T \times {R}_{x ’ , - 1} - w T L \times {R}_{- 1 , - 1} + ( 64 - w L - w T + w T L ) \times p r ed ( x ’ , y ’ ) + 32 ) >> 6 \qquad ( 4 )$$

R_{-1,y′}, R_{x′,-1} and R_{-1,-1} are reference pixel values used for correcting the prediction value pred (x′y′), and wL, wT and wTL are weights acquired based on (x′y′).

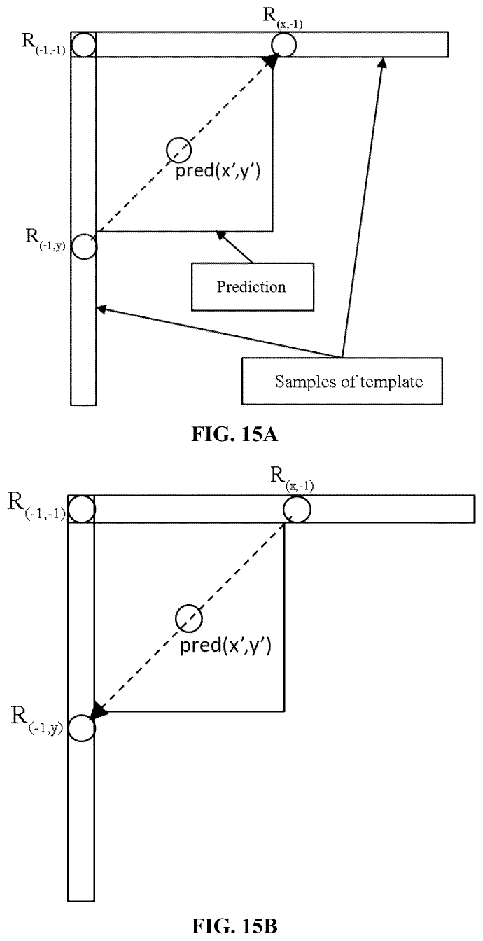

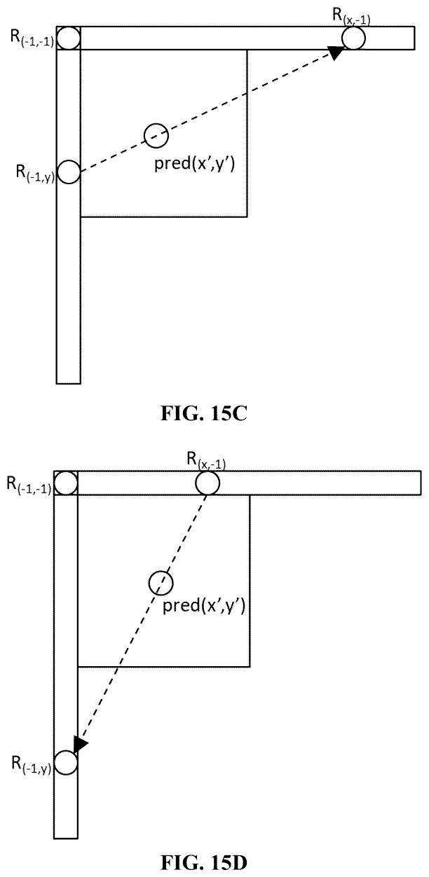

In an example, schematic diagrams of applying the PDPC to predicted pixels in different modes are shown in FIG. 15A to FIG. 15D. FIG. 15A is a diagonal upper right mode, FIG. 15B is a diagonal bottom-left mode, FIG. 15C is a neighbouring upper right mode, and FIG. 15D is a neighbouring bottom-left mode.

In an example, weights of the PDPC in different modes in the above formula (4) may be acquired based on the following Table 2.

TABLE 2
Weights of the PDPC in different modes

| Prediction | | | |
|---|---|---|---|
| Mode | wT | wL | wTL |
| diagonal above- | 16 >> ((y′ << | 16 >> ((x′ << | |
| right mode | 1) >> shift) | 1) >> shift) | |
| diagonal bottom- | 16 >> ((y′ << | 16 >> ((x′ << | 0 |
| left mode | 1) >> shift) | 1) >> shift) | |
| neighbouring | 32 >> ((y′ << | 0 | 0 |
| above-right | 1) >> shift) | | |
| mode | | | |
| neighbouring | 0 | 32 >> ((x′ << | 0 |
| bottom-left | | 1) >> shift) | |
| mode | | | |

The current method for constructing the intra prediction mode candidate list is only designed for traditional 65-angular-accuracy. When the intra prediction mode candidate list needs to be constructed in a prediction tool with 129-angular-accuracy, an existing approach is to match the 129-angular-accuracy back to the 65-angular-accuracy, and then matches 65-accuracy in the intra prediction mode candidate list back to 129-accuracy when deriving the prediction angle by using the template. This approach introduces redundancy and may cause accuracy loss in a matching process from the 129-angular-accuracy to 65-angular-accuracy, such that the constructed intra prediction mode candidate list is not accurate enough, thereby affecting accuracy of prediction and resulting in poor encoding and decoding effects.

In order to solve the above technical problem, in the embodiment of the disclosure, when constructing an intra prediction mode candidate list, a first angular accuracy corresponding to the intra prediction mode candidate list is determined first, here the first angular accuracy indicates a search range of angular prediction modes in the intra prediction mode candidate list. Then, the intra prediction mode candidate list is constructed based on the first angular accuracy. For example, the intra prediction mode candidate list is a TIMD list. Assuming that the first angular accuracy corresponding to the TIMD is 129, instead of first constructing an intra prediction mode candidate list with 65-angular-accuracy, and then matching the intra prediction mode candidate list with the 65-angular-accuracy back to 129-angular-accuracy; the embodiment of the disclosure directly constructs an intra prediction mode candidate list 129-angular-accuracy, thereby avoiding angular accuracy loss and improving accuracy of constructing the intra prediction mode candidate list. In this way, when prediction is performed based on the accurately constructed intra prediction mode candidate list, accuracy of prediction for the current block can be improved, thereby improving effects of video encoding and decoding.

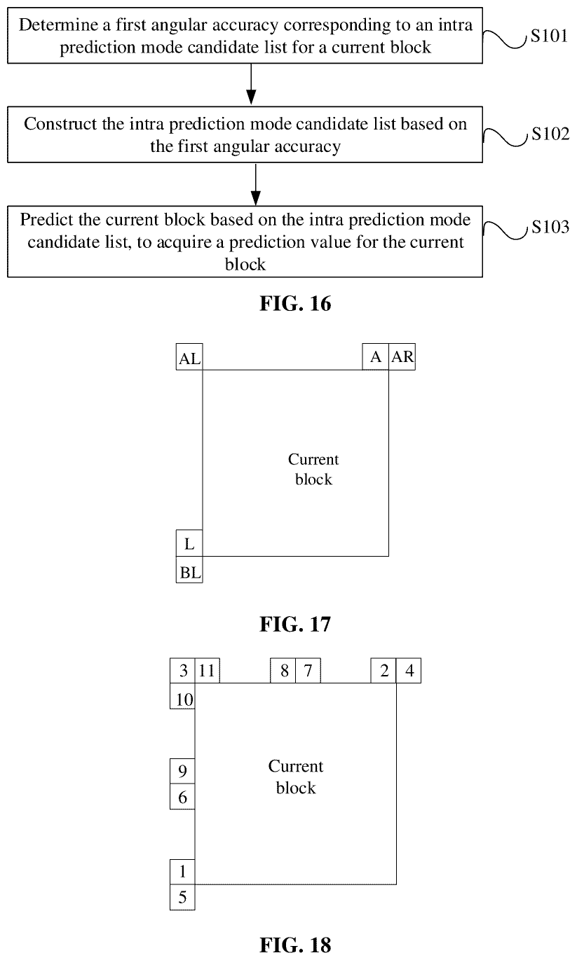

By taking the decoding end as an example, a method for video decoding according to an embodiment of the disclosure will be introduced below with reference to FIG. 16.

FIG. 16 is a schematic flowchart of a method for video decoding according to an embodiment of the disclosure, and the embodiment of the disclosure is applied to video decoders shown in FIG. 1 and FIG. 3. As shown in FIG. 16, the method of the embodiment of the disclosure includes the following operations S101 to S103.

In operation S101, a first angular accuracy corresponding to an intra prediction mode candidate list for a current block is determined.

When decoding the current block at the decoding end, a bitstream is decoded to acquire quantization coefficients of the current block, inverse quantization is performed on the quantization coefficients to acquire transform coefficients of the current block, and inverse transform is performed on the transform coefficients to acquire residual values of the current block. Then, the prediction mode for the current block is determined, prediction values of the current block are determined based on the prediction mode, and reconstruction values of the current block are acquired based on the prediction values and the residual values of the current block.

Exemplarily, the prediction mode for the current block includes an intra prediction mode and an inter prediction mode, and the embodiment of the disclosure is mainly related to the intra prediction mode.

In the intra prediction mode, manners of determining the intra prediction mode for the current block include at least the following first to third examples.

First example: the encoding end signals an angular index of the intra prediction mode for the current block into the bitstream. The decoding end acquires the angular index of the intra prediction mode for the current block by decoding the bitstream, then determines the intra prediction mode for the current block from the intra prediction modes shown in the above FIG. 6 or FIG. 7, and then preforms prediction for the current block by using the intra prediction mode, to acquire the prediction values for the current block.

Second example: the encoding end constructs an intra prediction mode candidate list, and selects the intra prediction mode for the current block from the intra prediction mode candidate list. Then, the encoding end signals a serial number (or an index number) of the intra prediction mode for the current block in the intra prediction mode candidate list into the bitstream. In this way, the decoding end determines the serial number of the intra prediction mode for the current block in the intra prediction mode candidate list by decoding the bitstream, while constructs an intra prediction mode candidate list in the same manner as the encoding end, and then determines the intra prediction mode for the current block from the constructed intra prediction mode candidate list based on the serial number of the intra prediction mode for the current block in the intra prediction mode candidate list. Finally, prediction for the current block is performed by using the determined intra prediction mode for the current block, to acquire the prediction values of the current block.

Third example: the encoding end constructs an intra prediction mode candidate list, and selects the intra prediction mode for the current block from the intra prediction mode candidate list. For example, the encoding end determines costs of each candidate prediction mode in the intra prediction mode candidate list on the template of the current block, and then determines the intra prediction mode for the current block based on the costs. Correspondingly, the decoding end constructs an intra prediction mode candidate list in the same manner as the encoding end, determines costs of each candidate prediction mode in the intra prediction mode candidate list on the template of the current block, and then determines the intra prediction mode for the current block based on the costs. Finally, prediction for the current block is performed by using the determined intra prediction mode for the current block, to acquire the prediction values of the current block.

In the above examples 2 and 3, the decoding end and the encoding end construct the same intra prediction mode candidate list, and performs prediction for the current block based on the intra prediction mode candidate list, to acquire the prediction values of the current block. As may be known, accuracy of constructing the intra prediction mode candidate list directly determines accuracy of prediction for the current block, thereby affecting decoding effect of a video.

At present, when constructing the intra prediction mode candidate list, the intra prediction mode candidate list is usually constructed based on 65 angular prediction modes (that is, 65-angular-accuracy). For example, taking the TIMD as an example, modes derived by the TIMD may undergo further angular refinement, subdividing the 65 angles into 129 angles by adding a finer angle between every two originally neighbouring angles, that is, a TIMD prediction tool has 129-angular-accuracy. When constructing the intra prediction mode candidate list of the TIMD, the current technical solution is to match prediction modes with 129-angular-accuracy corresponding to the TIMD back to prediction modes with 65-angular-accuracy, to construct an intra prediction mode candidate list with 65-angular-accuracy, and then match the constructed intra prediction mode candidate list with 65-angular-accuracy back to an intra prediction mode candidate list with 129-angular-accuracy. This approach introduces redundancy and may cause accuracy loss in a matching process from the 129-angular-accuracy to 65-angular-accuracy, such that the constructed intra prediction mode candidate list is not accurate enough, thereby affecting accuracy of prediction and resulting in poor encoding and decoding effects.

In order to solve the above technical problem, in the embodiment of the disclosure, when constructing an intra prediction mode candidate list, a first angular accuracy corresponding to the intra prediction mode candidate list is determined first, here the first angular accuracy indicates a search range of angular prediction modes in the intra prediction mode candidate list. Then, the intra prediction mode candidate list is constructed based on the first angular accuracy. For example, the intra prediction mode candidate list is a TIMD list. Assuming that the first angular accuracy corresponding to the TIMD is 129, instead of first constructing an intra prediction mode candidate list with 65-angular-accuracy, and then matching the intra prediction mode candidate list with the 65-angular-accuracy back to 129-angular-accuracy; the embodiment of the disclosure directly constructs an intra prediction mode candidate list 129-angular-accuracy, thereby avoiding angular accuracy loss and improving accuracy of constructing the intra prediction mode candidate list. In this way, when prediction is performed based on the accurately constructed intra prediction mode candidate list, accuracy of prediction for the current block can be improved, thereby improving effects of video encoding and decoding.

It should be noted that in the embodiment of the disclosure, the angular accuracy may be understood as the search range of the angular prediction modes. For example, the 65-angular-accuracy indicates that the search range of the angular prediction modes includes 65 angular prediction modes, that is, 65-angular-accuracy corresponds to 65 angular prediction modes. The 129-angular-accuracy indicates that the search range of the angular prediction mode includes 129 angular prediction modes, that is, the 129-angular-accuracy corresponds to 129 angular prediction modes.

In the embodiment of the disclosure, the first angular accuracy corresponding to the intra prediction mode candidate list for the current block indicates the search range of the angular prediction modes in the intra prediction mode candidate list. For example, when the first angular accuracy corresponding to the intra prediction mode candidate list for the current block is 65, it indicates that each angular prediction mode in the intra prediction mode candidate list is one of 65 angular prediction modes. For another example, when the first angular accuracy corresponding to the intra prediction mode candidate list for the current block is 129, it indicates that each angular prediction mode in the intra prediction mode candidate list is one of 129 angular prediction modes.

Specific processes of determining the first angular accuracy corresponding to the intra prediction mode candidate list for the current block will be introduced below.

In some embodiments, the first angular accuracy corresponding to the intra prediction mode candidate list for the current block is a preset value or a default value. That is, both the decoding end and the encoding end determine a preset value or a default value as the first angular accuracy corresponding to the intra prediction mode candidate list for the current block. The preset value or the default value is indicated through a high-level signaling.

In some embodiments, the decoding end may determine the first angular accuracy through the following operations S101-A to S101-C.

In operation S101-A, a prediction manner used in prediction for the current block is determined.

In operation S101-B, if the prediction manner is a template matching-based prediction manner, an angular accuracy corresponding to the prediction manner is determined.

In operation S101-C, the first angular accuracy is determined based on the angular accuracy corresponding to the prediction manner.

The prediction manner used in prediction for the current block may also be referred to as a prediction tool, such as the TIMD or the DIMD, etc.

Specific types of the prediction manner (that is, the prediction tool) are not limited in the embodiments of the disclosure. Exemplarily, the prediction manner includes, but is not limited to at least one of the TIMD, the MPM, the TMRL, the SGPM, or the DIMD. That is, if the TIMD tool, the MPM tool, the TMRL tool, the SGPM tool or the DIMD tool is used for the current block, the angular accuracy corresponding to the TIMD, the MPM, the TMRL, the SGPM or the DIMD is determined as the first angular accuracy.

The above operation S101-A of determining the prediction manner used in prediction for the current block, includes at least the following first to third manners.

First manner: the prediction manner used in prediction for the current block is a default manner.

Second manner: the bitstream is decoded to acquire the prediction manner used in prediction for the current block. For example, when the encoding end performs prediction for the current block by using multiple prediction manners respectively, the encoding end determines a respective prediction cost for each prediction manner, determines a prediction manner with a minimum prediction cost as the prediction manner for the current block, and signals identification information of the prediction manner into the bitstream. In this way, the decoding end may acquire the prediction manner used for the current block by decoding the bitstream.

Third manner: the prediction manner used in prediction for the current block is determined from multiple prediction manners based on the template of the current block. For example, when the encoding end and the decoding end perform prediction for the template of the current block by using multiple prediction manners respectively, the encoding end and the decoding end determine a prediction cost for each prediction manner, and determine a prediction manner with a minimum prediction cost as the prediction manner used for the current block.

After determining the prediction manner used in prediction for the current block, the decoding end determines whether the prediction manner is the template matching-based prediction manner; if the prediction manner is the template matching-based prediction manner, the decoding end determines an angular accuracy corresponding to the prediction manner, and then determines the first angular accuracy based on the angular accuracy corresponding to the prediction manner.

In the embodiment of the disclosure, manners of determining the first angular accuracy based on the angular accuracy corresponding to the prediction manner, include but are not limited to the following manners.

First manner: if the angular accuracy corresponding to the prediction manner is greater than a preset angular accuracy, the first angular accuracy is less than the angular accuracy corresponding to the prediction manner and greater than the preset angular accuracy. For example, if the angular accuracy corresponding to the prediction manner is 129 (corresponding to 129 angular prediction modes) and the preset angular accuracy is 65 (corresponding to 65 angular prediction modes), the first angular accuracy may be any angular accuracy less than 129 and greater than 65. For example, the first angular accuracy is 120, and the 120-angular-accuracy is a part of the 129-angular-accuracy, that is, 120 angular prediction modes are selected from 129 angular prediction modes, and the intra prediction mode candidate list is constructed based on the 120 angular prediction modes.

Second manner: the decoding end directly determines the angular accuracy corresponding to the prediction manner used in prediction for the current block, as the first angular accuracy.

After determining the first angular accuracy corresponding to the intra prediction mode candidate list based on operations of the manners, the decoding end performs the following operation S102.

In operation S102, the intra prediction mode candidate list is constructed based on the first angular accuracy.

As may be known from the above descriptions, in the TIMD tool, the DIMD tool, the TMRL tool, the SGPM tool or the MPM tool, it needs to construct an intra prediction mode candidate list when deriving an intra prediction mode, and candidate lists of these tools have different lengths and different construction methods respectively. However, at present, 65 angles are used during construction, which means that when a 129-angular-accuracy mode is filled in, it needs to match this mode back to a 65-angular-accuracy and then fill it into the candidate list, which causes accuracy loss. However, in the embodiment of the disclosure, a corresponding intra prediction mode candidate list is constructed based on the first angular accuracy corresponding to the TIMD, the DIMD, the TMRL, the SGPM or the MPM.

For example, the TIMD tool is used in the prediction for the current block, assuming that the first angular accuracy corresponding to the TIMD is 129, the intra prediction mode candidate list constructed by using the TIMD has an angular accuracy of 129.

For example, the TMRL tool is used in the prediction for the current block, assuming that the first angular accuracy corresponding to the TMRL is 129, the intra prediction mode candidate list constructed by using the TMRL has an angular accuracy of 129.

For example, the MPM tool is used in the prediction for the current block, assuming that the first angular accuracy corresponding to the MPM is 129, the intra prediction mode candidate list constructed by using the MPM has an angular accuracy of 129.

For example, the TIMD tool is used in the prediction for the current block, assuming that the first angular accuracy corresponding to the TIMD is 65, the intra prediction mode candidate list constructed by using the TIMD has an angular accuracy of 65.

For example, the TMRL tool is used in the prediction for the current block, assuming that the first angular accuracy corresponding to the TMRL is 65, the intra prediction mode candidate list constructed by using the TMRL has an angular accuracy of 65.

For example, the MPM tool is used in the prediction for the current block, assuming that the first angular accuracy corresponding to the MPM is 65, the intra prediction mode candidate list constructed by using the MPM has an angular accuracy of 65.

In some embodiments, in the intra prediction mode candidate list of the TIMD, the DIMD, the TMRL, the SGPM, or the MPM or the like, modes in the intra prediction mode candidate list include modes selected for prediction blocks at positions around the current block. Based on this, the above operation S102 includes the following operations S102-A and S102-B.

In operation S102-A, first intra prediction modes for N prediction blocks around the current block are acquired, here N is a positive integer.

In operation S102-B, the intra prediction mode candidate list is constructed based on the first intra prediction modes for the N prediction blocks and the first angular accuracy.

Specific positions of the N prediction blocks are not limited in the embodiments of the disclosure.

In a possible implementation, the N prediction blocks include five prediction blocks at positions neighbouring the current block. Exemplarily, these five positions are shown in FIG. 17, and differences between these positions and the coordinate of the above-left corner of the current block in horizontal and vertical directions are: above-left (−1,−1), above (width−1,−1), above-right (width,−1), left (−1, height−1), bottom-left (−1, height) respectively, here width and height are a width and a height of the current block respectively.

Exemplarily, the prediction blocks at these five positions are selected in an order of: left, above, above-left, bottom-left, and above-right.

In another possible implementation, in the embodiment of the disclosure, when constructing the intra prediction mode candidate list, prediction modes for prediction blocks corresponding to blocks at more neighbouring and/or non-neighbouring positions around the current block may be used, to expand and acquire the intra prediction mode candidate list. For example, the N prediction blocks include P first prediction blocks and/or Q second prediction blocks, here the first prediction blocks are prediction blocks corresponding to decoded blocks neighbouring the current block, the second prediction blocks are prediction blocks corresponding to decoded blocks not neighbouring the current block, both P and Q are positive integers less than or equal to N, and a sum of P and Q is equal to N.

That is, in the embodiment of the disclosure, all of the N prediction blocks may be the prediction blocks corresponding to decoded blocks neighbouring the current block; or, all of the N prediction blocks may be the prediction blocks corresponding to decoded blocks not neighbouring the current block; or, the N prediction blocks may include the prediction blocks corresponding to decoded blocks neighbouring the current block and the prediction blocks corresponding to decoded blocks not neighbouring the current block.

At this time, the above operation S102-A of acquiring the first intra prediction modes for the N prediction blocks around the current block includes at least the following first and second manners.

First manner: if the N prediction blocks include the P first prediction blocks, the above operation S102-A includes the following operations S102-A-11 and S102-A-12 at this time.

In operation S102-A-11, a first access order of the P first prediction blocks is determined.

In operation S102-A-12, first intra prediction modes for the P first prediction blocks are acquired based on the first access order.

When the decoding end acquires the first intra prediction modes for the P first prediction blocks, the decoding end needs to access them in a certain access order, for example, the decoding end acquires the first intra prediction modes for the P first prediction blocks based on the first access order.

Specific manners of determining the first access order of the P first prediction blocks are not limited in the embodiments of the disclosure.

In an example, the above first access order of the P first prediction blocks is a preset order.

In another example, the decoding end may determine the first access order based on a size of the current block and sizes of P decoded blocks, and/or based on a shape of the current block and shapes of the P decoded blocks.

For example, for any one of the P decoded blocks: a first similarity is determined based on a size of the decoded block and the size of the current block, and/or a second similarity is determined based on a shape of the decoded block and the shape of the current block; and a total similarity between the decoded block and the current block is determined based on the first similarity and/or the second similarity. In this way, an access order of the P decoded blocks is determined according to the total similarities, and the access order of the P decoded blocks is determined as the first access order of the P first prediction blocks. For example, the greater the total similarity, the earlier the access to the decoded block.

For example, the positions neighbouring the current block may be eleven positions shown in FIG. 18, that is, the P first prediction blocks are eleven first prediction blocks, and these eleven first prediction blocks are prediction blocks corresponding to the positions shown in FIG. 18.

Differences between these eleven positions shown in FIG. 18 and the coordinate of the above-left corner of the current block in horizontal and vertical directions are: position 1 (−1, height−1), position 2 (width−1,−1), position 3 (−1,−1), position 4 (width,−1), position 5 (−1, height), position 6 (−1, height/2), position 7 (width/2,−1), position 8 (width/2−1,−1), position 9 (−1, height/2−1), position 10 (−1, 0), position 11 (0,−1) respectively. Here width and height are a width and a height of the current block respectively.

The decoding end determines the first access order of the first prediction blocks corresponding to the positions shown in the above FIG. 18, and then acquires the first intra prediction modes for the first prediction blocks at these eleven positions based on the first access order.

Exemplarily, the first access order of these eleven first prediction blocks is: position 1, position 2, position 3, position 5, position 4, position 10, position 11, position 9, position 8, position 6, and position 7.

Second manner: if the N prediction blocks include the Q second prediction blocks, the above operation S102-A includes the following operations S102-A-21 and S102-A-22 at this time.

In operation S102-A-21, a second access order of the Q second prediction blocks is determined.

In operation S102-A-22, first intra prediction modes for the Q second prediction blocks are acquired according to the second access order.

When the decoding end acquires the first intra prediction modes for the Q second prediction blocks, the decoding end needs to access them in a certain access order, for example, the decoding end acquires the first intra prediction modes for the Q second prediction blocks according to the second access order.

Specific manners of determining the second access order of the Q second prediction blocks are not limited in the embodiments of the disclosure.

In an example, the above second access order of the Q second prediction blocks is a preset order.

In another example, the decoding end may determine the second access order based on a size of the current block and sizes of Q decoded blocks, and/or based on a shape of the current block and shapes of the Q decoded blocks.

For example, for any one of the Q decoded blocks: a first similarity is determined based on a size of the decoded block and the size of the current block, and/or a second similarity is determined based on a shape of the decoded block and the shape of the current block; and a total similarity between the decoded block and the current block is determined based on the first similarity and/or the second similarity. In this way, an access order of the Q decoded blocks is determined according to the total similarities, and the access order of the Q decoded blocks is determined as the second access order of the Q second prediction blocks. For example, the greater the total similarity, the earlier the access to the decoded block.

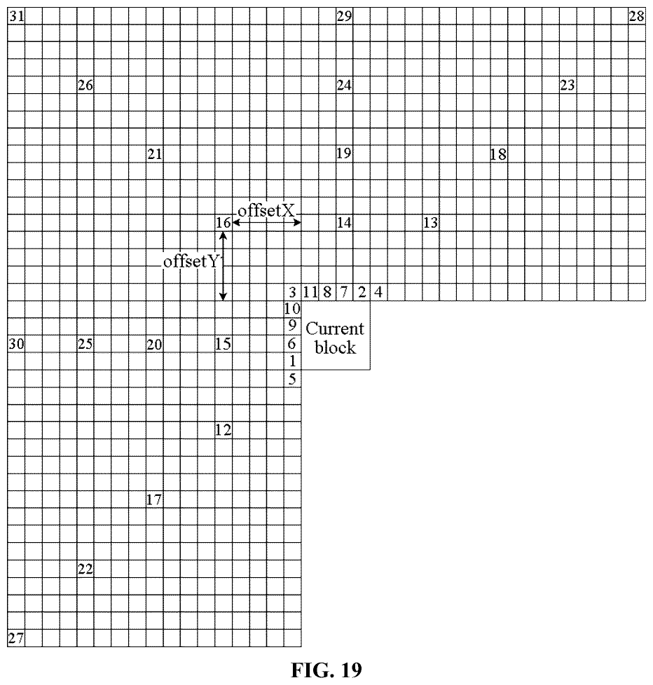

First example: positions not neighbouring the current block may be positions with serial numbers of 12-31 shown in FIG. 19, that is, the Q second prediction blocks are twenty second prediction blocks, and these twenty second prediction blocks are prediction blocks corresponding to the positions shown in FIG. 19.

Differences between positions with serial numbers of 12-31 shown in FIG. 19 and the coordinate of the above-left corner of the current block in horizontal and vertical directions are: position 12 (−offsetX−1, height+offsetY−1), position 13 (width+offsetX−1,−offsetY−1), position 14 (width/2,−offsetY−1), position 15 (−offsetX−1, height/2), position 16 (−offsetX−1, −offsetY−1), position 17 (−offsetX*2−1, height+offsetY*2−1), position 18 (width+offset*2−1,−offsetY*2−1), position 19 (width/2,−offsetY*2−1), position 20 (−offsetX*2−1, height/2), position 21 (−offsetX*2−1,−offsetY*2−1), position 22 (−offsetX*3−1, height+offsetY*3−1), position 23 (width+offset*3−1,−offsetY*3−1), position 24 (width/2,−offsetY*3−1), position 25 (−offsetX*3−1, height/2), position 26 (−offsetX*3−1,−offsetY*3−1), position 27 (−offsetX*4−1, height+offsetY*4−1), position 28 (width+offset*4−1,−offsetY*4−1), position 29 (width/2,−offsetY*4−1), position 30 (−offsetX*4−1, height/2), position 31 (−offsetX*4−1,−offsetY*4−1) respectively. Here width and height are a width and a height of the current block respectively.

The decoding end determines the second access order of the second prediction blocks corresponding to the positions shown in the above FIG. 19, and then acquires the first intra prediction modes for the second prediction blocks at these twenty positions based on the second access order.

In FIG. 19, positions with serial numbers of 1-11 are the same as these eleven neighbouring positions shown in above FIG. 18.

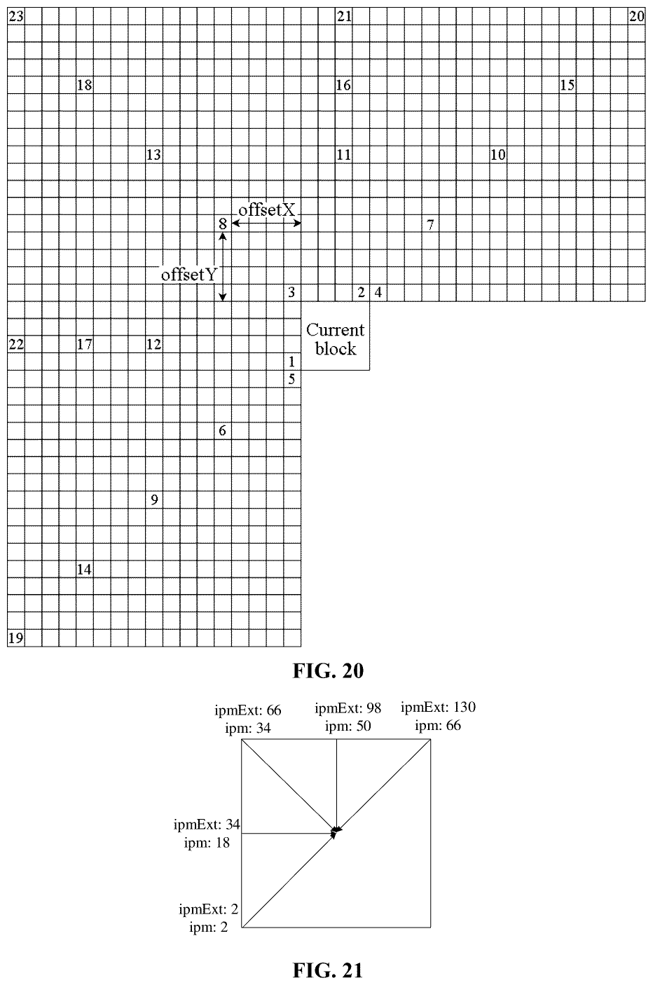

Second example: positions not neighbouring the current block may be positions with serial numbers of 6-23 shown in FIG. 20, that is, the Q second prediction blocks are eighteen second prediction blocks, and these eighteen second prediction blocks are prediction blocks corresponding to the positions shown in FIG. 20.

Differences between positions with serial numbers of 6-23 shown in FIG. 20 and the coordinate of the above-left corner of the current block in horizontal and vertical directions are: position 6 (−offsetX−1, height+offsetY−1), position 7 (width+offsetX−1,−offsetY−1), position 8 (−offsetX−1,−offsetY−1), position 9 (−offsetX*2−1, height+offsetY*2−1), position 10 (width+offset*2−1,−offsetY*2−1), position 11 (width/2,−offsetY*2−1), position 12 (−offsetX*2−1, height/2), position 13 (−offsetX*2−1,−offsetY*2−1), position 14 (−offsetX*3−1, height+offsetY*3−1), position 15 (width+offset*3−1,−offsetY*3−1), position 16 (width/2,−offsetY*3−1), position 17 (−offsetX*3−1, height/2), position 18 (−offsetX*3−1,−offsetY*3−1), position 19 (−offsetX*4−1, height+offsetY*4−1), position 20 (width+offset*4−1,−offsetY*4−1), position 21 (width/2,−offsetY*4−1), position 22 (−offsetX*4−1, height/2), position 23 (−offsetX*4−1,−offsetY*4−1) respectively. Here width and height are a width and a height of the current block respectively.

The decoding end determines the second access order of the second prediction blocks corresponding to the positions shown in the above FIG. 20, and then acquires the first intra prediction modes for the second prediction blocks at these eighteen positions based on the second access order.

In FIG. 20, positions with serial numbers of 1-5 are the same as these five neighbouring positions shown in above FIG. 17.

It should be noted that in the above FIG. 19 and FIG. 20, offsetX and offsetY may be fixed values, may be equal to or different from each other, and may be variables that vary based on the shape and size of the block. In some embodiments, offsetX is equal to the width of the current block, and offsetY is equal to the height of the current block.

In some embodiments, in order to limit complexity, at least one decoded block of the decoded blocks neighbouring the current block and/or the decoded blocks not neighbouring the current block, and the current block correspond to a same CTU, that is, the current block and the at least one decoded block belong to different picture blocks in the same CTU.

In the embodiment of the disclosure, if all of the N prediction blocks are the P first prediction blocks, that is, when N=P, the decoding end acquires the first intra prediction modes for the P first prediction blocks through the method of the above first manner. If all of the N prediction blocks are the Q second prediction blocks, that is, when N=Q, the decoding end acquires the first intra prediction modes for the Q second prediction blocks through the method of the above second manner. If the N prediction blocks include the P first prediction blocks and the Q second prediction blocks, and N=P+Q, the decoding end acquires the first intra prediction modes for the P first prediction blocks through the method of the above first manner, acquires the first intra prediction modes for the Q second prediction blocks through the method of the above second manner, and then acquires the first intra prediction modes for the N prediction blocks.

Operations of the order for acquiring the first intra prediction modes for the N prediction blocks are described as above. Specific manners of acquiring the first intra prediction mode for the prediction block will be described below.

In the embodiment of the disclosure, the first intra prediction mode for the prediction block may be understood as an intra prediction mode used in prediction for the prediction block, or an intra prediction mode derived from the prediction mode used in prediction for the prediction block. For example, if the prediction block is an intra prediction block, the intra prediction mode used in prediction for the prediction block is determined as the first intra prediction mode; or another one or more intra prediction modes are derived based on the intra prediction mode used for the prediction block, as the first intra prediction mode for the prediction block. For another example, if the prediction block is an inter prediction block, the first intra prediction mode for the prediction block is derived based on an inter prediction manner used for the prediction block.

Exemplarily, in the embodiment of the disclosure, the first intra prediction mode for the prediction block is one of the above 67 intra prediction modes (including 65 angular prediction modes), or one of 131 intra prediction modes (including 129 angular prediction modes).

In the embodiment of the disclosure, a specific manner of determining the first intra prediction mode for each of the N prediction blocks is the same. In order to facilitate descriptions, explanations will be made below by taking an example of acquiring a first intra prediction mode for an i-th prediction block.

In some embodiments, the first intra prediction mode for the i-th prediction block is determined based on a type of the i-th prediction block. For example, if the i-th prediction block is an intra prediction block, an intra prediction mode (such as an angular prediction mode) used in prediction for the i-th prediction block is determined as the first intra prediction mode for the i-th prediction block. For another example, if the i-th prediction block is an intra prediction block, an intra prediction mode is determined based on an inter prediction mode used in prediction for the i-th prediction block, as the first intra prediction mode for the i-th prediction block.

In some embodiments, the first intra prediction mode for the i-th prediction block is determined based on the prediction mode for the i-th prediction block. At this time, the above operation S102-A includes the following operations S102-A-31 and S102-A-32.

In operation S102-A-31, for an i-th prediction block of the N prediction blocks, a prediction manner used in prediction for the i-th prediction block is determined, here i is a positive integer less than or equal to N.

In operation S102-A-32, a first intra prediction mode for the i-th prediction block is determined based on the prediction manner.

In this embodiment, the prediction manner used in prediction for the i-th prediction block may be understood as a prediction tool or prediction technology used in prediction for the i-th prediction block. The prediction manner used in prediction for the i-th prediction block may be any prediction technology such as the above TIMD, DIMD, TMRL, MIP, intraTMP, GPM, SGPM, or traditional intra prediction mode, etc.

In an example, if the prediction manner used in prediction for the i-th prediction block is any one of a TIMD, a DIMD, a TMRL and a traditional intra prediction mode, an intra prediction mode derived from the prediction manner is determined as the first intra prediction mode for the i-th prediction block.

For example, if the i-th prediction block is an intra prediction block and the prediction manner (or prediction technology) used in prediction for the i-th prediction block is the TIMD or the TMRL, at least one intra prediction mode (such as an angular prediction mode) derived by using the TIMD or TMRL technology during prediction for the i-th prediction block is determined as the first intra prediction mode for the i-th prediction block.

For another example, if the i-th prediction block is an intra prediction block and the prediction manner (or prediction technology) used in prediction for the i-th prediction block is the DIMD, at least one intra prediction mode (such as an angular prediction mode) derived by using the DIMD technology during prediction for the i-th prediction block is determined as the first intra prediction mode for the i-th prediction block.

For another example, if the i-th prediction block is an intra prediction block and the prediction manner (or prediction technology) used in prediction for the i-th prediction block is the traditional intra prediction mode, at least one intra prediction mode (such as an angular prediction mode) derived from the traditional intra prediction mode during prediction for the i-th prediction block is determined as the first intra prediction mode for the i-th prediction block.

In an example, if the prediction manner used in prediction for the i-th prediction block is the MIP or the intraTMP, a first angular prediction mode is derived by using a DIMD manner, and the first angular prediction mode is determined as the first intra prediction mode for the i-th prediction block; or, the planar (PLANAR) mode is determined as the first intra prediction mode for the i-th prediction block.

In the embodiment of the disclosure, if the i-th prediction block is an intra prediction block and the prediction manner used in prediction for the i-th prediction block is the MIP or the intraTMP, since the MIP or the intraTMP cannot correspond to the angular prediction mode, it needs to replace the MIP or the intraTMP by other modes. Exemplarily, when the i-th prediction block is an intra prediction block and the prediction manner used in prediction for the i-th prediction block is the MIP or the intraTMP, there are at least two manners of determining the first intra prediction mode for the i-th prediction block.

First manner: a first angular prediction mode is derived through the DIMD manner, as the first intra prediction mode for the i-th prediction block. For example, with reference to the above introduction of relevant technologies of the DIMD, an angular prediction mode may be derived from reconstructed pixels around a decoded block corresponding to the i-th prediction block, and the angular prediction mode is determined as the first intra prediction mode for the i-th prediction block.

Second manner: the PLANAR mode is directly determined as the first intra prediction mode for the i-th prediction block.

In an example, if the prediction manner used in prediction for the i-th prediction block is a GPM or an SGPM, an angular prediction mode corresponding to a partitioning angle of the GPM or the SGPM is determined as the first intra prediction mode for the i-th prediction block.

For example, if the i-th prediction block is an inter prediction block and the prediction manner (or prediction technology) used in prediction for the i-th prediction block is the GPM, a GPM partitioning mode corresponding to the i-th prediction block is determined (as shown in FIG. 11). Then, a GPM partitioning angle is determined based on the GPM partitioning mode, and an angular prediction mode corresponding to the GPM partitioning angle may be determined by looking up the above Table 1, and then the angular prediction mode is determined as the first intra prediction mode for the i-th prediction block.

For another example, if the i-th prediction block is an intra prediction block and the prediction manner (or prediction technology) used in prediction for the i-th prediction block is the SGPM, an SGPM partitioning mode corresponding to the i-th prediction block is determined (as shown in FIG. 11). Then, a partitioning angle is determined based on the SGPM partitioning mode, and an angular prediction mode corresponding to the SGPM partitioning angle may be determined by looking up the above Table 1, and then the angular prediction mode is determined as the first intra prediction mode for the i-th prediction block.

In an example, if the i-th prediction block is an inter prediction block and a prediction mode used in prediction for the i-th prediction block is not a GPM mode, an intra prediction mode in an intra prediction mode cache of the current block is determined as the first intra prediction mode for the i-th prediction block.

During prediction for the current block, one or more intra prediction modes are cached in the intra prediction mode cache of the current block, and the one or more intra prediction modes are intra prediction modes for reference blocks of the current block. In this way, when the i-th prediction block is an inter prediction block and the prediction mode used in prediction for the i-th prediction block is not the GPM mode, at least one intra prediction mode in the intra prediction mode cache of the current block may be determined as the first intra prediction mode for the i-th prediction block.

The decoding end may acquire the first intra prediction mode for each of the N prediction blocks, based on the above access order of the N prediction blocks and the above manners of acquiring the first intra prediction mode.

After acquiring the first intra prediction modes for the N prediction blocks, the decoding end performs the above operation S102-B, that is, constructs the intra prediction mode candidate list corresponding to the current block based on the first intra prediction modes for the N prediction blocks and the first angular accuracy.

In the embodiment of the disclosure, angular accuracies of prediction tools used in prediction for different prediction blocks of the N prediction blocks may not be exactly the same, and thus angular accuracies corresponding to the first intra prediction modes for the N prediction blocks are not exactly the same, either. For example, the TIMD is used in prediction for a prediction block 1, and an angular accuracy of the TIMD is 129 (corresponding to 129 angular prediction modes), therefore an angular accuracy corresponding to a first intra prediction mode for the prediction block 1 is 129 (corresponding to 129 angular prediction modes). For another example, the DIMD is used in prediction for a prediction block 2, and an angular accuracy of the DIMD is 65 (corresponding to 65 angular prediction modes), therefore an angular accuracy corresponding to a first intra prediction mode for the prediction block 2 is 65 (corresponding to 65 angular prediction modes). At this time, the angular accuracy corresponding to the first intra prediction mode for the prediction block 1 is different from the angular accuracy corresponding to the first intra prediction mode for the prediction block 2. Furthermore, an angular accuracy of at least one of the first intra prediction modes for the N prediction blocks may be different from the first angular accuracy. Therefore, after the decoding end acquires the first intra prediction modes for the N prediction blocks based on the above operations, it also needs to perform angle matching on the first intra prediction modes based on the first angular accuracy, to acquire second intra prediction modes, and then construct the intra prediction mode candidate list based on the second intra prediction modes.

Specific processes of constructing the intra prediction mode candidate list corresponding to the current block based on the first intra prediction modes for the N prediction blocks and the first angular accuracy will be introduced below.

In the above operation S102-B, manners of constructing the intra prediction mode candidate list corresponding to the current block based on the first intra prediction modes for the N prediction blocks and the first angular accuracy include at least the following first and second manners.

First manner: for each of the N prediction blocks, the decoding end compares an angular accuracy corresponding to a first intra prediction mode for the prediction block to the first angular accuracy. If the angular accuracy corresponding to the first intra prediction mode for the prediction block is different from the first angular accuracy, the decoding end performs accuracy matching on the first intra prediction mode for the prediction block, to acquire a second intra prediction mode of the first intra prediction mode for the prediction block at the first angular accuracy. If the angular accuracy corresponding to the first intra prediction mode for the prediction block is the same as the first angular accuracy, the decoding end determines the first intra prediction mode for the prediction block as the second intra prediction mode. In this way, the second intra prediction mode corresponding to the first intra prediction mode for each of the N prediction blocks may be determined, and then the intra prediction mode candidate list is constructed based on second intra prediction modes for the N prediction blocks. For example, different second intra prediction modes among the second intra prediction modes for the N prediction blocks are added to the intra prediction mode candidate list, until a length of the intra prediction mode candidate list reaches a preset length.

Second manner: the above operation S102-B includes the following operations S102-B1 to S102-B3.

In operation S102-B1, K first intra prediction modes are determined based on the first intra prediction modes for the N prediction blocks, here K is a positive integer less than or equal to N.

In operation S102-B2, second intra prediction modes respectively corresponding to the K first intra prediction modes are determined based on the first angular accuracy.

In operation S102-B3, the intra prediction mode candidate list is constructed based on K second intra prediction modes.

In the second manner, the decoding end selects K first intra prediction modes from the first intra prediction modes for the N prediction blocks, and the K first intra prediction modes are different from each other. Then, the decoding end compares an angular accuracy corresponding to each of the K first intra prediction modes to the first angular accuracy, to determine a respective second intra prediction mode corresponding to each of the K first intra prediction modes. Finally, the decoding end constructs the intra prediction mode candidate list based on the K second intra prediction modes.

In the embodiment of the disclosure, specific manners of determining the K first intra prediction modes based on the first intra prediction modes for the N prediction blocks include at least the following first to third manners.

First manner: the decoding end selects the K first intra prediction modes from the first intra prediction modes for the N prediction blocks, based on the above access order of the N prediction blocks.

Second manner: the above operation S102-B1 includes the following operations S102-B1-11 and S102-B1-12.

In operation S102-B1-11, part or all of the first intra prediction modes for the N prediction blocks are sorted, to acquire sorted first intra prediction modes.

In operation S102-B1-12, the K first intra prediction modes are determined based on the sorted first intra prediction modes.

As may be known from the above descriptions, in some embodiments, the N prediction blocks include P first prediction blocks; in some embodiments, the N prediction blocks include Q second prediction blocks; and in some embodiments, the N prediction blocks include both P first prediction blocks and Q second prediction blocks.

Based on this, manners of sorting part or all of the first intra prediction modes for the N prediction blocks, to acquire the sorted first intra prediction modes may include the following first to fourth examples.

First example: if the N prediction blocks include the P first prediction blocks, first intra prediction modes for the P first prediction blocks of the N prediction blocks are sorted, to acquire the sorted first intra prediction modes.

That is, in the first example, only the first intra prediction modes for the P first prediction blocks of the N prediction blocks are sorted, and if the N prediction blocks further include second prediction blocks, first intra prediction modes for the second prediction blocks are not sorted.

In this example, a manner of sorting the first intra prediction modes for the P first prediction blocks may be that the first intra prediction modes for the first prediction blocks are used to predict the template of the current block, to determine prediction values of the template, and first prediction costs of the first intra prediction modes are determined based on the prediction values and reconstruction values of the template. With reference to this manner, the first prediction cost corresponding to the first intra prediction mode for each of the P first prediction blocks may be determined, and then the first intra prediction modes for the P first prediction blocks may be sorted based on the first prediction costs (for example, in an ascending order of the first prediction costs) to acquire the sorted first intra prediction modes.

Second example: if the N prediction blocks include the Q second prediction blocks, first intra prediction modes for the Q second prediction blocks of the N prediction blocks are sorted, to acquire the sorted first intra prediction modes.

That is, in the second example, only the first intra prediction modes for the Q second prediction blocks of the N prediction blocks are sorted, and if the N prediction blocks further include first prediction blocks, first intra prediction modes for the first prediction blocks are not sorted.

In this example, a manner of sorting the first intra prediction modes for the Q second prediction blocks may be that the first intra prediction modes for the second prediction blocks are used to predict the template of the current block, to determine prediction values of the template, and first prediction costs of the first intra prediction modes are determined based on the prediction values and reconstruction values of the template. With reference to this manner, the first prediction cost corresponding to the first intra prediction mode for each of the Q second prediction blocks may be determined, and then the first intra prediction modes for the Q second prediction blocks may be sorted based on the first prediction costs (for example, in an ascending order of the first prediction costs) to acquire the sorted first intra prediction modes.

Third example: the first intra prediction modes for the N prediction blocks are sorted, to acquire the sorted first intra prediction modes.

In the embodiment of the disclosure, both the above first example and second example may be understood as a solution for sorting part of the first intra prediction modes for the N prediction blocks. The above third example may be understood as a solution for sorting all of the first intra prediction modes for the N prediction blocks.

That is, in the third example, no matter the N prediction blocks are N first prediction blocks, or the N prediction blocks are N second prediction blocks, or the N prediction blocks include first prediction blocks and second prediction blocks, the decoding end sorts all of the first intra prediction modes for the N prediction blocks.

In this example, a manner of sorting the first intra prediction modes for the N prediction blocks may be that the first intra prediction modes are used to predict the template of the current block, to determine prediction values of the template, and first prediction costs of the first intra prediction modes are determined based on the prediction values and reconstruction values of the template. With reference to this manner, the first prediction cost corresponding to each of the first intra prediction modes may be determined, and then the first intra prediction modes for the N prediction blocks may be sorted based on the first prediction costs (for example, in an ascending order of the first prediction costs) to acquire the sorted first intra prediction modes.

Fourth example: R first intra prediction modes are selected from the first intra prediction modes for the N prediction blocks, here R is a positive integer less than N; and the R first intra prediction modes are sorted, to acquire the sorted first intra prediction modes.

In this fourth example, the decoding end selects R first intra prediction modes from the first intra prediction modes for the N prediction blocks, for example, selects R first intra prediction modes from the first intra prediction modes for the N prediction blocks according to a preset order or rule. Then, the decoding end sorts the selected R first intra prediction modes, to acquire the sorted first intra prediction modes.

In this example, a manner of sorting the R first intra prediction modes may be that the first intra prediction modes are used to predict for the template of the current block, to determine prediction values of the template, and first prediction costs of the first intra prediction modes are determined based on the prediction values and reconstruction values of the template. With reference to this manner, the first prediction cost corresponding to each of the first intra prediction modes may be determined, and then the R first intra prediction modes may be sorted based on the first prediction costs (for example, in an ascending order of the first prediction costs) to acquire the sorted first intra prediction modes.

In the second manner, the decoding end sorts part or all of the first intra prediction modes for the N prediction blocks based on the above operations, to acquire the sorted first intra prediction modes, and then determines K first intra prediction modes based on the sorted first intra prediction modes. For example, the first intra prediction modes are sorted in an ascending order of the first prediction costs, such that first K first intra prediction modes may be selected from the sorted first intra prediction modes, to acquire the K first intra prediction modes.

In addition to acquiring the K first intra prediction modes by using the above second manner, the decoding end may acquire the K first intra prediction modes by using the following third manner.

Third manner: the above operation S102-B1 includes the following operations S102-B1-21 and S102-B1-22.

In operation S102-B1-21, first intra prediction mode(s) corresponding to a DIMD are determined.

In operation S102-B1-22, the K first intra prediction modes are determined based on the first intra prediction mode(s) corresponding to the DIMD and the first intra prediction modes for the N prediction blocks.

In the third manner, the K first intra prediction modes are determined from the first intra prediction mode(s) corresponding to the DIMD and the first intra prediction modes for the N prediction blocks. A manner of deriving the first intra prediction modes by using the DIMD manner may refer to the above relevant introduction of DIMD technologies. For example, in the template region of the current block, one or more intra prediction modes are derived by using the DIMD technologies, and the one or more intra prediction modes are recorded as the first intra prediction modes corresponding to the DIMD.

Then, the K first intra prediction modes are determined from the first intra prediction mode(s) corresponding to the DIMD and the first intra prediction modes for the N prediction blocks.

Specific implementations of determining the K first intra prediction modes from the first intra prediction mode(s) corresponding to the DIMD and the first intra prediction modes for the N prediction blocks include at least the following manners.

In a manner, the K first intra prediction modes are selected from the first intra prediction mode(s) corresponding to the DIMD and the first intra prediction modes for the N prediction blocks according to a preset order or rule.

In another manner, S first intra prediction modes are selected from the first intra prediction mode(s) corresponding to the DIMD and the first intra prediction modes for the N prediction blocks, here S is a positive integer; the S first intra prediction modes are sorted, to acquire sorted S first intra prediction modes; and the K first intra prediction modes are determined based on the sorted S first intra prediction modes.

In this implementation, the decoding end selects S first intra prediction modes from the first intra prediction modes corresponding to the DIMD and the first intra prediction modes for the N prediction blocks according to a preset order or rule. Then, the decoding end sorts the S first intra prediction modes, to acquire sorted S first intra prediction modes, for example, the decoding end calculates a respective prediction value of each of the S first intra prediction modes for the template of the current block, and acquires a respective first prediction cost corresponding to each of the S first intra prediction modes based on reconstruction values of the template and the prediction value of the template corresponding to each first intra prediction mode. Then, the decoding end sorts the S first intra prediction modes based on the first prediction costs, to acquire the sorted S first intra prediction modes, for example, the decoding end sorts the S first intra prediction modes in an ascending order of the first prediction costs, to acquire the sorted S first intra prediction modes. In this way, the K first intra prediction modes may be determined from the sorted S first intra prediction modes, for example, first K first intra prediction modes of the sorted S first intra prediction modes are determined as the K first intra prediction modes.

After determining the K first intra prediction modes based on the first intra prediction modes for the N prediction blocks based on the above operations, the decoding end performs the above operation S102-B2.

The operation of determining the second intra prediction modes corresponding to the K first intra prediction modes based on the first angular accuracy may include the following first and second cases.

First case: for an i-th first intra prediction mode of the K first intra prediction modes, if an angular accuracy corresponding to the i-th first intra prediction mode is consistent with the first angular accuracy, the i-th first intra prediction mode is determined as an i-th second intra prediction mode, here i is a positive integer less than or equal to N.

Second case: for an i-th first intra prediction mode of the K first intra prediction modes, if an angular accuracy corresponding to the i-th first intra prediction mode is different from the first angular accuracy, a second intra prediction mode corresponding to the i-th first intra prediction mode at the first angular accuracy is determined.

In some embodiments, correspondences between indices of 129-angular-accuracy and 65-angular-accuracy and indices of a traditional prediction mode in angular directions are shown in FIG. 21. ipmExt refers to an index of an intra prediction mode with 129-angular-accuracy, and ipm refers to an index of an intra prediction mode with 65-angular-accuracy.

Exemplarily, when both the ipmExt and the ipm are 0, corresponding intra prediction modes are the planar mode.

Exemplarily, when both the ipmExt and the ipm are 1, corresponding intra prediction modes are the DC mode.

Exemplarily, when the ipmExt ranges from 2 to 130, corresponding intra prediction modes have 129 angles, the angular directions may substantially refer to those shown in FIG. 21.

Exemplarily, when the ipm ranges from 2 to 66, corresponding intra prediction modes have 65 angles, the angular directions may substantially refer to those shown in FIG. 21.

In an example, a matching relationship between the ipm and the ipmExt is shown in the following formulas (5) and (6):

$$ipm = \{ \begin{matrix}( ipmExt >> 1 ) + 1 , & ipmExt \geq 2 \\ ipmExt , & ipmExt < 2\end{matrix} \qquad ( 5 )$$

$$ipmExt = \{ \begin{matrix}( ipm << 1 ) - 2 , & ipmExt \geq 2 \\ ipm , & ipmExt < 2\end{matrix} \qquad ( 6 )$$

Here, >> and <<represent a left shift and a right shift of a bit-wise operation respectively. When matching from 65 angles to 129 angles, the ipm indices of 2 to 66 may correspond to even angle indices in the ipmExt of 2 to 130. When matching from 129 angles to 65 angles, there may be loss of angular accuracy.

For example, when the angular accuracy corresponding to the i-th first intra prediction mode is 65 (corresponding to 65 angular prediction modes), and the first angular accuracy is 129 (corresponding to 129 angular prediction modes), a second intra prediction mode corresponding to the i-th first intra prediction mode at the angular accuracy of 129 may be determined by the above formula (6).

For another example, when the angular accuracy corresponding to the i-th first intra prediction mode is 129 (corresponding to 129 angular prediction modes), and the first angular accuracy is 65 (corresponding to 65 angular prediction modes), a second intra prediction mode corresponding to the i-th first intra prediction mode at the angular accuracy of 65 may be determined by the above formula (5).

In some embodiments, the decoding end may construct the intra prediction mode candidate list by the following operations S102-C to S102-E, in addition to constructing the intra prediction mode candidate list based on the first intra prediction modes for the N prediction blocks around the current block as shown in the above embodiments.

In operation S102-C, M intra prediction modes are acquired from existing intra prediction modes in a current intra prediction mode candidate list, here Mis a positive integer.

In operation S102-D, for a j-th intra prediction mode of the M intra prediction modes, the intra prediction mode similar to the j-th intra prediction mode is determined based on the first angular accuracy, here j is a positive integer less than or equal to M.

In operation S102-E, the similar intra prediction mode is added to the intra prediction mode candidate list.

In this embodiment, the decoding end first acquires the M intra prediction modes from the existing intra prediction modes in the current intra prediction mode candidate list; determines, based on the first angular accuracy, respective intra prediction modes similar to each of the M intra prediction modes; and then, adds these similar intra prediction modes to the intra prediction mode candidate list, until a length of the intra prediction mode candidate list is equal to a preset length.

In this embodiment, there is at least one intra prediction mode in the intra prediction mode candidate list. That is, when the decoding end determines that a length of the current intra prediction mode candidate list is less than a preset length, the decoding end acquires the M intra prediction modes from the existing intra prediction modes in the current intra prediction mode candidate list.

In some embodiments, the existing intra prediction modes in the current intra prediction mode candidate list may be some default intra prediction modes, such as the PLANAR mode, etc.

In some embodiments, the existing intra prediction modes in the current intra prediction mode candidate list may be the K second intra prediction modes determined by the above method. That is, the decoding end first acquires the first intra prediction modes for the N prediction blocks around the current block based on the above method, and determines the K first intra prediction modes based on the first intra prediction modes for the N prediction blocks. Then, the decoding end determines, based on the first angular accuracy, the second intra prediction modes corresponding to the K first intra prediction modes respectively, and then adds different second intra prediction modes of the K second intra prediction modes to the intra prediction mode candidate list. Next, the decoding end determines whether the length of the intra prediction mode candidate list reaches the preset length at this time. If the length of the intra prediction mode candidate list is less than the preset length, the decoding end performs the above operations S102-C to S102-E to determine at least one similar intra prediction mode, and adds intra prediction modes of the at least one similar intra prediction mode that do not repeat with the existing intra prediction modes to the intra prediction mode candidate list.

In the embodiment of the disclosure, manners of determining intra prediction modes similar to each of the M intra prediction modes are consistent. In order to facilitate descriptions, explanations will be made below by taking the j-th intra prediction mode as an example.

In some embodiments, the intra prediction modes similar to the j-th intra prediction mode include: a first similar prediction mode with an index less than a first index of the j-th intra prediction mode, and/or a second similar prediction mode with an index greater than the first index.

In some embodiments, the above operation S102-D of determining, based on the first angular accuracy, the intra prediction modes similar to the j-th intra prediction mode includes manners shown in the following examples.

In an example, if preset modes similar to the j-th intra prediction mode include the first similar prediction mode, and the j-th intra prediction mode is not a first angular prediction mode among prediction modes corresponding to the first angular accuracy, a prediction mode (among the prediction modes corresponding to the first angular accuracy) with an index less than the first index by a first value is determined as the first similar prediction mode.

In an example, if the intra prediction modes similar to the j-th intra prediction mode include the first similar prediction mode, and the j-th intra prediction mode is the first angular prediction mode among the prediction modes corresponding to the first angular accuracy, a prediction mode (among the prediction modes corresponding to the first angular accuracy) with an index less than an index of a prediction mode in an opposite direction of the j-th intra prediction mode by the first value is determined as the first similar prediction mode. For example, the first angular accuracy is 65, if ipm of the j-th prediction mode is 2, ipm. of the first similar prediction mode is an angular mode index that differs from the ipm by the first value (such as delta+1) in an opposite angular direction of the ipm. For another example, the first angular accuracy is 129, if ipmExt of the j-th prediction mode is 2, ipmExt. of the first similar prediction mode is an angular mode index that differs from the ipmExt by the first value (such as delta+1) in an opposite angular direction of the ipmExt.

In an example, if the preset mode similar to the j-th intra prediction mode include the second similar prediction mode, and the j-th intra prediction mode is not a last angular prediction mode among the prediction modes corresponding to the first angular accuracy, a prediction mode (among the prediction modes corresponding to the first angular accuracy) with an index greater than the first index by the first value is determined as the second similar prediction mode.

In an example, if the preset mode similar to the j-th intra prediction mode include the second similar prediction mode, and the j-th intra prediction mode is a last angular prediction mode among the prediction modes corresponding to the first angular accuracy, a prediction mode (among the prediction modes corresponding to the first angular accuracy) with an index greater than an index of a prediction mode in an opposite direction of the j-th intra prediction mode by the first value is determined as the second similar prediction mode. For example, the first angular accuracy is 65, if ipm of the j-th prediction mode is 66, ipm. of the first similar prediction mode is an angular mode index that differs from the ipm by the first value (such as delta+1) in an opposite angular direction of the ipm. For another example, the first angular accuracy is 129, if ipmExt of the j-th prediction mode is 130, ipmExt. of the first similar prediction mode is an angular mode index that differs from the ipmExt by the first value (such as delta+1) in an opposite angular direction of the ipmExt.

Specific values of the above first value are not limited in the embodiments of the disclosure.

In a possible implementation, the above first value may be a preset value.

In another possible implementation, the above first value is a sum of a first preset value and 1. The first preset value is delta, and delta is a positive integer equal to or greater than 0. In some embodiments, delta is less than 4.

In some embodiments, the above operation S102-D of determining, based on the first angular accuracy, the intra prediction modes similar to the j-th intra prediction mode includes the following operations S102-D1 and S102-D2.

In operation S102-D1, a second numerical value and/or a third numerical value are determined based on the first angular accuracy.

In operation S102-D2, the first similar prediction mode and/or the second similar prediction mode are determined based on the second numerical value and/or the third numerical value.

Specific manners of determining the second numerical value and/or the third numerical value based on the first angular accuracy are not limited in the embodiments of the disclosure.

In an example, the above different angular accuracies correspond to different second numerical values and/or third numerical values, both the second numerical value and the third numerical value are preset values. For example, when the first angular accuracy is 65, the second numerical value is 61 and the third numerical value is 64. For another example, when the first angular accuracy is 129, the second numerical value is 125 and the third numerical value is 128.

In another example, a value acquired by subtracting 4 from the first angular accuracy is determined as the second numerical value, and a value acquired by subtracting 1 from the first angular accuracy is determined as the third numerical value.

After determining the second numerical value and/or the third numerical value, the decoding end determines the first similar prediction mode and/or the second similar prediction mode based on the second numerical value and/or the third numerical value. Specifically, the decoding end determines the first similar prediction mode based on the second numerical value and the third numerical value, and determines the second similar prediction mode based on the third numerical value.

In some embodiments, the decoding end calculates a sum of the first index of the j-th intra prediction mode and the second numerical value, and then subtracts a first preset value from the sum, to acquire a fourth numerical value; calculates a modulo of the fourth numerical value with respect to the third numerical value, and then adds a second preset value to the modulo result, to acquire an index corresponding to the first similar prediction mode; and determines the first similar prediction mode from prediction modes corresponding to the first angular accuracy, based on the index corresponding to the first similar prediction mode.

In some other embodiments, the decoding end calculates a difference by subtracting a third preset value from an index of the j-th intra prediction mode, and then calculates a sum of the difference and a first preset value, to acquire a fifth numerical value; calculates a modulo of the fifth numerical value with respect to the third numerical value, and then adds a second preset value to the modulo result, to acquire an index corresponding to the second similar prediction mode; and determines the second similar prediction mode from prediction modes corresponding to the first angular accuracy, based on the index corresponding to the second similar prediction mode.

For example, if the first angular accuracy is 65 (corresponding to 65 angular prediction modes), the decoding end may determine the first similar prediction mode and the second similar prediction mode that are similar to the j-th intra prediction mode by the following formula (7):

$$\begin{matrix}{ipm}_{-} = ( ip m + 61 - delta ) \%64 + 2 \\ {ipm}_{+} = ( i pm - 1 + delta ) \%64 + 2\end{matrix} \qquad ( 7 )$$

Here ipm is a first index of the j-th intra prediction mode at 65-angular-accuracy, delta is the first preset value, 61 is the second numerical value corresponding to 65-angular-accuracy, 64 is the third numerical value corresponding to 65-angular-accuracy, (ipm+61−delta) is the fourth numerical value, ipm is an index of the first similar prediction mode similar to the j-th intra prediction mode. (ipm−1+delta) is the fifth numerical value, here the third preset value is equal to 1. ipm, is an index of the second similar prediction mode similar to the j-th intra prediction mode.

For another example, if the first angular accuracy is 129 (corresponding to 129 angular prediction modes), the decoding end may determine the first similar prediction mode and the second similar prediction mode that are similar to the j-th intra prediction mode by the following formula (8):

$$\begin{matrix}{ipmExt}_{-} = ( ipmExt + 125 - delta ) \%128 + 2 \\ {ipmExt}_{+} = ( ipmExt - 1 + delta ) \%128 + 2\end{matrix} \qquad ( 8 )$$

Here ipmExt is a first index of the j-th intra prediction mode at an angular accuracy of 129, delta is the first preset value, 125 is the second numerical value corresponding to the angular accuracy of 129, 128 is the third numerical value corresponding to the angular accuracy of 129, (ipmExt+125−delta) is the fourth numerical value, ipmExt is an index of the first similar prediction mode similar to the j-th intra prediction mode. (ipmExt−1+delta) is the fifth numerical value, here the third preset value is equal to 1. ipmExt₊ is an index of the second similar prediction mode similar to the j-th intra prediction mode.

Respective intra prediction modes similar to each of the M intra prediction modes may be determined based on the above operations, and then the similar intra prediction modes are added to the intra prediction mode candidate list, until the length of the list reaches the preset length.

In some embodiments, if a length of the intra prediction mode candidate list does not reach a preset length, the method further includes the following operations. A second angular accuracy corresponding to a default angular prediction mode is determined. If the second angular accuracy is different from the first angular accuracy, a second intra prediction mode corresponding to the default angular prediction mode at the first angular accuracy is determined. The second intra prediction mode corresponding to the default angular prediction mode is added to the intra prediction mode candidate list. The operation of determining the second intra prediction mode corresponding to the default angular prediction mode at the first angular accuracy may refer to relevant descriptions of the above embodiments, which will not be elaborated here.

Processes of constructing the intra prediction mode candidate list in the embodiment of the disclosure will be further explained below by way of examples.

Assuming that angular accuracy corresponding to TMRL and TIMD technologies is 129, and angular accuracy corresponding to DIMD, MPM, SGPM and GPM technologies is 65.

First example: an MPM candidate list is constructed, and a first angular accuracy corresponding to the MPM candidate list is 65.

First manner: the MPM candidate list is constructed by the following operations 11 to 15.

In operation 11, the PLANAR mode is arranged at a first position of the MPM candidate list.

In operation 12, non-repeating second intra prediction modes among second intra prediction modes corresponding to first intra prediction modes for P first prediction blocks corresponding to decoded blocks at positions neighbouring the current block are filled into the MPM candidate list one by one in a certain order. Exemplarily, the P first prediction blocks are prediction blocks at eleven neighbouring positions around the current block in FIG. 18. Specifically, the following processes are performed for an i-th first prediction block of these eleven first prediction blocks.

When the i-th first prediction block is an intra prediction block and uses a TIMD or TMRL mode, an index of intra prediction mode corresponding to the i-th first prediction block is matched from an angular accuracy of 129 to an angular accuracy of 65, and the index of the intra prediction mode is acquired.

When the i-th first prediction block is an intra prediction block, and when a prediction mode for the i-th first prediction block is a MIP or an intraTMP, an index of the PLANAR mode is used for processing.

When the i-th first prediction block is an intra prediction block, and when the prediction mode for the i-th first prediction block is a DIMD mode, an index of intra prediction mode with a 65-angular-accuracy derived through the DIMD is acquired.

When the i-th first prediction block is an intra prediction block, and when the prediction mode for the i-th first prediction block is an SGPM mode, an index of angular prediction mode corresponding to SGPM partitioning angle is acquired.

When the i-th first prediction block is an intra prediction block, and when the prediction mode for the i-th first prediction block is a traditional intra prediction mode, an index of intra prediction mode is acquired.

When the i-th first prediction block is an inter prediction block, and when the prediction mode for the i-th first prediction block is a GPM mode, an index of angular prediction mode corresponding to GPM partitioning angle is acquired.

When the i-th first prediction block is an inter prediction block, and when the prediction mode for the i-th first prediction block is not the GPM mode, an index of intra prediction mode in an intra prediction mode cache of the current block is acquired.

It should be noted that indices of the intra prediction modes acquired as above may be understood as indices of the second intra prediction modes.

In operation 13, indices of one or more (for example, two) angular modes derived by using a DIMD tool for the current block are acquired.

In operation 14, existing angular prediction modes in an intra prediction candidate list are expanded through similar angles, to acquire at least one expanded angular prediction mode.

In operation 15, the intra prediction candidate list is filled with indices of modes with an angular accuracy of 65 in a default mode list.

It should be noted that in the above operations 11-15, when the number of filled modes reaches the required to-be-filled number, filling should be stopped.

Second manner: the MPM candidate list is constructed by the following operations 21 to 26.

In operation 21, the PLANAR mode is arranged at a first position of the MPM candidate list.

In operation 22, non-repeating second intra prediction modes among second intra prediction modes corresponding to first intra prediction modes for P first prediction blocks corresponding to decoded blocks at positions neighbouring the current block are filled into the MPM candidate list one by one in a certain order. Exemplarily, the P first prediction blocks are prediction blocks at eleven neighbouring positions around the current block in FIG. 19. Specifically, the following processes are performed for an i-th first prediction block of these eleven first prediction blocks.

When the i-th first prediction block is an intra prediction block and uses a TIMD or TMRL mode, an index of an intra prediction mode corresponding to the i-th first prediction block is matched from an angular accuracy of 129 to an angular accuracy of 65, that is, matched from 129 angular prediction modes back to 65 angular prediction modes, and the index of the intra prediction mode is acquired.

When the i-th first prediction block is an intra prediction block, and when a prediction mode for the i-th first prediction block is a MIP or an intraTMP, an index of the PLANAR mode is used for processing.

When the i-th first prediction block is an intra prediction block, and when the prediction mode for the i-th first prediction block is a DIMD mode, an index of intra prediction mode with an 65-angular-accuracy derived by the DIMD is acquired.

When the i-th first prediction block is an intra prediction block, and when the prediction mode for the i-th first prediction block is an SGPM mode, an index of angular prediction mode corresponding to SGPM partitioning angle is acquired.

When the i-th first prediction block is an intra prediction block, and when the prediction mode for the i-th first prediction block is a traditional intra prediction mode, an index of intra prediction mode is acquired.

When the i-th first prediction block is an inter prediction block, and when the prediction mode for the i-th first prediction block is a GPM mode, an index of angular prediction mode corresponding to GPM partitioning angle is acquired.

When the i-th first prediction block is an inter prediction block, and when the prediction mode for the i-th first prediction block is not the GPM mode, an index of intra prediction mode in an intra prediction mode cache of the current block is acquired.

It should be noted that indices of the intra prediction modes acquired as above may be understood as indices of the second intra prediction modes.

In operation 23, indices of one or more (for example, two) angular modes derived by using a DIMD tool for the current block are acquired.

In operation 24, non-repeating second intra prediction modes among second intra prediction modes corresponding to first intra prediction modes for Q second prediction blocks corresponding to decoded blocks at positions not neighbouring the current block are filled into the MPM candidate list one by one in a certain order. Exemplarily, the Q second prediction blocks are prediction blocks at twenty non-neighbouring positions around the current block in FIG. 19. Specifically, the following processes are performed for an i-th second prediction block of these twenty second prediction blocks.

When the i-th second prediction block is an intra prediction block and uses a TIMD or TMRL mode, an index of intra prediction mode corresponding to the i-th second prediction block is matched from an angular accuracy of 129 to an angular accuracy of 65, that is, from 129 angular prediction modes back to 65 angular prediction modes, and the index of the intra prediction mode is acquired.

When the i-th second prediction block is an intra prediction block, and when a prediction mode for the i-th second prediction block is a MIP or an intraTMP, an index of the PLANAR mode is used for processing.

When the i-th second prediction block is an intra prediction block, and when the prediction mode for the i-th second prediction block is a DIMD mode, an index of intra prediction mode with an angular accuracy of 65 derived by the DIMD is acquired.

When the i-th second prediction block is an intra prediction block, and when the prediction mode for the i-th second prediction block is an SGPM mode, an index of angular prediction mode corresponding to SGPM partitioning angle is acquired.

When the i-th second prediction block is an intra prediction block, and when the prediction mode for the i-th second prediction block is a traditional intra prediction mode, an index of intra prediction mode is acquired.

When the i-th second prediction block is an inter prediction block, and when the prediction mode for the i-th second prediction block is a GPM mode, an index of angular prediction mode corresponding to GPM partitioning angle is acquired.

When the i-th second prediction block is an inter prediction block, and when the prediction mode for the i-th second prediction block is not the GPM mode, an index of intra prediction mode in an intra prediction mode cache of the current block is acquired.

In operation 25, existing angular prediction modes in an intra prediction candidate list are expanded through similar angles, to acquire at least one expanded angular prediction mode.

In operation 26, the intra prediction candidate list is filled with indices of modes with an angular accuracy of 65 in a default mode list.

It should be noted that in the above operations 21-26, when the number of filled modes reaches the required to-be-filled number, filling should be stopped.

Third manner: the MPM candidate list is constructed by the following operations 31 to 36.

In operation 31, the PLANAR mode is arranged at a first position of the MPM candidate list.

In operation 32, non-repeating second intra prediction modes among second intra prediction modes corresponding to first intra prediction modes for P first prediction blocks corresponding to decoded blocks at positions neighbouring the current block are filled into the MPM candidate list one by one in a certain order. Exemplarily, the P first prediction blocks are prediction blocks at five neighbouring positions around the current block in FIG. 20. Specifically, the following processes are performed for an i-th first prediction block of these five first prediction blocks.

When the i-th first prediction block is an intra prediction block and uses a TIMD or TMRL mode, an index of intra prediction mode corresponding to the i-th first prediction block is matched from an angular accuracy of 129 to an angular accuracy of 65, that is, from 129 angular prediction modes back to 65 angular prediction modes, and the index of the intra prediction mode is acquired.

When the i-th first prediction block is an intra prediction block, and when a prediction mode for the i-th first prediction block is a MIP or an intraTMP, an index of the PLANAR mode is used for processing.

When the i-th first prediction block is an intra prediction block, and when the prediction mode for the i-th first prediction block is a DIMD mode, an index of intra prediction mode with an angular accuracy of 65 derived through the DIMD is acquired.

When the i-th first prediction block is an intra prediction block, and when the prediction mode for the i-th first prediction block is an SGPM mode, an index of angular prediction mode corresponding to SGPM partitioning angle is acquired.

When the i-th first prediction block is an intra prediction block, and when the prediction mode for the i-th first prediction block is a traditional intra prediction mode, an index of intra prediction mode is acquired.

When the i-th first prediction block is an inter prediction block, and when the prediction mode for the i-th first prediction block is a GPM mode, an index of angular prediction mode corresponding to GPM partitioning angle is acquired.

When the i-th first prediction block is an inter prediction block, and when the prediction mode for the i-th first prediction block is not the GPM mode, an index of intra prediction mode in an intra prediction mode cache of the current block is acquired.

It should be noted that indices of the intra prediction modes acquired as above may be understood as indices of the second intra prediction modes.

In operation 33, indices of one or more (for example, two) angular modes derived by using a DIMD tool for the current block are acquired.

In operation 34, non-repeating second intra prediction modes among second intra prediction modes corresponding to first intra prediction modes for Q second prediction blocks corresponding to decoded blocks at positions not neighbouring the current block are filled into the MPM candidate list one by one in a certain order. Exemplarily, the Q second prediction blocks are prediction blocks at eighteen non-neighbouring positions around the current block in FIG. 20. Specifically, the following processes are performed for an i-th second prediction block of these eighteen second prediction blocks.

When the i-th second prediction block is an intra prediction block and uses a TIMD or TMRL mode, an index of intra prediction mode corresponding to the i-th second prediction block is matched from an angular accuracy of 129 to an angular accuracy of 65, that is, from 129 angular prediction modes back to 65 angular prediction modes, and the index of the intra prediction mode is acquired.

When the i-th second prediction block is an intra prediction block, and when a prediction mode for the i-th second prediction block is a MIP or an intraTMP, an index of the PLANAR mode is used for processing.

When the i-th second prediction block is an intra prediction block, and when the prediction mode for the i-th second prediction block is a DIMD mode, an index of intra prediction mode with an angular accuracy of 65 derived through the DIMD is acquired.

When the i-th second prediction block is an intra prediction block, and when the prediction mode for the i-th second prediction block is an SGPM mode, an index of angular prediction mode corresponding to SGPM partitioning angle is acquired.

When the i-th second prediction block is an intra prediction block, and when the prediction mode for the i-th second prediction block is a traditional intra prediction mode, an index of intra prediction mode is acquired.

When the i-th second prediction block is an inter prediction block, and when the prediction mode for the i-th second prediction block is a GPM mode, an index of angular prediction mode corresponding to GPM partitioning angle is acquired.

When the i-th second prediction block is an inter prediction block, and when the prediction mode for the i-th second prediction block is not the GPM mode, an index of intra prediction mode from an intra prediction mode cache of the current block is acquired.

In operation 35, existing angular prediction modes in an intra prediction candidate list are expanded through similar angles, to acquire at least one expanded angular prediction mode.

In operation 36, the intra prediction candidate list is filled with indices of modes with an angular accuracy of 65 in a default mode list.

It should be noted that in the above operations 31-36, when the number of filled modes reaches a required to-be-filled number, filling should be stopped.

In some embodiments, the total number of modes acquired at neighbouring and non-neighbouring positions and modes derived by the DIMD may be limited to not exceed a preset value. The preset value may be an agreed value followed by the encoder and the decoder together, or a value parsed from the bitstream.

Second example: a TMRL candidate list is constructed, and a first angular accuracy corresponding to the TMRL candidate list is 129.

First manner: the TMRL candidate list is constructed by the following operations 41 to 44.

In operation 41, non-repeating second intra prediction modes among second intra prediction modes corresponding to first intra prediction modes for P first prediction blocks corresponding to decoded blocks at positions neighbouring the current block are filled into the TMRL candidate list one by one in a certain order. Exemplarily, the P first prediction blocks are prediction blocks at eleven neighbouring positions around the current block in FIG. 18. Specifically, the following processes are performed for an i-th first prediction block of these eleven first prediction blocks.

When the i-th first prediction block is an intra prediction block and uses a TIMD or TMRL mode, an index of intra prediction mode corresponding to the i-th first prediction block is acquired.

When the i-th first prediction block is an intra prediction block, and when a prediction mode for the i-th first prediction block is a MIP or an intraTMP, an index of the PLANAR mode is used for processing.

When the i-th first prediction block is an intra prediction block, and when the prediction mode for the i-th first prediction block is a DIMD mode, an index of intra prediction mode with an angular accuracy of 65 derived by the DIMD is matched to an index of intra prediction mode with an angular accuracy of 129.

When the i-th first prediction block is an intra prediction block, and when the prediction mode for the i-th first prediction block is an SGPM mode, an index of angular prediction mode corresponding to SGPM partitioning angle is matched to an index of intra prediction mode with an angular accuracy of 129.

When the i-th first prediction block is an intra prediction block, and when the prediction mode for the i-th first prediction block is a traditional intra prediction mode, an index of a first intra prediction mode for the i-th first prediction block is matched to an index of an intra prediction mode with an angular accuracy of 129.

When the i-th first prediction block is an inter prediction block, and when the prediction mode for the i-th first prediction block is a GPM mode, an index of intra prediction mode corresponding to GPM partitioning is matched to an index of intra prediction mode with an angular accuracy of 129.

When the i-th first prediction block is an inter prediction block, and when the prediction mode for the i-th first prediction block is not the GPM mode, an index of intra prediction mode in an intra prediction mode cache of the current block is matched to an index of intra prediction mode with an angular accuracy of 129.

It should be noted that indices of the intra prediction modes acquired as above may be understood as indices of the second intra prediction modes.

In operation 42, indices of one or more (for example, two) angular modes derived by using a DIMD tool for the current block are acquired and matched to indices of intra prediction modes with an angular accuracy of 129.

In operation 43, existing angular prediction modes in an intra prediction candidate list are expanded through similar angles, to acquire at least one expanded angular prediction mode.

In operation 44, indices of modes with an angular accuracy of 65 in a default mode list are used to match to indices of intra prediction modes with an angular accuracy of 129.

It should be noted that in the above operations 41-44, when the number of filled modes reaches the required to-be-filled number, filling should be stopped.

Second manner: the TMRL candidate list is constructed by the following operations 51 to 55.

In operation 51, non-repeating second intra prediction modes among second intra prediction modes corresponding to first intra prediction modes for P first prediction blocks corresponding to decoded blocks at positions neighbouring the current block are filled into the TMRL candidate list one by one in a certain order. Exemplarily, the P first prediction blocks are prediction blocks at eleven neighbouring positions around the current block in FIG. 19. Specifically, the following processes are performed for an i-th first prediction block of these eleven first prediction blocks.

When the i-th first prediction block is an intra prediction block and uses a TIMD or TMRL mode, an index of intra prediction mode corresponding to the i-th first prediction block is acquired.

When the i-th first prediction block is an intra prediction block, and when a prediction mode for the i-th first prediction block is a MIP or an intraTMP, an index of the PLANAR mode is used for processing.

When the i-th first prediction block is an intra prediction block, and when the prediction mode for the i-th first prediction block is a DIMD mode, an index of intra prediction mode with an angular accuracy of 65 derived by the DIMD is matched to an index of intra prediction mode with an angular accuracy of 129.

When the i-th first prediction block is an intra prediction block, and when the prediction mode for the i-th first prediction block is an SGPM mode, an index of angular prediction mode corresponding to SGPM partitioning angle is matched to an index of intra prediction mode with an angular accuracy of 129.

When the i-th first prediction block is an intra prediction block, and when the prediction mode for the i-th first prediction block is a traditional intra prediction mode, an index of a first intra prediction mode for the i-th first prediction block is matched to an index of an intra prediction mode with an angular accuracy of 129.

When the i-th first prediction block is an inter prediction block, and when the prediction mode for the i-th first prediction block is a GPM mode, an index of intra prediction mode corresponding to GPM partitioning is matched to an index of intra prediction mode with an angular accuracy of 129.

When the i-th first prediction block is an inter prediction block, and when the prediction mode for the i-th first prediction block is not the GPM mode, an index of intra prediction mode in an intra prediction mode cache of the current block is matched to an index of intra prediction mode with an angular accuracy of 129.

It should be noted that indices of the intra prediction modes acquired as above may be understood as indices of the second intra prediction modes.

In operation 52, indices of one or more (for example, two) angular modes derived by using a DIMD tool for the current block are acquired and matched to indices of intra prediction modes with an angular accuracy of 129.

In operation 53, non-repeating second intra prediction modes among second intra prediction modes corresponding to first intra prediction modes for Q second prediction blocks corresponding to decoded blocks at positions not neighbouring the current block are filled into the TMRL candidate list one by one in a certain order. Exemplarily, the Q second prediction blocks are prediction blocks at twenty non-neighbouring positions around the current block in FIG. 19. Specifically, the following processes are performed for an i-th second prediction block of these twenty second prediction blocks.

When the i-th second prediction block is an intra prediction block and uses a TIMD or TMRL mode, an index of intra prediction mode corresponding to the i-th second prediction block is acquired.

When the i-th second prediction block is an intra prediction block, and when a prediction mode for the i-th second prediction block is a MIP or an intraTMP, an index of the PLANAR mode is used for processing.

When the i-th second prediction block is an intra prediction block, and when the prediction mode for the i-th second prediction block is a DIMD mode, an index of intra prediction mode with an angular accuracy of 65 derived by the DIMD is matched to an index of intra prediction mode with an angular accuracy of 129.

When the i-th second prediction block is an intra prediction block, and when the prediction mode for the i-th second prediction block is an SGPM mode, an index of angular prediction mode corresponding to SGPM partitioning angle is matched to an index of intra prediction mode with an angular accuracy of 129.

When the i-th second prediction block is an intra prediction block, and when the prediction mode for the i-th second prediction block is a traditional intra prediction mode, an index of a first intra prediction mode for the i-th second prediction block is matched to an index of an intra prediction mode with an angular accuracy of 129.

When the i-th second prediction block is an inter prediction block, and when the prediction mode for the i-th second prediction block is a GPM mode, an index of intra prediction mode corresponding to GPM partitioning is matched to an index of intra prediction mode with an angular accuracy of 129.

When the i-th second prediction block is an inter prediction block, and when the prediction mode for the i-th second prediction block is not the GPM mode, an index of intra prediction mode in an intra prediction mode cache of the current block is matched to an index of intra prediction mode with an angular accuracy of 129.

In operation 54, existing angular prediction modes in an intra prediction candidate list are expanded through similar angles, to acquire at least one expanded angular prediction mode.

In operation 55, indices of modes with an angular accuracy of 65 in a default mode list are used to match to indices of intra prediction modes with an angular accuracy of 129.

It should be noted that in the above operations 51-55, when the number of filled modes reaches the required to-be-filled number, filling should be stopped.

Third manner: the TMRL candidate list is constructed by the following operations 61 to 65.

In operation 61, non-repeating second intra prediction modes among second intra prediction modes corresponding to first intra prediction modes for P first prediction blocks corresponding to decoded blocks at positions neighbouring the current block are filled into the TMRL candidate list one by one in a certain order. Exemplarily, the P first prediction blocks are prediction blocks at five neighbouring positions around the current block in FIG. 20. Specifically, the following processes are performed for an i-th first prediction block of these five first prediction blocks.

When the i-th first prediction block is an intra prediction block and uses a TIMD or TMRL mode, an index of intra prediction mode corresponding to the i-th first prediction block is acquired.

When the i-th first prediction block is an intra prediction block, and when a prediction mode for the i-th first prediction block is a MIP or an intraTMP, an index of the PLANAR mode is used for processing.

When the i-th first prediction block is an intra prediction block, and when the prediction mode for the i-th first prediction block is a DIMD mode, an index of intra prediction mode with an angular accuracy of 65 derived by the DIMD is matched to an index of intra prediction mode with an angular accuracy of 129.

When the i-th first prediction block is an intra prediction block, and when the prediction mode for the i-th first prediction block is an SGPM mode, an index of angular prediction mode corresponding to SGPM partitioning angle is matched to an index of intra prediction mode with an angular accuracy of 129.

When the i-th first prediction block is an intra prediction block, and when the prediction mode for the i-th first prediction block is a traditional intra prediction mode, an index of a first intra prediction mode for the i-th first prediction block is matched to an index of an intra prediction mode with an angular accuracy of 129

When the i-th first prediction block is an inter prediction block, and when the prediction mode for the i-th first prediction block is a GPM mode, an index of intra prediction mode corresponding to GPM partitioning is matched to an index of intra prediction mode with an angular accuracy of 129.

When the i-th first prediction block is an inter prediction block, and when the prediction mode for the i-th first prediction block is not the GPM mode, an index of intra prediction mode in an intra prediction mode cache of the current block is matched to an index of intra prediction mode with an angular accuracy of 129.

It should be noted that indices of the intra prediction modes acquired as above may be understood as indices of the second intra prediction modes.

In operation 62, indices of one or more (for example, two) angular modes derived by using a DIMD tool for the current block are acquired and matched to indices of intra prediction mode with an angular accuracy of 129.

In operation 63, non-repeated second intra prediction modes among second intra prediction modes corresponding to first intra prediction modes for Q second prediction blocks corresponding to decoded blocks at positions not neighbouring the current block are filled into the TMRL candidate list one by one in a certain order. Exemplarily, the Q second prediction blocks are prediction blocks at eighteen non-neighbouring positions around the current block in FIG. 20. Specifically, the following processes are performed for an i-th second prediction block of these eighteen second prediction blocks.

When the i-th second prediction block is an intra prediction block and uses a TIMD or TMRL mode, an index of intra prediction mode corresponding to the i-th second prediction block is acquired.

When the i-th second prediction block is an intra prediction block, and when a prediction mode for the i-th second prediction block is a MIP or an intraTMP, an index of the PLANAR mode is used for processing.

When the i-th second prediction block is an intra prediction block, and when the prediction mode for the i-th second prediction block is a DIMD mode, an index of intra prediction mode with an angular accuracy of 65 derived by the DIMD is matched to an index of intra prediction mode with an angular accuracy of 129.

When the i-th second prediction block is an intra prediction block, and when the prediction mode for the i-th second prediction block is an SGPM mode, an index of angular prediction mode corresponding to SGPM partitioning angle is matched to an index of intra prediction mode with an angular accuracy of 129.

When the i-th second prediction block is an intra prediction block, and when the prediction mode for the i-th second prediction block is a traditional intra prediction mode, an index of a first intra prediction mode for the i-th first prediction block is matched to an index of an intra prediction mode with an angular accuracy of 129.

When the i-th second prediction block is an inter prediction block, and when the prediction mode for the i-th second prediction block is a GPM mode, an index of intra prediction mode corresponding to GPM partitioning is matched to an index of intra prediction mode with an angular accuracy of 129.

When the i-th second prediction block is an inter prediction block, and when the prediction mode for the i-th second prediction block is not the GPM mode, an index of intra prediction mode in an intra prediction mode cache of the current block is matched to an index of intra prediction mode with an angular accuracy of 129.

In operation 64, existing angular prediction modes in an intra prediction candidate list are expanded through similar angles, to acquire at least one expanded angular prediction mode.

In operation 65, indices of modes with an angular accuracy of 65 in a default mode list are used to match to indices of intra prediction modes with an angular accuracy of 129.

It should be noted that in the above operations 61-65, when the number of filled modes reaches the required to-be-filled number, filling should be stopped.

In some embodiments, the total number of modes acquired at neighbouring and non-neighbouring positions and modes derived by the DIMD may be limited to not exceed a preset value. The preset value may be an agreed value followed by the encoder and the decoder together, or a value parsed from the bitstream.

After acquiring the intra prediction mode candidate list based on the above method, the decoding end performs the following operation S103.

In operation S103, the prediction for the current block is performed based on the intra prediction mode candidate list, to acquire a prediction value of the current block.

Specific manners of performing the prediction for the current block based on the intra prediction mode candidate list, to acquire the prediction value of the current block are not limited in the embodiments of the disclosure.

In some embodiments, the decoding end decodes the bitstream to acquire an index of an intra prediction mode corresponding to the current block; and selects, based on the index, an intra prediction mode corresponding to the index from the intra prediction mode candidate list constructed as above, and then performs prediction for the current block by using the intra prediction mode, to acquire the prediction value of the current block.

In some embodiments, the decoding end performs prediction for the template of the current block by using each of candidate prediction modes in an intra prediction mode list, to acquire a respective one of prediction values of the template corresponding to each of the candidate prediction modes, and then determines a respective one of prediction costs corresponding to each of the candidate prediction modes according to the prediction values of the template and reconstruction values of the template. Then, the decoding end determines a candidate prediction mode with a minimum prediction cost as the intra prediction mode for the current block, and performs the prediction for the current block by using this intra prediction mode, to acquire the prediction value of the current block.

In some embodiments, the above operation S103 includes the following operations S103-A and S103-B.

In operation S103-A, T candidate prediction modes in the intra prediction mode candidate list are sorted, to acquire a sorted intra prediction mode candidate list, here T is a positive integer greater than 1.

In operation S103-B, the prediction for the current block is performed based on the sorted intra prediction mode candidate list, to acquire the prediction value for the current block.

In an example, the above T candidate prediction modes may be part of candidate prediction modes in the intra prediction mode list.

In another example, the above T candidate prediction modes may be all of candidate prediction modes in the intra prediction mode list.

That is, in the embodiment of the disclosure, part or all of the candidate prediction modes in the constructed intra prediction mode candidate list are sorted, to acquire the sorted intra prediction mode candidate list.

Specific manners of sorting the T candidate prediction modes in the intra prediction mode candidate list, to acquire the sorted intra prediction mode candidate list are not limited in the embodiments of the disclosure.

In a possible implementation, the T candidate prediction modes in the intra prediction mode candidate list are sorted based on a preset sorting rule and order, to acquire the sorted intra prediction mode candidate list.

In another possible implementation, sorting is performed based on prediction costs. At this time, the above operation S103-A includes the following operations S103-A1 and S103-A2.

In operation S103-A1, for a t-th candidate prediction mode of the T candidate prediction modes, the t-th candidate prediction mode is used to predict the template of the current block to acquire a second prediction cost, here t is a positive integer less than or equal to T.

In operation S103-A2, the T candidate prediction modes are sorted based on the second prediction costs, to acquire the sorted intra prediction mode candidate list.

In this implementation, for the t-th candidate prediction mode of the T candidate prediction modes, the t-th candidate prediction mode is used to predict the template of the current block, to acquire a prediction value of the template in the t-th candidate prediction mode. Then, a second prediction cost corresponding to the t-th candidate prediction mode is determined according to the reconstructed value of the template and the prediction value of the template in the t-th candidate prediction mode, and the second prediction cost may be an approximate cost such as SAD or STAD, etc. In this way, the second prediction costs corresponding to each of the T candidate prediction modes may be determined, and then the T candidate prediction modes are sorted based on the second prediction costs, to acquire the sorted intra prediction mode candidate list. For example, the T candidate prediction modes are sorted in an ascending order of the second prediction costs, to acquire the sorted intra prediction mode candidate list.

In some embodiments, when determining the prediction value of the template of the current block, reference pixel rows used by template of the current block are at least one row and/or at least one column of reconstructed pixels neighbouring the template of the current block.

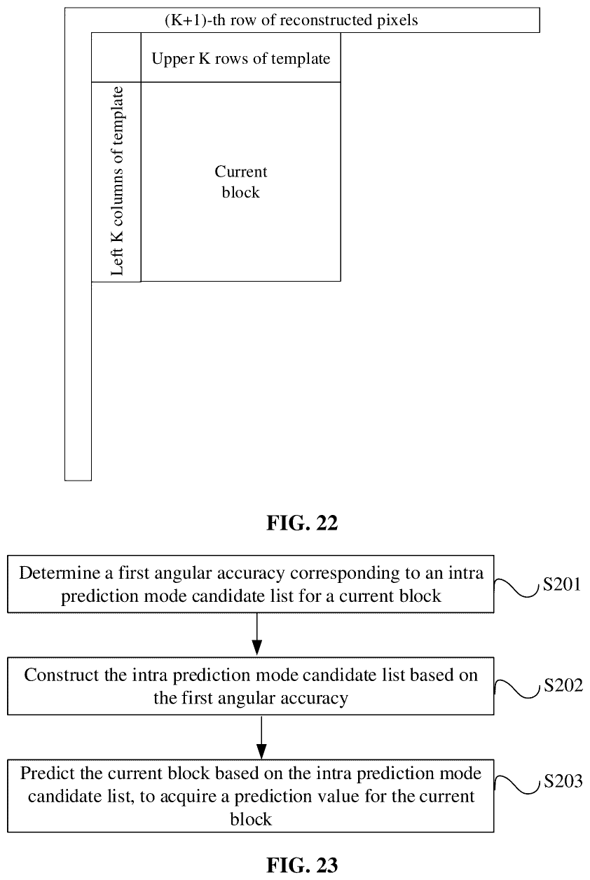

Exemplarily, as shown in FIG. 22, the template of the current block include an upper template and/or a left template, the upper template includes K pixel rows, and the left template includes K pixel columns, here K is a positive integer. The reference pixel rows of the template of the current block include upper reference pixel row(s) and/or left reference pixel column(s). In an example, the upper reference pixel rows are one pixel row, such as a (K+1)-th reconstructed pixel row. In another example, the left reference pixel columns are one pixel column, such as a (K+1)-th reconstructed pixel column.

In some embodiments, the row number of the upper reference pixel rows may be different from the column number of the left reference pixel columns. In some embodiments, the row number of the upper reference pixel rows and/or the column number of the left reference pixel columns may be determined according to different sizes of the current block.

In some embodiments, the upper template of the current block includes one or two pixel rows, and/or the left template of the current block includes one or two pixel columns.

For example, in order to reduce complexity of calculating the above second prediction costs, the upper template includes one pixel row, and/or the left template includes one pixel column.

For another example, the above second prediction costs may be calculated by using the upper template with two rows and/or the left template with two columns, to reduce complexity of calculation.

In some embodiments, complexity of prediction on the template may be simplified, for example, without using the PDPC, and by reducing the number of taps of an interpolation filter.

In some embodiments, the number of pixel rows included in the upper template may be different from the number of pixel columns included in the left template. In some embodiments, the number of pixel rows included in the upper template and the number of pixel columns included in the left template may be determined according to different sizes of the current block.

In some embodiments, the template of the current block may include only the upper template, without including the left template. Alternatively, the template of the current block may include only the left template, without including the upper template.

According to the method for video decoding according to the embodiment of the disclosure, when constructing an intra prediction mode candidate list, a first angular accuracy corresponding to the intra prediction mode candidate list is determined first, here the first angular accuracy indicates a search range of angular prediction modes in the intra prediction mode candidate list. Then, the intra prediction mode candidate list is constructed based on the first angular accuracy. For example, the intra prediction mode candidate list is a TIMD list. Assuming that the first angular accuracy corresponding to the TIMD is 129, instead of first constructing an intra prediction mode candidate list with 65-angular-accuracy, and then matching the intra prediction mode candidate list with the 65-angular-accuracy back to 129-angular-accuracy; the embodiment of the disclosure directly constructs an intra prediction mode candidate list 129-angular-accuracy, thereby avoiding angular accuracy loss and improving accuracy of constructing the intra prediction mode candidate list. In this way, when prediction is performed based on the accurately constructed intra prediction mode candidate list, accuracy of prediction for the current block can be improved, thereby improving effects of video encoding and decoding.

The prediction method of the disclosure is introduced as above by taking the decoding end as an example, and explanations will be made below by taking an encoding end as an example.

FIG. 23 is a schematic flowchart of a prediction method according to an embodiment of the disclosure, and the embodiment of the disclosure is applied to video encoders shown in FIG. 1 and FIG. 2. As shown in FIG. 23, the method of the embodiment of the disclosure includes the following operations S201 to S203.

In operation S201, a first angular accuracy corresponding to an intra prediction mode candidate list for a current block is determined.

Exemplarily, prediction modes for the current block include an intra prediction mode and an inter prediction mode, and the embodiment of the disclosure is mainly related to the intra prediction mode.

At present, when constructing the intra prediction mode candidate list, the intra prediction mode candidate list is usually constructed based on 65 angular prediction modes (that is, 65-angular-accuracy). For example, taking the TIMD as an example, modes derived by the TIMD may undergo further angular refinement, subdividing the 65 angles into 129 angles by adding a finer angle between every two originally neighbouring angles, that is, a TIMD prediction tool has 129-angular-accuracy. When constructing the intra prediction mode candidate list of the TIMD, the current technical solution is to match prediction modes with 129-angular-accuracy corresponding to the TIMD back to prediction modes with 65-angular-accuracy, to construct an intra prediction mode candidate list with 65-angular-accuracy, and then match the constructed intra prediction mode candidate list with 65-angular-accuracy back to an intra prediction mode candidate list with 129-angular-accuracy. This approach introduces redundancy and may cause accuracy loss in a matching process from the 129-angular-accuracy to 65-angular-accuracy, such that the constructed intra prediction mode candidate list is not accurate enough, thereby affecting accuracy of prediction and resulting in poor encoding and decoding effects.

In order to solve the above technical problem, in the embodiment of the disclosure, when constructing an intra prediction mode candidate list, a first angular accuracy corresponding to the intra prediction mode candidate list is determined first, here the first angular accuracy indicates a search range of angular prediction modes in the intra prediction mode candidate list. Then, the intra prediction mode candidate list is constructed based on the first angular accuracy. For example, the intra prediction mode candidate list is a TIMD list. Assuming that the first angular accuracy corresponding to the TIMD is 129, instead of first constructing an intra prediction mode candidate list with 65-angular-accuracy, and then matching the intra prediction mode candidate list with the 65-angular-accuracy back to 129-angular-accuracy; the embodiment of the disclosure directly constructs an intra prediction mode candidate list 129-angular-accuracy, thereby avoiding angular accuracy loss and improving accuracy of constructing the intra prediction mode candidate list. In this way, when prediction is performed based on the accurately constructed intra prediction mode candidate list, accuracy of prediction for the current block can be improved, thereby improving effects of video encoding and decoding.

It should be noted that in the embodiment of the disclosure, the angular accuracy may be understood as the search range of the angular prediction modes. For example, the 65-angular-accuracy indicates that the search range of the angular prediction modes includes 65 angular prediction modes, that is, 65-angular-accuracy corresponds to 65 angular prediction modes. The 129-angular-accuracy indicates that the search range of the angular prediction mode includes 129 angular prediction modes, that is, the 129-angular-accuracy corresponds to 129 angular prediction modes.

In the embodiment of the disclosure, the first angular accuracy corresponding to the intra prediction mode candidate list for the current block indicates the search range of the angular prediction modes in the intra prediction mode candidate list. For example, when the first angular accuracy corresponding to the intra prediction mode candidate list for the current block is 65, it indicates that each angular prediction mode in the intra prediction mode candidate list is one of 65 angular prediction modes. For another example, when the first angular accuracy corresponding to the intra prediction mode candidate list for the current block is 129, it indicates that each angular prediction mode in the intra prediction mode candidate list is one of 129 angular prediction modes.

Specific processes of determining the first angular accuracy corresponding to the intra prediction mode candidate list for the current block will be introduced below.

In some embodiments, the first angular accuracy corresponding to the intra prediction mode candidate list for the current block is a preset value or a default value. That is, both the decoding end and the encoding end determine a preset value or a default value as the first angular accuracy corresponding to the intra prediction mode candidate list for the current block. The preset value or the default value is indicated through a high-level signaling.

In some embodiments, the encoding end may determine the first angular accuracy through the following operations S201-A to S201-C.

In operation S201-A, a prediction manner used in prediction for the current block is determined.

In operation S201-B, if the prediction manner is a template matching-based prediction manner, an angular accuracy corresponding to the prediction manner is determined.

In operation S201-C, the first angular accuracy is determined based on the angular accuracy corresponding to the prediction manner.

The prediction manner used in prediction for the current block may also be referred to as a prediction tool, such as the TIMD or the DIMD, etc.

Specific types of the prediction manner (that is, the prediction tool) are not limited in the embodiments of the disclosure. Exemplarily, the prediction manner includes, but is not limited to at least one of the TIMD, the MPM, the TMRL, the SGPM, and the DIMD. That is, if the TIMD tool, the MPM tool, the TMRL tool, the SGPM tool or the DIMD tool is used for the current block, the angular accuracy corresponding to the TIMD, the MPM, the TMRL, the SGPM or the DIMD is determined as the first angular accuracy.

The above operation S201-A of determining the prediction manner used in prediction for the current block includes at least the following first and second manners.

First manner: the prediction manner used in prediction for the current block is a default manner.

Second manner: the prediction manner used in prediction for the current block is determined from multiple prediction manners based on the template of the current block. For example, when the encoding end perform prediction for the template of the current block by using multiple prediction manners respectively, the encoding end determines a prediction cost for each prediction manner, and determines a prediction manner with a minimum prediction cost as the prediction manner used for the current block.

After determining the prediction manner used in prediction for the current block, the encoding end determines whether the prediction manner is the template matching-based prediction manner; if the prediction manner is the template matching-based prediction manner, the encoding end determines an angular accuracy corresponding to the prediction manner, and then determines the first angular accuracy based on the angular accuracy corresponding to the prediction manner.

In the embodiment of the disclosure, manners of determining the first angular accuracy based on the angular accuracy corresponding to the prediction manner, include but are not limited to the following manners.

First manner: if the angular accuracy corresponding to the prediction manner is greater than a preset angular accuracy, the first angular accuracy is less than the angular accuracy corresponding to the prediction manner and greater than the preset angular accuracy. For example, if the angular accuracy corresponding to the prediction manner is 129 (corresponding to 129 angular prediction modes) and the preset angular accuracy is 65 (corresponding to 65 angular prediction modes), the first angular accuracy may be any angular accuracy less than 129 and greater than 65. For example, the first angular accuracy is 120, and the 120-angular-accuracy is a part of the 129-angular-accuracy, that is, 120 angular prediction modes are selected from 129 angular prediction modes, and the intra prediction mode candidate list is constructed based on the 120 angular prediction modes.

Second manner: the encoding end directly determines the angular accuracy corresponding to the prediction manner used in prediction for the current block, as the first angular accuracy.

After determining the first angular accuracy corresponding to the intra prediction mode candidate list based on operations of the manners, the encoding end performs the following operation S202.

In operation S202, the intra prediction mode candidate list is constructed based on the first angular accuracy.

As may be known from the above descriptions, in the TIMD tool, the DIMD tool, the TMRL tool, the SGPM tool or the MPM tool, it needs to construct an intra prediction mode candidate list when deriving an intra prediction mode, and candidate lists of these tools have different lengths and different construction methods respectively. However, at present, 65 angles are used during construction, which means that when a 129-angular-accuracy mode is filled in, it needs to match this mode back to a 65-angular-accuracy and then fill it into the candidate list, which causes accuracy loss. However, in the embodiment of the disclosure, a corresponding intra prediction mode candidate list is constructed based on the first angular accuracy corresponding to the TIMD, the DIMD, the TMRL, the SGPM or the MPM.

For example, the TIMD tool is used in prediction for the current block. Assuming that the first angular accuracy corresponding to the TIMD is 129, the intra prediction mode candidate list constructed by using the TIMD has an angular accuracy of 129.

For example, the TMRL tool is used in prediction for the current block, assuming that the first angular accuracy corresponding to the TMRL is 129, the intra prediction mode candidate list constructed by using the TMRL has an angular accuracy of 129.

For example, the MPM tool is used in prediction for the current block, assuming that the first angular accuracy corresponding to the MPM is 129, the intra prediction mode candidate list constructed by using the MPM has an angular accuracy of 129.

For example, the TIMD tool is used in prediction for the current block, assuming that the first angular accuracy corresponding to the TIMD is 65, the intra prediction mode candidate list constructed by using the TIMD has an angular accuracy of 65.

For example, the TMRL tool is used in prediction for the current block, assuming that the first angular accuracy corresponding to the TMRL is 65, the intra prediction mode candidate list constructed by using the TMRL has an angular accuracy of 65.

For example, the MPM tool is used in prediction for the current block, assuming that the first angular accuracy corresponding to the MPM is 65, the intra prediction mode candidate list constructed by using the MPM has an angular accuracy of 65.

In some embodiments, in the intra prediction mode candidate list of the TIMD, the DIMD, the TMRL, the SGPM, or the MPM or the like, modes in the intra prediction mode candidate list include modes selected for prediction blocks at positions around the current block. Based on this, the above operation S202 includes the following operations S202-A and S202-B.

In operation S202-A, first intra prediction modes for N prediction blocks around the current block are acquired, here N is a positive integer.

In operation S202-B, the intra prediction mode candidate list is constructed based on the first intra prediction modes for the N prediction blocks and the first angular accuracy.

Specific positions of the N prediction blocks are not limited in the embodiments of the disclosure.

In a possible implementation, the N prediction blocks include five prediction blocks at positions neighbouring the current block. Exemplarily, these five positions are shown in FIG. 17, and differences between these positions and the coordinate of the above-left corner of the current block in horizontal and vertical directions are: above-left (−1,−1), above (width−1,−1), above-right (width,−1), left (−1, height−1), bottom-left (−1, height) respectively, here width and height are a width and a height of the current block respectively.

Exemplarily, the prediction blocks at these five positions are selected in an order of: left, above, above-left, bottom-left, and above-right.

In another possible implementation, in the embodiment of the disclosure, when constructing the intra prediction mode candidate list, prediction modes for prediction blocks corresponding to blocks at more neighbouring and/or non-neighbouring positions around the current block may be used, to expand and acquire the intra prediction mode candidate list. For example, the N prediction blocks include P first prediction blocks and/or Q second prediction blocks, here the first prediction blocks are prediction blocks corresponding to encoded blocks neighbouring the current block, the second prediction blocks are prediction blocks corresponding to encoded blocks not neighbouring the current block, P and Q are positive integers less than or equal to N respectively, and a sum of P and Q is equal to N.

That is, in the embodiment of the disclosure, all of the N prediction blocks may be the prediction blocks corresponding to encoded blocks neighbouring the current block; or, all of the N prediction blocks may be the prediction blocks corresponding to encoded blocks not neighbouring the current block; or, the N prediction blocks may include the prediction blocks corresponding to encoded blocks neighbouring the current block and the prediction blocks corresponding to encoded blocks not neighbouring the current block.

At this time, the above operation S202-A of acquiring the first intra prediction modes for the N prediction blocks around the current block includes at least the following first and second manners.

First manner: if the N prediction blocks include the P first prediction blocks, the above operation S202-A includes the following operations S202-A-11 and S202-A-12 at this time.

In operation S202-A-11, a first access order of the P first prediction blocks is determined.

In operation S202-A-12, first intra prediction modes for the P first prediction blocks are acquired according to the first access order.

When the encoding end acquires the first intra prediction modes for the P first prediction blocks, the encoding end needs to access them in a certain access order, for example, the encoding end acquires the first intra prediction modes for the P first prediction blocks according to the first access order.

Specific manners of determining the first access order of the P first prediction blocks are not limited in the embodiments of the disclosure.

In an example, the above first access order of the P first prediction blocks is a preset order.

In another example, the encoding end may determine the first access order based on a size of the current block and sizes of P encoded blocks, and/or based on a shape of the current block and shapes of the P encoded blocks.

For example, for any one of the P encoded blocks: a first similarity is determined based on a size of the encoded block and the size of the current block, and/or a second similarity is determined based on a shape of the encoded block and the shape of the current block; and a total similarity between the encoded block and the current block is determined based on the first similarity and/or the second similarity. In this way, an access order of the P encoded blocks is determined according to the total similarities, and the access order of the P encoded blocks is determined as the first access order of the P first prediction blocks. For example, the greater the total similarity, the earlier the access to the encoded block.

For example, the positions neighbouring the current block may be eleven positions shown in FIG. 18, that is, the P first prediction blocks are eleven first prediction blocks, and these eleven first prediction blocks are prediction blocks corresponding to the positions shown in FIG. 18.

Differences between these eleven positions shown in FIG. 18 and the coordinate of the above-left corner of the current block in horizontal and vertical directions are: position 1 (−1, height−1), position 2 (width−1,−1), position 3 (−1,−1), position 4 (width,−1), position 5 (−1, height), position 6 (−1, height/2), position 7 (width/2,−1), position 8 (width/2−1,−1), position 9 (−1, height/2−1), position 10 (−1, 0), position 11 (0,−1) respectively. Here width and height are a width and a height of the current block respectively.

The encoding end determines the first access order of the first prediction blocks corresponding to the positions shown in the above FIG. 18, and then acquires the first intra prediction modes for the first prediction blocks at these eleven positions based on the first access order.

Exemplarily, the first access order of these eleven first prediction blocks is: position 1, position 2, position 3, position 5, position 4, position 10, position 11, position 9, position 8, position 6, and position 7.

Second manner: if the N prediction blocks include the Q second prediction blocks, the above operation S202-A includes the following operations S202-A-21 and S202-A-22 at this time.

In operation S202-A-21, a second access order of the Q second prediction blocks is determined.

In operation S202-A-22, first intra prediction modes for the Q second prediction blocks are acquired according to the second access order.

When the encoding end acquires the first intra prediction modes for the Q second prediction blocks, the encoding end needs to access them in a certain access order, for example, the encoding end acquires the first intra prediction modes for the Q second prediction blocks according to the second access order.

Specific manners of determining the second access order of the Q second prediction blocks are not limited in the embodiments of the disclosure.

In an example, the above second access order of the Q second prediction blocks is a preset order.

In another example, the encoding end may determine the second access order based on a size of the current block and sizes of Q encoded blocks, and/or based on a shape of the current block and shapes of the Q encoded blocks.

For example, for any one of the Q encoded blocks: a first similarity is determined based on a size of the encoded block and the size of the current block, and/or a second similarity is determined based on a shape of the encoded block and the shape of the current block; and a total similarity between the encoded block and the current block is determined based on the first similarity and/or the second similarity. In this way, an access order of the Q encoded blocks is determined according to the total similarities, and the access order of the Q encoded blocks is determined as the second access order of the Q second prediction blocks. For example, the greater the total similarity, the earlier the access to the encoded block.

First example: positions not neighbouring the current block may be positions with serial numbers of 12-31 shown in FIG. 19, that is, the Q second prediction blocks are twenty second prediction blocks, and these twenty second prediction blocks are prediction blocks corresponding to the positions shown in FIG. 19.

Differences between positions with serial numbers of 12-31 shown in FIG. 19 and the coordinate of the above-left corner of the current block in horizontal and vertical directions are: position 12 (−offsetX−1, height+offsetY−1), position 13 (width+offsetX−1,−offsetY−1), position 14 (width/2,−offsetY−1), position 15 (−offsetX−1, height/2), position 16 (−offsetX−1, −offsetY−1), position 17 (−offsetX*2−1, height+offsetY*2−1), position 18 (width+offset*2−1,−offsetY*2−1), position 19 (width/2,−offsetY*2−1), position 20 (−offsetX*2−1, height/2), position 21 (−offsetX*2−1,−offsetY*2−1), position 22 (−offsetX*3−1, height+offsetY*3−1), position 23 (width+offset*3−1,−offsetY*3−1), position 24 (width/2,−offsetY*3−1), position 25 (−offsetX*3−1, height/2), position 26 (−offsetX*3−1,−offsetY*3−1), position 27 (−offsetX*4−1, height+offsetY*4−1), position 28 (width+offset*4−1,−offsetY*4−1), position 29 (width/2,−offsetY*4−1), position 30 (−offsetX*4−1, height/2), position 31 (−offsetX*4−1,−offsetY*4−1) respectively. Here width and height are a width and a height of the current block respectively.

The encoding end determines the second access order of the second prediction blocks corresponding to the positions shown in the above FIG. 19, and then acquires the first intra prediction modes for the second prediction blocks at these twenty positions based on the second access order.

In FIG. 19, positions with serial numbers of 1-11 are the same as these eleven neighbouring positions shown in above FIG. 18.

Second example: positions not neighbouring the current block may be positions with serial numbers of 6-23 shown in FIG. 20, that is, the Q second prediction blocks are eighteen second prediction blocks, and these eighteen second prediction blocks are prediction blocks corresponding to the positions shown in FIG. 20.

Differences between positions with serial numbers of 6-23 shown in FIG. 20 and the coordinate of the above-left corner of the current block in horizontal and vertical directions are: position 6 (−offsetX−1, height+offsetY−1), position 7 (width+offsetX−1,−offsetY−1), position 8 (−offsetX−1,−offsetY−1), position 9 (−offsetX*2−1, height+offsetY*2−1), position 10 (width+offset*2−1,−offsetY*2−1), position 11 (width/2,−offsetY*2−1), position 12 (−offsetX*2−1, height/2), position 13 (−offsetX*2−1,−offsetY*2−1), position 14 (−offsetX*3−1, height+offsetY*3−1), position 15 (width+offset*3−1,−offsetY*3−1), position 16 (width/2,−offsetY*3−1), position 17 (−offsetX*3−1, height/2), position 18 (−offsetX*3−1,−offsetY*3−1), position 19 (−offsetX*4−1, height+offsetY*4−1), position 20 (width+offset*4−1,−offsetY*4−1), position 21 (width/2,−offsetY*4−1), position 22 (−offsetX*4−1, height/2), position 23 (−offsetX*4−1,−offsetY*4−1) respectively. Here width and height are a width and a height of the current block respectively.

The encoding end determines the second access order of the second prediction blocks corresponding to the positions shown in the above FIG. 20, and then acquires the first intra prediction modes for the second prediction blocks at these eighteen positions based on the second access order.

In FIG. 20, positions with serial numbers of 1-5 are the same as these five neighbouring positions shown in above FIG. 17.

It should be noted that in the above FIG. 19 and FIG. 20, offsetX and offsetY may be fixed values, may be equal to or different from each other, and may be variables that vary based on the shape and size of the block. In some embodiments, offsetX is equal to the width of the current block, and offsetY is equal to the height of the current block.

In some embodiments, in order to limit complexity, at least one encoded block of the encoded blocks neighbouring the current block and/or the encoded blocks not neighbouring the current block, and the current block correspond to a same CTU, that is, the current block and the at least one encoded block belong to different picture blocks in the same CTU.

In the embodiment of the disclosure, if all of the N prediction blocks are the P first prediction blocks, that is, when N=P, the encoding end acquires the first intra prediction modes for the P first prediction blocks by the method of the above first manner. If all of the N prediction blocks are the Q second prediction blocks, that is, when N=Q, the encoding end acquires the first intra prediction modes for the Q second prediction blocks by the method of the above second manner. If the N prediction blocks include the P first prediction blocks and the Q second prediction blocks, and N=P+Q, the encoding end acquires the first intra prediction modes for the P first prediction blocks by the method of the above first manner, acquires the first intra prediction modes for the Q second prediction blocks by the method of the above second manner, and then acquires the first intra prediction modes for the N prediction blocks.

Operations of the order for acquiring the first intra prediction modes for the N prediction blocks are sequentially described as above. Specific manners of acquiring the first intra prediction mode for the prediction block will be described below.

In the embodiment of the disclosure, the first intra prediction mode for the prediction block may be understood as an intra prediction mode used in prediction for the prediction block, or an intra prediction mode derived from the prediction mode used in prediction for the prediction block. For example, if the prediction block is an intra prediction block, the intra prediction mode used in prediction for the prediction block is determined as the first intra prediction mode; or another one or more intra prediction modes are derived based on the intra prediction mode used for the prediction block, as the first intra prediction mode for the prediction block. For another example, if the prediction block is an inter prediction block, the first intra prediction mode for the prediction block is derived based on an inter prediction manner used for the prediction block.

Exemplarily, in the embodiment of the disclosure, the first intra prediction mode for the prediction block is one of the above 67 intra prediction modes (including 65 angular prediction modes), or one of 131 intra prediction modes (including 129 angular prediction modes).

In the embodiment of the disclosure, for each of the N prediction blocks, a specific manner of determining the first intra prediction mode for the prediction block is the same. In order to facilitate descriptions, explanations will be made below by taking an example of acquiring a first intra prediction mode for an i-th prediction block.

In some embodiments, the first intra prediction mode for the i-th prediction block is determined based on a type of the i-th prediction block. For example, if the i-th prediction block is an intra prediction block, an intra prediction mode (such as an angular prediction mode) used in prediction for the i-th prediction block is determined as the first intra prediction mode for the i-th prediction block. For another example, if the i-th prediction block is an intra prediction block, an intra prediction mode is determined based on an inter prediction mode used in prediction for the i-th prediction block, as the first intra prediction mode for the i-th prediction block.

In some embodiments, the first intra prediction mode for the i-th prediction block is determined based on the prediction mode for the i-th prediction block. At this time, the above operation S202-A includes the following operations S202-A-31 and S202-A-32.

In operation S202-A-31, for an i-th prediction block from the N prediction blocks, a prediction manner used in prediction for the i-th prediction block is determined, here i is a positive integer less than or equal to N.

In operation S202-A-32, a first intra prediction mode for the i-th prediction block is determined based on the prediction manner.

In this embodiment, the prediction manner used in prediction for the i-th prediction block may be understood as a prediction tool or prediction technology used in prediction for the i-th prediction block. The prediction manner used in prediction for the i-th prediction block may be any prediction technology such as the above TIMD, DIMD, TMRL, MIP, intraTMP, GPM, SGPM, or traditional intra prediction mode, etc.

In an example, if the prediction manner used in prediction for the i-th prediction block is any one of a TIMD, a DIMD, a TMRL and a traditional intra prediction mode, an intra prediction mode derived from the prediction manner is determined as the first intra prediction mode for the i-th prediction block.

For example, if the i-th prediction block is an intra prediction block and the prediction manner (or prediction technology) used in prediction for the i-th prediction block is the TIMD or the TMRL, at least one intra prediction mode (such as an angular prediction mode) derived by using the TIMD or TMRL technology during prediction for the i-th prediction block is determined as the first intra prediction mode for the i-th prediction block.

For another example, if the i-th prediction block is an intra prediction block and the prediction manner (or prediction technology) used in prediction for the i-th prediction block is the DIMD, at least one intra prediction mode (such as an angular prediction mode) derived by using the DIMD technology during prediction for the i-th prediction block is determined as the first intra prediction mode for the i-th prediction block.

For another example, if the i-th prediction block is an intra prediction block and the prediction manner (or prediction technology) used in prediction for the i-th prediction block is the traditional intra prediction mode, at least one intra prediction mode (such as an angular prediction mode) derived from the traditional intra prediction mode during prediction for the i-th prediction block is determined as the first intra prediction mode for the i-th prediction block.

In an example, if the prediction manner used in prediction for the i-th prediction block is the MIP or the intraTMP, a first angular prediction mode is derived by using a DIMD manner, and the first angular prediction mode is determined as the first intra prediction mode for the i-th prediction block; or, the planar (PLANAR) mode is determined as the first intra prediction mode for the i-th prediction block.

In the embodiment of the disclosure, if the i-th prediction block is an intra prediction block and the prediction manner used in prediction for the i-th prediction block is the MIP or the intraTMP, since the MIP or the intraTMP cannot correspond to the angular prediction mode, it needs to replace the MIP or the intraTMP by other modes. Exemplarily, when the i-th prediction block is an intra prediction block and the prediction manner used in prediction for the i-th prediction block is the MIP or the intraTMP, there are at least two manners of determining the first intra prediction mode for the i-th prediction block.

First manner: a first angular prediction mode is derived through using the DIMD manner, as the first intra prediction mode for the i-th prediction block. For example, with reference to the above introduction of relevant technologies of the DIMD, an angular prediction mode may be derived from reconstructed pixels around an encoded block corresponding to the i-th prediction block, and the angular prediction mode is determined as the first intra prediction mode for the i-th prediction block.

Second manner: the PLANAR mode is directly determined as the first intra prediction mode for the i-th prediction block.

In an example, if the prediction manner used in prediction for the i-th prediction block is a GPM or an SGPM, an angular prediction mode corresponding to a partitioning angle of the GPM or the SGPM is determined as the first intra prediction mode for the i-th prediction block.

For example, if the i-th prediction block is an inter prediction block and the prediction manner (or prediction technology) used in prediction for the i-th prediction block is the GPM, a GPM partitioning mode corresponding to the i-th prediction block is determined (as shown in FIG. 11). Then, a GPM partitioning angle is determined based on the GPM partitioning mode, and an angular prediction mode corresponding to the GPM partitioning angle may be determined by looking up the above Table 1, and then the angular prediction mode is determined as the first intra prediction mode for the i-th prediction block.

For another example, if the i-th prediction block is an intra prediction block and the prediction manner (or prediction technology) used in prediction for the i-th prediction block is the SGPM, an SGPM partitioning mode corresponding to the i-th prediction block is determined (as shown in FIG. 11). Then, a partitioning angle is determined based on the SGPM partitioning mode, and an angular prediction mode corresponding to the SGPM partitioning angle may be determined by looking up the above Table 1, and then the angular prediction mode is determined as the first intra prediction mode for the i-th prediction block.

In an example, if the i-th prediction block is an inter prediction block and a prediction mode used in prediction for the i-th prediction block is not a GPM mode, an intra prediction mode in an intra prediction mode cache of the current block is determined as the first intra prediction mode for the i-th prediction block.

During prediction for the current block, one or more intra prediction modes are cached in the intra prediction mode cache of the current block, and the one or more intra prediction modes are intra prediction modes for reference blocks of the current block. In this way, when the i-th prediction block is an inter prediction block and the prediction mode used in prediction for the i-th prediction block is not the GPM mode, at least one intra prediction mode in the intra prediction mode cache of the current block may be determined as the first intra prediction mode for the i-th prediction block.

The encoding end may acquire the first intra prediction mode for each of the N prediction blocks, based on the above access order of the N prediction blocks and the above manners of acquiring the first intra prediction mode.

After acquiring the first intra prediction modes for the N prediction blocks, the encoding end performs the above operation S202-B, that is, constructs the intra prediction mode candidate list corresponding to the current block based on the first intra prediction modes for the N prediction blocks and the first angular accuracy.

In the embodiment of the disclosure, angular accuracies of prediction tools used in prediction for different prediction blocks of the N prediction blocks may not be exactly the same, and thus angular accuracies corresponding to the first intra prediction modes for the N prediction blocks are not exactly the same, either. For example, the TIMD is used in prediction for a prediction block 1, and an angular accuracy of the TIMD is 129, therefore an angular accuracy corresponding to a first intra prediction mode for the prediction block 1 is 129. For another example, the DIMD is used in prediction for a prediction block 2, and an angular accuracy of the DIMD is 65, therefore an angular accuracy corresponding to a first intra prediction mode for the prediction block 2 is 65. At this time, the angular accuracy corresponding to the first intra prediction mode for the prediction block 1 is different from the angular accuracy corresponding to the first intra prediction mode for the prediction block 2. Furthermore, an angular accuracy of at least one of the first intra prediction modes for the N prediction blocks may be different from the first angular accuracy. Therefore, after the encoding end acquires the first intra prediction modes for the N prediction blocks based on the above operations, it also needs to perform angle matching on the first intra prediction modes based on the first angular accuracy, to acquire second intra prediction modes, and then construct the intra prediction mode candidate list based on the second intra prediction modes.

Specific processes of constructing the intra prediction mode candidate list corresponding to the current block based on the first intra prediction modes for the N prediction blocks and the first angular accuracy will be introduced below.

In the above operation S202-B, manners of constructing the intra prediction mode candidate list corresponding to the current block based on the first intra prediction modes for the N prediction blocks and the first angular accuracy include at least the following first and second manners.

First manner: for each of the N prediction blocks, the encoding end compares an angular accuracy corresponding to a first intra prediction mode for the prediction block to the first angular accuracy. If the angular accuracy corresponding to the first intra prediction mode for the prediction block is different from the first angular accuracy, the encoding end performs accuracy matching on the first intra prediction mode for the prediction block, to acquire a second intra prediction mode of the first intra prediction mode of the prediction block at the first angular accuracy. If the angular accuracy corresponding to the first intra prediction mode for the prediction block is the same as the first angular accuracy, the encoding end determines the first intra prediction mode for the prediction block as the second intra prediction mode. In this way, the second intra prediction mode corresponding to the first intra prediction mode for each of the N prediction blocks may be determined, and then the intra prediction mode candidate list is constructed based on second intra prediction modes for the N prediction blocks. For example, different second intra prediction modes among the second intra prediction modes for the N prediction blocks are added to the intra prediction mode candidate list, until a length of the intra prediction mode candidate list reaches a preset length.

Second manner: the above operation S202-B includes the following operations S202-B1 to S202-B3.

In operation S202-B1, K first intra prediction modes are determined based on the first intra prediction modes for the N prediction blocks, here K is a positive integer less than or equal to N.

In operation S202-B2, second intra prediction modes corresponding to the K first intra prediction modes are determined based on the first angular accuracy.

In operation S202-B3, the intra prediction mode candidate list is constructed based on K second intra prediction modes.

In the second manner, the encoding end firstly selects K first intra prediction modes from the first intra prediction modes for the N prediction blocks, and the K first intra prediction modes are different from each other. Then, the encoding end compares an angular accuracy corresponding to each of the K first intra prediction modes to the first angular accuracy, to determine a second intra prediction mode corresponding to each of the K first intra prediction modes. Finally, the encoding end constructs the intra prediction mode candidate list based on the K second intra prediction modes.

In the embodiment of the disclosure, specific manners of determining the K first intra prediction modes based on the first intra prediction modes for the N prediction blocks include at least the following first to third manners.

First manner: the encoding end selects the K first intra prediction modes from the first intra prediction modes for the N prediction blocks, based on the above access order of the N prediction blocks.

Second manner: the above operation S202-B1 includes the following operations S202-B1-11 and S202-B1-12.

In operation S202-B1-11, part or all of the first intra prediction modes for the N prediction blocks are sorted, to acquire sorted first intra prediction modes.

In operation S202-B1-12, the K first intra prediction modes are determined based on the sorted first intra prediction modes.

As may be known from the above descriptions, in some embodiments, the N prediction blocks include P first prediction blocks; in some embodiments, the N prediction blocks include Q second prediction blocks; and in some embodiments, the N prediction blocks include both P first prediction blocks and Q second prediction blocks.

Based on this, manners of sorting part or all of the first intra prediction modes for the N prediction blocks, to acquire the sorted first intra prediction modes may include the following first to fourth examples.

First example: if the N prediction blocks include the P first prediction blocks, first intra prediction modes for the P first prediction blocks of the N prediction blocks are sorted, to acquire the sorted first intra prediction modes.

That is, in the first example, only the first intra prediction modes for the P first prediction blocks of the N prediction blocks are sorted, and if the N prediction blocks further include second prediction blocks, first intra prediction modes for the second prediction blocks are not sorted.

In this example, a manner of sorting the first intra prediction modes for the P first prediction blocks may be that the first intra prediction modes for the first prediction blocks are used to predict the template of the current block, to determine prediction values of the template, and first prediction costs of the first intra prediction modes are determined based on the prediction values and reconstruction values of the template. With reference to this manner, the first prediction cost corresponding to the first intra prediction mode for each of the P first prediction blocks may be determined, and then the first intra prediction modes for the P first prediction blocks may be sorted based on the first prediction costs (for example, in an ascending order of the first prediction costs) to acquire the sorted first intra prediction modes.

Second example: if the N prediction blocks include the Q second prediction blocks, first intra prediction modes for the Q second prediction blocks of the N prediction blocks are sorted, to acquire the sorted first intra prediction modes.

That is, in the second example, only the first intra prediction modes for the Q second prediction blocks of the N prediction blocks are sorted, and if the N prediction blocks further include first prediction blocks, first intra prediction modes for the first prediction blocks are not sorted.

In this example, a manner of sorting the first intra prediction modes for the Q second prediction blocks may be that the first intra prediction modes for the second prediction blocks are used to predict the template of the current block, to determine prediction values of the template, and first prediction costs of the first intra prediction modes are determined based on the prediction values and reconstruction values of the template. With reference to this manner, the first prediction cost corresponding to the first intra prediction mode for each of the Q second prediction blocks may be determined, and then the first intra prediction modes for the Q second prediction blocks may be sorted based on the first prediction costs (for example, in an ascending order of the first prediction costs) to acquire the sorted first intra prediction modes.

Third example: the first intra prediction modes for the N prediction blocks are sorted, to acquire the sorted first intra prediction modes.

In the embodiment of the disclosure, both the above first example and second example may be understood as a solution for sorting part of the first intra prediction modes for the N prediction blocks. The above third example may be understood as a solution for sorting all of the first intra prediction modes for the N prediction blocks.

That is, in the third example, no matter the N prediction blocks are N first prediction blocks, or the N prediction blocks are N second prediction blocks, or the N prediction blocks include first prediction blocks and second prediction blocks, the encoding end sorts all of the first intra prediction modes for the N prediction blocks.

In this example, a manner of sorting the first intra prediction modes for the N prediction blocks may be that the first intra prediction modes are used to predict the template of the current block, to determine prediction values of the template, and first prediction costs of the first intra prediction modes are determined based on the prediction values and reconstruction values of the template. With reference to this manner, the first prediction cost corresponding to each of the first intra prediction modes may be determined, and then the first intra prediction modes for the N prediction blocks may be sorted based on the first prediction costs (for example, in an ascending order of the first prediction costs) to acquire the sorted first intra prediction modes.

Fourth example: R first intra prediction modes are selected from the first intra prediction modes for the N prediction blocks, here R is a positive integer less than N; and the R first intra prediction modes are sorted, to acquire the sorted first intra prediction modes.

In this fourth example, the encoding end selects R first intra prediction modes from the first intra prediction modes for the N prediction blocks, for example, selects R first intra prediction modes from the first intra prediction modes for the N prediction blocks according to a preset order or rule. Then, the encoding end sorts the selected R first intra prediction modes, to acquire the sorted first intra prediction modes.

In this example, a manner of sorting the R first intra prediction modes may be that the first intra prediction modes are used to predict for the template of the current block, to determine prediction values of the template, and first prediction costs of the first intra prediction modes are determined based on the prediction values and reconstruction values of the template. With reference to this manner, the first prediction cost corresponding to each of the first intra prediction modes may be determined, and then the R first intra prediction modes may be sorted based on the first prediction costs (for example, in an ascending order of the first prediction costs) to acquire the sorted first intra prediction modes.

In the second manner, the encoding end sorts part or all of the first intra prediction modes for the N prediction blocks based on the above operations, to acquire the sorted first intra prediction modes, and then determines K first intra prediction modes based on the sorted first intra prediction modes. For example, the first intra prediction modes are sorted in an ascending order of the first prediction costs, such that first K first intra prediction modes may be selected from the sorted first intra prediction modes, to acquire the K first intra prediction modes.

In addition to acquiring the K first intra prediction modes by using the above second manner, the encoding end may acquire the K first intra prediction modes by using the following third manner.

Third manner: the above operation S202-B1 includes the following operations S202-B1-21 and S202-B1-22.

In operation S202-B1-21, first intra prediction mode(s) corresponding to a DIMD are determined.

In operation S202-B1-22, the K first intra prediction modes are determined based on the first intra prediction mode(s) corresponding to the DIMD and the first intra prediction modes for the N prediction blocks.

In the third manner, the K first intra prediction modes are determined from the first intra prediction mode(s) corresponding to the DIMD and the first intra prediction modes for the N prediction blocks. A manner of deriving the first intra prediction modes by using the DIMD manner may refer to the above relevant introduction of DIMD technologies. For example, in regions of the templates of the current block, one or more intra prediction modes are derived by using the DIMD technologies, and the one or more intra prediction modes are recorded as the first intra prediction modes corresponding to the DIMD.

Then, the K first intra prediction modes are determined from the first intra prediction mode(s) corresponding to the DIMD and the first intra prediction modes for the N prediction blocks.

Specific implementations of determining the K first intra prediction modes from the first intra prediction mode(s) corresponding to the DIMD and the first intra prediction modes for the N prediction blocks include at least the following manners.

In a manner, the K first intra prediction modes are selected from the first intra prediction mode(s) corresponding to the DIMD and the first intra prediction modes for the N prediction blocks according to a preset order or rule.

In another manner, S first intra prediction modes are selected from the first intra prediction mode(s) corresponding to the DIMD and the first intra prediction modes for the N prediction blocks, here S is a positive integer; the S first intra prediction modes are sorted, to acquire sorted S first intra prediction modes; and the K first intra prediction modes are determined based on the sorted S first intra prediction modes.

In this implementation, the encoding end selects S first intra prediction modes from the first intra prediction modes corresponding to the DIMD and the first intra prediction modes for the N prediction blocks according to a preset order or rule. Then, the encoding end sorts the S first intra prediction modes, to acquire sorted S first intra prediction modes, for example, the encoding end calculates a respective prediction value of each of the S first intra prediction modes for the templates of the current block, and acquires a respective first prediction cost corresponding to each of the S first intra prediction modes based on reconstruction values of the template and prediction values of the template corresponding to each first intra prediction mode. Then, the encoding end sorts the S first intra prediction modes based on the first prediction costs, to acquire the sorted S first intra prediction modes, for example, the encoding end sorts the S first intra prediction modes in an ascending order of the first prediction costs, to acquire the sorted S first intra prediction modes. In this way, the K first intra prediction modes may be determined from the sorted S first intra prediction modes, for example, first K first intra prediction modes of the sorted S first intra prediction modes are determined as the K first intra prediction modes.

After determining the K first intra prediction modes based on the first intra prediction modes for the N prediction blocks based on the above operations, the encoding end performs the above operation S202-B2.

The operation of determining the second intra prediction modes corresponding to the K first intra prediction modes, based on the first angular accuracy may include the following first and second cases.

First case: for an i-th first intra prediction mode of the K first intra prediction modes, if an angular accuracy corresponding to the i-th first intra prediction mode is consistent with the first angular accuracy, the i-th first intra prediction mode is determined as an i-th second intra prediction mode, here i is a positive integer less than or equal to N.

Second case: for an i-th first intra prediction mode of the K first intra prediction modes, if an angular accuracy corresponding to the i-th first intra prediction mode is different from the first angular accuracy, a second intra prediction mode corresponding to the i-th first intra prediction mode at the first angular accuracy is determined.

In some embodiments, correspondences between indices of 129-angular-accuracy and 65-angular-accuracy and indices of a traditional prediction mode in angular directions are shown in FIG. 21. ipmExt refers to an index of an intra prediction mode with 129-angular-accuracy, and ipm refers to an index of an intra prediction mode with 65-angular-accuracy.

Exemplarily, when both the ipmExt and the ipm are 0, corresponding intra prediction modes are the planar mode.

Exemplarily, when both the ipmExt and the ipm are 1, corresponding intra prediction modes are the DC mode.

Exemplarily, when the ipmExt ranges from 2 to 130, corresponding intra prediction modes have 129 angles, the angular directions may substantially refer to those shown in FIG.

Exemplarily, when the ipm ranges from 2 to 66, corresponding intra prediction modes have 65 angles, the angular directions may substantially refer to those shown in FIG. 21.

In an example, a matching relationship between the ipm and the ipmExt is shown in the above formulas (5) and (6).

For example, when the angular accuracy corresponding to the i-th first intra prediction mode is 65, and the first angular accuracy is 129, a second intra prediction mode corresponding to the i-th first intra prediction mode at the angular accuracy of 129 may be determined by the above formula (6).

For another example, when the angular accuracy corresponding to the i-th first intra prediction mode is 129, and the first angular accuracy is 65, a second intra prediction mode corresponding to the i-th first intra prediction mode at the angular accuracy of 65 may be determined by the above formula (5).

In some embodiments, the encoding end may construct the intra prediction mode candidate list by the following operations S202-C to S202-E, in addition to constructing the intra prediction mode candidate list based on the first intra prediction modes for the N prediction blocks around the current block as shown in the above embodiments.

In operation S202-C, M intra prediction modes are acquired from existing intra prediction modes in a current intra prediction mode candidate list, here Mis a positive integer.

In operation S202-D, for a j-th intra prediction mode of the M intra prediction modes, an intra prediction mode similar to the j-th intra prediction mode is determined based on the first angular accuracy, here j is a positive integer less than or equal to M.

In operation S202-E, the similar intra prediction mode is added to the intra prediction mode candidate list.

In this embodiment, the encoding end acquires the M intra prediction modes from the existing intra prediction modes in the current intra prediction mode candidate list; determines, based on the first angular accuracy, respective intra prediction modes similar to each of the M intra prediction modes; and then, adds these similar intra prediction modes to the intra prediction mode candidate list, until a length of the intra prediction mode candidate list is equal to a preset length.

In this embodiment, there is at least one intra prediction mode existing in the intra prediction mode candidate list. That is, when the encoding end determines that a length of the current intra prediction mode candidate list is less than a preset length, the encoding end acquires the M intra prediction modes from the existing intra prediction modes in the current intra prediction mode candidate list.

In some embodiments, the existing intra prediction modes in the current intra prediction mode candidate list may be some default intra prediction modes, such as the PLANAR mode, etc.

In some embodiments, the existing intra prediction modes in the current intra prediction mode candidate list may be the K second intra prediction modes determined by the above method. That is, the encoding end acquires the first intra prediction modes for the N prediction blocks around the current block based on the above method, and determines the K first intra prediction modes based on the first intra prediction modes for the N prediction blocks. Then, the encoding end determines, based on the first angular accuracy, the second intra prediction modes corresponding to the K first intra prediction modes respectively, and then adds different second intra prediction modes of the K second intra prediction modes to the intra prediction mode candidate list. Next, the encoding end determines whether the length of the intra prediction mode candidate list reaches the preset length at this time. If the length of the intra prediction mode candidate list is less than the preset length, the encoding end performs the above operations S202-C to S202-E to determine at least one similar intra prediction mode, and adds intra prediction modes of the at least one similar intra prediction mode that do not repeat with the existing intra prediction modes to the intra prediction mode candidate list.

In the embodiment of the disclosure, manners of determining intra prediction modes similar to each of the M intra prediction modes are consistent. In order to facilitate descriptions, explanations will be made below by taking the j-th intra prediction mode as an example.

In some embodiments, the intra prediction modes similar to the j-th intra prediction mode include: a first similar prediction mode with an index less than a first index of the j-th intra prediction mode, and/or a second similar prediction mode with an index greater than the first index.

In some embodiments, the above operation S202-D of determining, based on the first angular accuracy, the intra prediction modes similar to the j-th intra prediction mode includes manners shown in the following examples.

In an example, if preset modes similar to the j-th intra prediction mode include the first similar prediction mode, and if the j-th intra prediction mode is not a first angular prediction mode among prediction modes corresponding to the first angular accuracy, a prediction mode (among the prediction modes corresponding to the first angular accuracy) with an index less than the first index by a first value is determined as the first similar prediction mode.

In an example, if the intra prediction modes similar to the j-th intra prediction mode include the first similar prediction mode, and if the j-th intra prediction mode is the first angular prediction mode among the prediction modes corresponding to the first angular accuracy, a prediction mode (among the prediction modes corresponding to the first angular accuracy) with an index less than an index of a prediction mode in an opposite direction of the j-th intra prediction mode by the first value is determined as the first similar prediction mode. For example, the first angular accuracy is 65, if ipm of the j-th prediction mode is 2, ipm. of the first similar prediction mode is an angular mode index that differs from the ipm by the first value (such as delta+1) in an opposite angular direction of the ipm. For another example, the first angular accuracy is 129, if ipmExt of the j-th prediction mode is 2, ipmExt. of the first similar prediction mode is an angular mode index that differs from the ipmExt by the first value (such as delta+1) in an opposite angular direction of the ipmExt.

In an example, if the preset mode similar to the j-th intra prediction mode include the second similar prediction mode, and if the j-th intra prediction mode is not a last angular prediction mode among the prediction modes corresponding to the first angular accuracy, a prediction mode (among the prediction modes corresponding to the first angular accuracy) with an index greater than the first index by the first value is determined as the second similar prediction mode.

In an example, if the preset mode similar to the j-th intra prediction mode include the second similar prediction mode, and if the j-th intra prediction mode is a last angular prediction mode among the prediction modes corresponding to the first angular accuracy, a prediction mode (among the prediction modes corresponding to the first angular accuracy) with an index greater than an index of a prediction mode in an opposite direction of the j-th intra prediction mode by the first value is determined as the second similar prediction mode. For example, the first angular accuracy is 65, if ipm of the j-th prediction mode is 66, ipm of the first similar prediction mode is an angular mode index that differs from the ipm by the first value (such as delta+1) in an opposite angular direction of the ipm. For another example, the first angular accuracy is 129, if ipmExt of the j-th prediction mode is 130, ipmExt of the first similar prediction mode is an angular mode index that differs from the ipmExt by the first value (such as delta+1) in an opposite angular direction of the ipmExt.

Specific values of the above first value are not limited in the embodiments of the disclosure.

In a possible implementation, the above first value may be a preset value.

In another possible implementation, the above first value is a sum of a first preset value and 1. The first preset value is delta, and delta is a positive integer equal to or greater than 0. In some embodiments, delta is less than 4.

In some embodiments, the above operation S202-D of determining, based on the first angular accuracy, the intra prediction modes similar to the j-th intra prediction mode includes the following operations S202-D1 and S202-D2.

In operation S202-D1, a second numerical value and/or a third numerical value are determined based on the first angular accuracy.

In operation S202-D2, the first similar prediction mode and/or the second similar prediction mode are determined based on the second numerical value and/or the third numerical value.

Specific manners of determining the second numerical value and/or the third numerical value based on the first angular accuracy are not limited in the embodiments of the disclosure.

In an example, the above different angular accuracies correspond to different second numerical values and/or third numerical values, both the second numerical value and the third numerical value are preset values. For example, when the first angular accuracy is 65, the second numerical value is 61 and the third numerical value is 64. For another example, when the first angular accuracy is 129, the second numerical value is 125 and the third numerical value is 128.

In another example, a value acquired by subtracting 4 from the first angular accuracy is determined as the second numerical value, and a value acquired by subtracting 1 from the first angular accuracy is determined as the third numerical value.

After determining the second numerical value and/or the third numerical value, the encoding end determines the first similar prediction mode and/or the second similar prediction mode based on the second numerical value and/or the third numerical value. Specifically, the encoding end determines the first similar prediction mode based on the second numerical value and the third numerical value, and determines the second similar prediction mode based on the third numerical value.

In some embodiments, the encoding end adds the first index of the j-th intra prediction mode to the second numerical value, and then subtracts a first preset value to acquire a fourth numerical value; calculates a modulo of the fourth numerical value with respect to the third numerical value, and then adds a second preset value to the modulo result, to acquire an index corresponding to the first similar prediction mode; and determines the first similar prediction mode from prediction modes corresponding to the first angular accuracy, based on the index corresponding to the first similar prediction mode.

In some other embodiments, the encoding end subtracts a third preset value from an index of the j-th intra prediction mode, and then adds a first preset value to acquire a fifth numerical value; calculates a modulo of the fifth numerical value with respect to the third numerical value, and then adds a second preset value to the modulo result, to acquire an index corresponding to the second similar prediction mode; and determines the second similar prediction mode from prediction modes corresponding to the first angular accuracy, based on the index corresponding to the second similar prediction mode.

For example, if the first angular accuracy is 65, the encoding end may determine the first similar prediction mode and the second similar prediction mode that are similar to the j-th intra prediction mode by the above formula (7).

For another example, if the first angular accuracy is 129, the encoding end may determine the first similar prediction mode and the second similar prediction mode that are similar to the j-th intra prediction mode by the above formula (8).

Respective intra prediction modes similar to each of the M intra prediction modes may be determined based on the above operations, and then the similar intra prediction modes are added to the intra prediction mode candidate list, until the length of the list reaches the preset length.

In some embodiments, if a length of the intra prediction mode candidate list does not reach a preset length, the method further includes the following operations. A second angular accuracy corresponding to a default angular prediction mode is determined. If the second angular accuracy is different from the first angular accuracy, a second intra prediction mode corresponding to the default angular prediction mode at the first angular accuracy is determined. The second intra prediction mode corresponding to the default angular prediction mode is added to the intra prediction mode candidate list. The operation of determining the second intra prediction mode corresponding to the default angular prediction mode at the first angular accuracy may refer to relevant descriptions of the above embodiments, which will not be elaborated here.

Processes of constructing the intra prediction mode candidate list in the embodiment of the disclosure will be further explained below by way of examples.

Assuming that angular accuracy corresponding to TMRL and TIMD technologies is 129, and angular accuracy corresponding to DIMD, MPM, SGPM and GPM technologies is 65.

First example: an MPM candidate list is constructed, and a first angular accuracy corresponding to the MPM candidate list is 65.

First manner: the MPM candidate list is constructed by the following operations 11 to 15.

In operation 11, the PLANAR mode is arranged at a first position of the MPM candidate list.

In operation 12, non-repeating second intra prediction modes among second intra prediction modes corresponding to first intra prediction modes for P first prediction blocks corresponding to encoded blocks at positions neighbouring the current block are filled into the MPM candidate list one by one in a certain order. Exemplarily, the P first prediction blocks are prediction blocks at eleven neighbouring positions around the current block in FIG. 18. Specifically, the following processes are performed for an i-th first prediction block from these eleven first prediction blocks.

When the i-th first prediction block is an intra prediction block and uses a TIMD or TMRL mode, an index of intra prediction modes corresponding to the i-th first prediction block is matched from an angular accuracy of 129 to an angular accuracy of 65, that is, from 129 angular prediction modes back to 65 angular prediction modes, and the an index of the intra prediction modes is acquired.

When the i-th first prediction block is an intra prediction block, and when a prediction mode for the i-th first prediction block is a MIP or an intraTMP, an index of the PLANAR mode is used for processing.

When the i-th first prediction block is an intra prediction block, and when the prediction mode for the i-th first prediction block is a DIMD mode, an index of intra prediction mode with an angular accuracy of 65 derived through the DIMD are acquired.

When the i-th first prediction block is an intra prediction block, and when the prediction mode for the i-th first prediction block is an SGPM mode, an index of angular prediction modes corresponding to SGPM partitioning angles are acquired.

When the i-th first prediction block is an intra prediction block, and when the prediction mode for the i-th first prediction block is a traditional intra prediction mode, an index of intra prediction mode is acquired.

When the i-th first prediction block is an inter prediction block, and when the prediction mode for the i-th first prediction block is a GPM mode, an index of angular prediction mode corresponding to GPM partitioning angle is acquired.

When the i-th first prediction block is an inter prediction block, and when the prediction mode for the i-th first prediction block is not the GPM mode, an index of intra prediction mode in an intra prediction mode cache of the current block is acquired.

It should be noted that indices of the intra prediction modes acquired as above may be understood as indices of the second intra prediction modes.

In operation 13, indices of one or more (for example, two) angular modes derived by using a DIMD tool for the current block are acquired.

In operation 14, existing angular prediction modes in an intra prediction candidate list are expanded through similar angles, to acquire at least one expanded angular prediction mode.

In operation 15, the intra prediction candidate list is filled with indices of modes with an angular accuracy of 65 in a default mode list.

It should be noted that in the above operations 11-15, when the number of filled modes reaches the required to-be-filled number, filling should be stopped.

Second manner: the MPM candidate list is constructed by the following operations 21 to 26.

In operation 21, the PLANAR mode is arranged at a first position of the MPM candidate list.

In operation 22, non-repeating second intra prediction modes among second intra prediction modes corresponding to first intra prediction modes for P first prediction blocks corresponding to encoded blocks at positions neighbouring the current block are filled into the MPM candidate list one by one in a certain order. Exemplarily, the P first prediction blocks are prediction blocks at eleven neighbouring positions around the current block in FIG. 19. Specifically, the following processes are performed for an i-th first prediction block of these eleven first prediction blocks.

When the i-th first prediction block is an intra prediction block and uses a TIMD or TMRL mode, an index of an intra prediction mode corresponding to the i-th first prediction block is matched from an angular accuracy of 129 to an angular accuracy of 65, that is, from 129 angular prediction modes to 65 angular prediction modes, and the an index of the intra prediction modes are acquired.

When the i-th first prediction block is an intra prediction block, and when a prediction mode for the i-th first prediction block is a MIP or an intraTMP, an index of the PLANAR mode is used for processing.

When the i-th first prediction block is an intra prediction block, and when the prediction mode for the i-th first prediction block is a DIMD mode, an index of intra prediction mode with a 65-angular-accuracy derived through the DIMD is acquired.

When the i-th first prediction block is an intra prediction block, and when the prediction mode for the i-th first prediction block is an SGPM mode, an index of angular prediction modes corresponding to SGPM partitioning angle is acquired.

When the i-th first prediction block is an intra prediction block, and when the prediction mode for the i-th first prediction block is a traditional intra prediction mode, an index of intra prediction mode is acquired.

When the i-th first prediction block is an inter prediction block, and when the prediction mode for the i-th first prediction block is a GPM mode, an index of angular prediction mode corresponding to GPM partitioning angle is acquired.

When the i-th first prediction block is an inter prediction block, and when the prediction mode for the i-th first prediction block is not the GPM mode, an index of intra prediction mode in an intra prediction mode cache of the current block is acquired.

It should be noted that indices of the intra prediction modes acquired as above may be understood as indices of the second intra prediction modes.

In operation 23, indices of one or more (for example, two) angular modes derived by using a DIMD tool for the current block are acquired.

In operation 24, non-repeating second intra prediction modes among second intra prediction modes corresponding to first intra prediction modes for Q second prediction blocks corresponding to encoded blocks at positions not neighbouring the current block are filled into the MPM candidate list one by one in a certain order. Exemplarily, the Q second prediction blocks are prediction blocks at twenty non-neighbouring positions around the current block in FIG. 19. Specifically, the following processes are performed for an i-th second prediction block from these twenty second prediction blocks.

When the i-th second prediction block is an intra prediction block and uses a TIMD or TMRL mode, an index of intra prediction mode corresponding to the i-th second prediction block is matched from an angular accuracy of 129 to an angular accuracy of 65, that is, from 129 angular prediction modes to 65 angular prediction modes, and the an index of the intra prediction mode is acquired.

When the i-th second prediction block is an intra prediction block, and when a prediction mode for the i-th second prediction block is a MIP or an intraTMP, an index of the PLANAR mode is used for processing.

When the i-th second prediction block is an intra prediction block, and when the prediction mode for the i-th second prediction block is a DIMD mode, an index of intra prediction mode with an angular accuracy of 65 derived by the DIMD is acquired.

When the i-th second prediction block is an intra prediction block, and when the prediction mode for the i-th second prediction block is an SGPM mode, an index of angular prediction mode corresponding to SGPM partitioning angle is acquired.

When the i-th second prediction block is an intra prediction block, and when the prediction mode for the i-th second prediction block is a traditional intra prediction mode, an index of intra prediction mode is acquired.

When the i-th second prediction block is an inter prediction block, and when the prediction mode for the i-th second prediction block is a GPM mode, an index of angular prediction mode corresponding to GPM partitioning angle is acquired.

When the i-th second prediction block is an inter prediction block, and when the prediction mode for the i-th second prediction block is not the GPM mode, an index of intra prediction mode in an intra prediction mode cache of the current block is acquired.

In operation 25, existing angular prediction modes in an intra prediction candidate list are expanded through similar angles, to acquire at least one expanded angular prediction mode.

In operation 26, the intra prediction candidate list is filled with indices of modes with an angular accuracy of 65 in a default mode list.

It should be noted that in the above operations 21-26, when the number of filled modes reaches the required to-be-filled number, filling should be stopped.

Third manner: the MPM candidate list is constructed by the following operations 31 to 36.

In operation 31, the PLANAR mode is arranged at a first position of the MPM candidate list.

In operation 32, non-repeating second intra prediction modes among second intra prediction modes corresponding to first intra prediction modes for P first prediction blocks corresponding to encoded blocks at positions neighbouring the current block are filled into the MPM candidate list one by one in a certain order. Exemplarily, the P first prediction blocks are prediction blocks at five neighbouring positions around the current block in FIG. 20. Specifically, the following processes are performed for an i-th first prediction block from these five first prediction blocks.

When the i-th first prediction block is an intra prediction block and uses a TIMD or TMRL mode, an index of intra prediction mode corresponding to the i-th first prediction block is matched from an angular accuracy of 129 to an angular accuracy of 65, that is, from 129 angular prediction modes to 65 angular prediction modes, and the an index of the intra prediction mode is acquired.

When the i-th first prediction block is an intra prediction block, and when a prediction mode for the i-th first prediction block is a MIP or an intraTMP, an index of the PLANAR mode is used for processing.

When the i-th first prediction block is an intra prediction block, and when the prediction mode for the i-th first prediction block is a DIMD mode, an index of intra prediction mode with a 65-angular-accuracy derived through the DIMD is acquired.

When the i-th first prediction block is an intra prediction block, and when the prediction mode for the i-th first prediction block is an SGPM mode, an index of angular prediction mode corresponding to SGPM partitioning angle is acquired.

When the i-th first prediction block is an intra prediction block, and when the prediction mode for the i-th first prediction block is a traditional intra prediction mode, an index of intra prediction mode is acquired.

When the i-th first prediction block is an inter prediction block, and when the prediction mode for the i-th first prediction block is a GPM mode, an index of angular prediction mode corresponding to GPM partitioning angle is acquired.

When the i-th first prediction block is an inter prediction block, and when the prediction mode for the i-th first prediction block is not the GPM mode, an index of intra prediction mode in an intra prediction mode cache of the current block is acquired.

It should be noted that indices of the intra prediction modes acquired as above may be understood as indices of the second intra prediction modes.

In operation 33, indices of one or more (for example, two) angular modes derived by using a DIMD tool for the current block are acquired.

In operation 34, non-repeating second intra prediction modes among second intra prediction modes corresponding to first intra prediction modes for Q second prediction blocks corresponding to encoded blocks at positions not neighbouring the current block are filled into the MPM candidate list one by one in a certain order. Exemplarily, the Q second prediction blocks are prediction blocks at eighteen non-neighbouring positions around the current block in FIG. 20. Specifically, the following processes are performed for an i-th second prediction block from these eighteen second prediction blocks.

When the i-th second prediction block is an intra prediction block and uses a TIMD or TMRL mode, an index of intra prediction mode corresponding to the i-th second prediction block is matched from an angular accuracy of 129 to an angular accuracy of 65, that is, from 129 angular prediction modes to 65 angular prediction modes, and the an index of the intra prediction mode is acquired.

When the i-th second prediction block is an intra prediction block, and when a prediction mode for the i-th second prediction block is a MIP or an intraTMP, an index of the PLANAR mode is used for processing.

When the i-th second prediction block is an intra prediction block, and when the prediction mode for the i-th second prediction block is a DIMD mode, an index of intra prediction mode with an angular accuracy of 65 derived through the DIMD is acquired.

When the i-th second prediction block is an intra prediction block, and when the prediction mode for the i-th second prediction block is an SGPM mode, an index of angular prediction mode corresponding to SGPM partitioning angle is acquired.

When the i-th second prediction block is an intra prediction block, and when the prediction mode for the i-th second prediction block is a traditional intra prediction mode, an index of intra prediction mode is acquired.

When the i-th second prediction block is an inter prediction block, and when the prediction mode for the i-th second prediction block is a GPM mode, an index of angular prediction mode corresponding to GPM partitioning angle is acquired.

When the i-th second prediction block is an inter prediction block, and when the prediction mode for the i-th second prediction block is not the GPM mode, an index of intra prediction mode in an intra prediction mode cache of the current block is acquired.

In operation 35, existing angular prediction modes in an intra prediction candidate list are expanded through similar angles, to acquire at least one expanded angular prediction mode.

In operation 36, the intra prediction candidate list is filled with indices of modes with an angular accuracy of 65 in a default mode list.

It should be noted that in the above operations 31-36, when the number of filled modes reaches the required to-be-filled number, filling should be stopped.

In some embodiments, a total number of modes acquired at neighbouring and non-neighbouring positions and modes derived by the DIMD may be limited to not exceed a preset value. The preset value may be an agreed value followed by the encoder and the decoder together.

Second example: a TMRL candidate list is constructed, and a first angular accuracy corresponding to the TMRL candidate list is 129

First manner: the TMRL candidate list is constructed by the following operations 41 to 44.

In operation 41, non-repeating second intra prediction modes among second intra prediction modes corresponding to first intra prediction modes for P first prediction blocks corresponding to encoded blocks at positions neighbouring the current block are filled into the TMRL candidate list one by one in a certain order. Exemplarily, the P first prediction blocks are prediction blocks at eleven neighbouring positions around the current block in FIG. 18. Specifically, the following processes are performed for an i-th first prediction block from these eleven first prediction blocks.

When the i-th first prediction block is an intra prediction block and uses a TIMD or TMRL mode, an index of intra prediction mode corresponding to the i-th first prediction block is acquired.

When the i-th first prediction block is an intra prediction block, and when a prediction mode for the i-th first prediction block is a MIP or an intraTMP, an index of the PLANAR mode is used for processing.

When the i-th first prediction block is an intra prediction block, and when the prediction mode for the i-th first prediction block is a DIMD mode, an index of intra prediction mode with an angular accuracy of 65 derived by the DIMD is matched to an index of intra prediction mode with an angular accuracy of 129.

When the i-th first prediction block is an intra prediction block, and when the prediction mode for the i-th first prediction block is an SGPM mode, an index of angular prediction mode corresponding to SGPM partitioning angle is matched to an index of intra prediction mode with an angular accuracy of 129.

When the i-th first prediction block is an intra prediction block, and when the prediction mode for the i-th first prediction block is a traditional intra prediction mode, an index of a first intra prediction mode for the i-th first prediction block is matched to an index of an intra prediction mode with an angular accuracy of 129.

When the i-th first prediction block is an inter prediction block, and when the prediction mode for the i-th first prediction block is a GPM mode, an index of intra prediction mode corresponding to GPM partitioning is matched to an index of intra prediction mode with an angular accuracy of 129.

When the i-th first prediction block is an inter prediction block, and when the prediction mode for the i-th first prediction block is not the GPM mode, an index of intra prediction mode in an intra prediction mode cache of the current block is matched to an index of intra prediction mode with an angular accuracy of 129.

It should be noted that indices of the intra prediction modes acquired as above may be understood as indices of the second intra prediction modes.

In operation 42, indices of one or more (for example, two) angular modes derived by using a DIMD tool for the current block are acquired and matched to indices of intra prediction modes with an angular accuracy of 129.

In operation 43, existing angular prediction modes in an intra prediction candidate list are expanded through similar angles, to acquire at least one expanded angular prediction mode.

In operation 44, indices of modes with an angular accuracy of 65 in a default mode list are used to match to indices of intra prediction modes with an angular accuracy of 129.

It should be noted that in the above operations 41-44, when the number of filled modes reaches the required to-be-filled number, filling should be stopped.

Second manner: the TMRL candidate list is constructed by the following operations 51 to 55.

In operation 51, non-repeating second intra prediction modes among second intra prediction modes corresponding to first intra prediction modes for P first prediction blocks corresponding to encoded blocks at positions neighbouring the current block are filled into the TMRL candidate list one by one in a certain order. Exemplarily, the P first prediction blocks are prediction blocks at eleven neighbouring positions around the current block in FIG. 19. Specifically, the following processes are performed for an i-th first prediction block of these eleven first prediction blocks.

When the i-th first prediction block is an intra prediction block and uses a TIMD or TMRL mode, an index of intra prediction mode corresponding to the i-th first prediction block is acquired.

When the i-th first prediction block is an intra prediction block, and when a prediction mode for the i-th first prediction block is a MIP or an intraTMP, an index of the PLANAR mode is used for processing.

When the i-th first prediction block is an intra prediction block, and when the prediction mode for the i-th first prediction block is a DIMD mode, an index of intra prediction mode with an angular accuracy of 65 derived by the DIMD is matched to an index of intra prediction mode with an angular accuracy of 129.

When the i-th first prediction block is an intra prediction block, and when the prediction mode for the i-th first prediction block is an SGPM mode, an index of angular prediction mode corresponding to SGPM partitioning angle is matched to an index of intra prediction mode with an angular accuracy of 129.

When the i-th first prediction block is an intra prediction block, and when the prediction mode for the i-th first prediction block is a traditional intra prediction mode, an index of a first intra prediction mode for the i-th first prediction block is matched to an index of an intra prediction mode with an angular accuracy of 129.

When the i-th first prediction block is an inter prediction block, and when the prediction mode for the i-th first prediction block is a GPM mode, an index of intra prediction mode corresponding to GPM partitioning is matched to an index of intra prediction mode with an angular accuracy of 129.

When the i-th first prediction block is an inter prediction block, and when the prediction mode for the i-th first prediction block is not the GPM mode, an index of intra prediction mode in an intra prediction mode cache of the current block is matched to an index of intra prediction mode with an angular accuracy of 129.

It should be noted that indices of the intra prediction modes acquired as above may be understood as indices of the second intra prediction modes.

In operation 52, indices of one or more (for example, two) angular modes derived by using a DIMD tool for the current block are acquired and matched to indices of intra prediction mode with an angular accuracy of 129.

In operation 53, non-repeating second intra prediction modes among second intra prediction modes corresponding to first intra prediction modes for Q second prediction blocks corresponding to encoded blocks at positions not neighbouring the current block are filled into the TMRL candidate list one by one in a certain order. Exemplarily, the Q second prediction blocks are prediction blocks at twenty non-neighbouring positions around the current block in FIG. 19. Specifically, the following processes are performed for an i-th second prediction block from these twenty second prediction blocks.

When the i-th second prediction block is an intra prediction block and uses a TIMD or TMRL mode, an index of intra prediction modes corresponding to the i-th second prediction block is acquired.

When the i-th second prediction block is an intra prediction block, and when a prediction mode for the i-th second prediction block is a MIP or an intraTMP, an index of the PLANAR mode is used for processing.

When the i-th second prediction block is an intra prediction block, and when the prediction mode for the i-th second prediction block is a DIMD mode, an index of intra prediction mode with an angular accuracy of 65 derived by the DIMD is matched to an index of intra prediction mode with an angular accuracy of 129.

When the i-th second prediction block is an intra prediction block, and when the prediction mode for the i-th second prediction block is an SGPM mode, an index of angular prediction mode corresponding to SGPM partitioning angle is matched to an index of intra prediction mode with an angular accuracy of 129.

When the i-th second prediction block is an intra prediction block, and when the prediction mode for the i-th second prediction block is a traditional intra prediction mode, an index of a first intra prediction mode for the i-th second prediction block is matched to an index of an intra prediction mode with an angular accuracy of 129.

When the i-th second prediction block is an inter prediction block, and when the prediction mode for the i-th second prediction block is a GPM mode, an index of intra prediction mode corresponding to GPM partitioning is matched to an index of intra prediction mode with an angular accuracy of 129.

When the i-th second prediction block is an inter prediction block, and when the prediction mode for the i-th second prediction block is not the GPM mode, an index of intra prediction mode in an intra prediction mode cache of the current block is matched to an index of intra prediction mode with an angular accuracy of 129.

In operation 54, existing angular prediction modes in an intra prediction candidate list are expanded through similar angles, to acquire at least one expanded angular prediction mode.

In operation 55, indices of modes with an angular accuracy of 65 in a default mode list are used to match to indices of intra prediction modes with an angular accuracy of 129.

It should be noted that in the above operations 51-55, when the number of filled modes reaches the required to-be-filled number, filling should be stopped.

Third manner: the TMRL candidate list is constructed by the following operations 61 to 65.

In operation 61, non-repeating second intra prediction modes among second intra prediction modes corresponding to first intra prediction modes for P first prediction blocks corresponding to encoded blocks at positions neighbouring the current block are filled into the TMRL candidate list one by one in a certain order. Exemplarily, the P first prediction blocks are prediction blocks at five neighbouring positions around the current block in FIG. 20. Specifically, the following processes are performed for an i-th first prediction block from these five first prediction blocks.

When the i-th first prediction block is an intra prediction block and uses a TIMD or TMRL mode, an index of intra prediction mode corresponding to the i-th first prediction block is acquired.

When the i-th first prediction block is an intra prediction block, and when a prediction mode for the i-th first prediction block is a MIP or an intraTMP, an index of the PLANAR mode is used for processing.

When the i-th first prediction block is an intra prediction block, and when the prediction mode for the i-th first prediction block is a DIMD mode, an index of intra prediction mode with an angular accuracy of 65 derived by the DIMD is matched to an index of intra prediction mode with an angular accuracy of 129.

When the i-th first prediction block is an intra prediction block, and when the prediction mode for the i-th first prediction block is an SGPM mode, an index of angular prediction mode corresponding to SGPM partitioning angle is matched to an index of intra prediction mode with an angular accuracy of 129.

When the i-th first prediction block is an intra prediction block, and when the prediction mode for the i-th first prediction block is a traditional intra prediction mode, an index of a first intra prediction mode for the i-th first prediction block is matched to an index of an intra prediction mode with an angular accuracy of 129.

When the i-th first prediction block is an inter prediction block, and when the prediction mode for the i-th first prediction block is a GPM mode, an index of intra prediction modes corresponding to GPM partitioning is matched to an index of intra prediction mode with an angular accuracy of 129.

When the i-th first prediction block is an inter prediction block, and when the prediction mode for the i-th first prediction block is not the GPM mode, an index of intra prediction mode in an intra prediction mode cache of the current block is matched to an index of intra prediction mode with an angular accuracy of 129.

It should be noted that indices of the intra prediction modes acquired as above may be understood as indices of the second intra prediction modes.

In operation 62, indices of one or more (for example, two) angular modes derived by using a DIMD tool for the current block are acquired and matched to indices of intra prediction mode with an angular accuracy of 129.

In operation 63, non-repeating second intra prediction modes among second intra prediction modes corresponding to first intra prediction modes for Q second prediction blocks corresponding to encoded blocks at positions not neighbouring the current block are filled into the TMRL candidate list one by one in a certain order. Exemplarily, the Q second prediction blocks are prediction blocks at eighteen non-neighbouring positions around the current block in FIG. 20. Specifically, the following processes are performed for an i-th second prediction block from these eighteen second prediction blocks.

When the i-th second prediction block is an intra prediction block and uses a TIMD or TMRL mode, an index of intra prediction mode corresponding to the i-th second prediction block is acquired.

When the i-th second prediction block is an intra prediction block, and when a prediction mode for the i-th second prediction block is a MIP or an intraTMP, an index of the PLANAR mode is used for processing.

When the i-th second prediction block is an intra prediction block, and when the prediction mode for the i-th second prediction block is a DIMD mode, an index of intra prediction mode with an angular accuracy of 65 derived by the DIMD is matched to an index of intra prediction mode with an angular accuracy of 129.

When the i-th second prediction block is an intra prediction block, and when the prediction mode for the i-th second prediction block is an SGPM mode, an index of angular prediction mode corresponding to SGPM partitioning angle is matched to an index of intra prediction mode with an angular accuracy of 129.

When the i-th second prediction block is an intra prediction block, and when the prediction mode for the i-th second prediction block is a traditional intra prediction mode, an index of a first intra prediction mode for the i-th first prediction block is matched to an index of an intra prediction mode with an angular accuracy of 129.

When the i-th second prediction block is an inter prediction block, and when the prediction mode for the i-th second prediction block is a GPM mode, an index of intra prediction mode corresponding to GPM partitioning is matched to an index of intra prediction mode with an angular accuracy of 129.

When the i-th second prediction block is an inter prediction block, and when the prediction mode for the i-th second prediction block is not the GPM mode, an index of intra prediction mode in an intra prediction mode cache of the current block is matched to an index of intra prediction mode with an angular accuracy of 129.

In operation 64, existing angular prediction modes in an intra prediction candidate list are expanded through similar angles, to acquire at least one expanded angular prediction mode.

In operation 65, indices of modes with an angular accuracy of 65 in a default mode list are used to match to indices of intra prediction modes with an angular accuracy of 129.

It should be noted that in the above operations 61-65, when the number of filled modes reaches the required to-be-filled number, filling should be stopped.

In some embodiments, the total number of modes acquired at neighbouring and non-neighbouring positions and modes derived by the DIMD may be limited to not exceed a preset value.

After acquiring the intra prediction mode candidate list based on the above method, the encoding end performs the following operation S203.

In operation S203, the prediction for the current block is performed based on the intra prediction mode candidate list, to acquire a prediction value of the current block.

Specific manners of performing the prediction for the current block based on the intra prediction mode candidate list, to acquire the prediction value of the current block are not limited in the embodiments of the disclosure.

In some embodiments, an intra prediction mode is selected from the intra prediction mode candidate list constructed as above, and then the prediction for the current block is performed by using this intra prediction mode, to acquire the prediction value for the current block. Furthermore, an index of the selected intra prediction mode is signalled into the bitstream.

In some embodiments, the encoding end performs prediction for the template of the current block by using each of candidate prediction modes in an intra prediction mode list, to acquire a respective one of prediction values of the template corresponding to each of the candidate prediction modes, and then determines a respective one of prediction costs corresponding to each of the candidate prediction modes according to the prediction values of the template and reconstruction values of the template. Then, the encoding end determines a candidate prediction mode with a minimum prediction cost as the intra prediction mode for the current block, and performs the prediction for the current block by using this intra prediction mode, to acquire the prediction value of the current block.

In some embodiments, the above operation S203 includes the following operations S203-A and S203-B.

In operation S203-A, T candidate prediction modes in the intra prediction mode candidate list are sorted, to acquire a sorted intra prediction mode candidate list, here T is a positive integer greater than 1.

In operation S203-B, the current block is predicted based on the sorted intra prediction mode candidate list, to acquire the prediction value for the current block.

In an example, the above T candidate prediction modes may be part of candidate prediction modes in the intra prediction mode list.

In another example, the above T candidate prediction modes may be all of candidate prediction modes in the intra prediction mode list.

That is, in the embodiment of the disclosure, part or all of the candidate prediction modes in the constructed intra prediction mode candidate list are sorted, to acquire the sorted intra prediction mode candidate list.

Specific manners of sorting the T candidate prediction modes in the intra prediction mode candidate list, to acquire the sorted intra prediction mode candidate list are not limited in the embodiments of the disclosure.

In a possible implementation, the T candidate prediction modes in the intra prediction mode candidate list are sorted based on a preset sorting rule and order, to acquire the sorted intra prediction mode candidate list.

In another possible implementation, sorting is performed based on prediction costs. At this time, the above operation S203-A includes the following operations S203-A1 and S203-A2.

In operation S203-A1, for a t-th candidate prediction mode of the T candidate prediction modes, the t-th candidate prediction mode is used to predict the template of the current block to acquire a second prediction cost, here t is a positive integer less than or equal to T.

In operation S203-A2, the T candidate prediction modes are sorted based on the second prediction costs, to acquire the sorted intra prediction mode candidate list.

In this implementation, for the t-th candidate prediction mode of the T candidate prediction modes, the t-th candidate prediction mode is used to predict the template of the current block, to acquire a prediction value of the template in the t-th candidate prediction mode. Then, a second prediction cost corresponding to the t-th candidate prediction mode is determined according to the reconstructed value of the template and the prediction value of the template in the t-th candidate prediction mode, and the second prediction cost may be an approximate cost such as SAD or STAD, etc. In this way, the second prediction costs corresponding to each of the T candidate prediction modes may be determined, and then the T candidate prediction modes are sorted based on the second prediction costs, to acquire the sorted intra prediction mode candidate list. For example, the T candidate prediction modes are sorted in an ascending order of the second prediction costs, to acquire the sorted intra prediction mode candidate list.

In some embodiments, when determining the prediction value of the template of the current block, reference pixel rows used by template of the current block are at least one row and/or at least one column of reconstructed pixels neighbouring the template of the current block.

Exemplarily, as shown in FIG. 22, the template of the current block include an upper template and/or a left template, the upper template includes K pixel rows, and the left template includes K pixel columns, here K is a positive integer. The reference pixel rows of the template of the current block include upper reference pixel row(s) and/or left reference pixel column(s). In an example, the upper reference pixel rows are one pixel row, such as a (K+1)-th reconstructed pixel row. In another example, the left reference pixel columns are one pixel column, such as a (K+1)-th reconstructed pixel column.

In some embodiments, the row number of the upper reference pixel rows may be different from the column number of the left reference pixel columns. In some embodiments, the row number of the upper reference pixel rows and/or the column number of the left reference pixel columns may be determined according to different sizes of the current block.

In some embodiments, the upper template of the current block includes one or two pixel rows, and/or the left template of the current block includes one or two pixel columns.

For example, in order to reduce complexity of calculating the above second prediction costs, the upper template includes one pixel row, and/or the left template includes one pixel column.

For another example, the above second prediction costs may be calculated by using the upper template with two rows and/or the left template with two columns, to reduce complexity of calculation.

In some embodiments, complexity of prediction on the template may be simplified, for example, without using the PDPC, and by reducing the number of taps of an interpolation filter.

In some embodiments, the number of pixel rows included in the upper template may be different from the number of pixel columns included in the left template. In some embodiments, the number of pixel rows included in the upper template and the number of pixel columns included in the left template may be determined according to different sizes of the current block.

In some embodiments, the template of the current block may include only the upper template, without including the left template. Alternatively, the template of the current block may include only the left template, without including the upper template.

According to the method for video encoding according to the embodiment of the disclosure, when constructing an intra prediction mode candidate list, a first angular accuracy corresponding to the intra prediction mode candidate list is determined first, here the first angular accuracy indicates a search range of angular prediction modes in the intra prediction mode candidate list. Then, the intra prediction mode candidate list is constructed based on the first angular accuracy. For example, the intra prediction mode candidate list is a TIMD list. Assuming that the first angular accuracy corresponding to the TIMD is 129, instead of first constructing an intra prediction mode candidate list with 65-angular-accuracy, and then matching the intra prediction mode candidate list with the 65-angular-accuracy back to 129-angular-accuracy; the embodiment of the disclosure directly constructs an intra prediction mode candidate list 129-angular-accuracy, thereby avoiding angular accuracy loss and improving accuracy of constructing the intra prediction mode candidate list. In this way, when prediction is performed based on the accurately constructed intra prediction mode candidate list, accuracy of prediction for the current block can be improved, thereby improving effects of video encoding and decoding.

It should be understood that FIG. 15 to FIG. 19 are only examples of the disclosure and should not be understood as limitations to the disclosure.

Preferred implementations of the disclosure has been described in detail as above with reference to the drawings; however, the disclosure is not limited to specific details in the above implementations, many simple modifications may be made to the technical solutions of the disclosure within the scope of technical concepts of the disclosure, and all of these simple modifications fall within the scope of protection of the disclosure. For example, various specific technical features described in the above specific implementations may be combined in any suitable manner without conflict. In order to avoid unnecessary repetition, various possible combinations will not be further explained in the disclosure. For another example, various different implementations of the disclosure may also be arbitrarily combined there-between as long as they do not violate ideas of the disclosure, and they should also be considered as contents disclosed in the disclosure.

It should also be understood that in various method embodiments of the disclosure, sizes of serial numbers of the above processes do not mean a sequence of execution, and the sequence of execution of each process should be determined by its function and internal logic, and should not constitute any limitation on implementation processes of the embodiments of the disclosure. Furthermore, in the embodiments of the disclosure, term “and/or” is only an association relationship describing associated objects, and represents that three relationships may exist. For example, A and/or B may represent three cases, i.e., existence of A alone, existence of both A and B, and existence of B alone. Furthermore, character “/” in the disclosure usually represents that anterior and posterior associated objects form an “or” relationship.

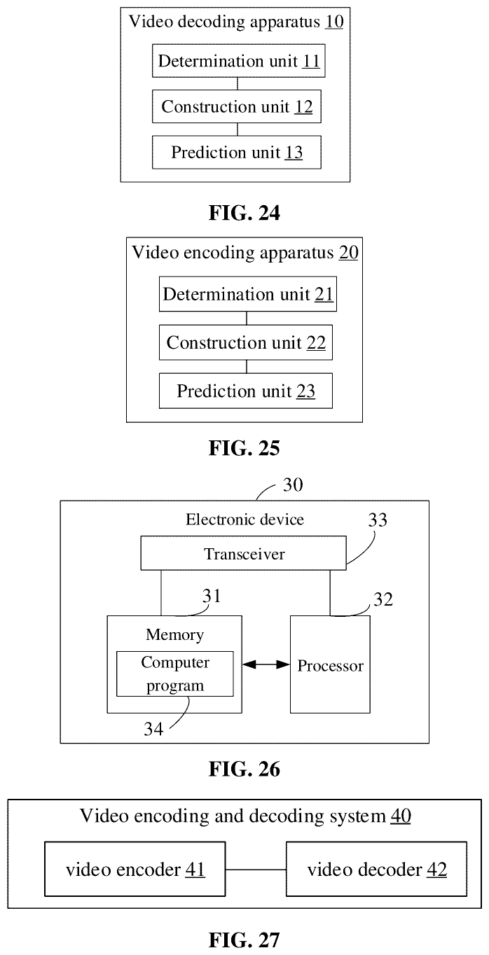

The method embodiments of the disclosure have been described in detail as above with reference to FIG. 16 to FIG. 23, and apparatus embodiments of the disclosure will be described in detail below with reference to FIG. 24 to FIG. 26.

FIG. 24 is a schematic block diagram of an apparatus for video decoding according to an embodiment of the disclosure. The apparatus 10 for video decoding is applied to the above video decoders.

As shown in FIG. 24, the apparatus 10 for video decoding includes a determination unit 11, a construction unit 12, and a prediction unit 13.

The determination unit 11 is configured to determine a first angular accuracy corresponding to an intra prediction mode candidate list for a current block, here the first angular accuracy indicates a search range of angular prediction modes in the intra prediction mode candidate list.

The construction unit 12 is configured to construct the intra prediction mode candidate list based on the first angular accuracy.

The prediction unit 13 is configured to predict the current block based on the intra prediction mode candidate list, to acquire a prediction value for the current block.

In some embodiments, the determination unit 11 is specifically configured to: determine a prediction manner used in prediction for the current block; if the prediction manner is a template matching-based prediction manner, determine an angular accuracy corresponding to the prediction manner; and determine the first angular accuracy based on the angular accuracy corresponding to the prediction manner.

In some embodiments, the determination unit 11 is specifically configured to determine the angular accuracy corresponding to the prediction manner as the first angular accuracy.

In some embodiments, the prediction manner includes at least one of a TIMD, a MPM, a TMRL, an SGPM, or a DIMD.

In some embodiments, the construction unit 12 is specifically configured to: acquire first intra prediction modes for N prediction blocks around the current block, here N is a positive integer; and construct the intra prediction mode candidate list based on the first intra prediction modes for the N prediction blocks and the first angular accuracy.

In some embodiments, the N prediction blocks include P first prediction blocks and/or Q second prediction blocks, the first prediction blocks are prediction blocks corresponding to decoded blocks neighbouring the current block, the second prediction blocks are prediction blocks corresponding to decoded blocks not neighbouring the current block, P and Q are positive integers less than or equal to N respectively, and a sum of P and Q is equal to N.

In some embodiments, if the N prediction blocks include the P first prediction blocks, the construction unit 12 is specifically configured to: determine a first access order of the P first prediction blocks; and acquire first intra prediction modes for the P first prediction blocks according to the first access order.

In some embodiments, the construction unit 12 is specifically configured to determine the first access order based on a size of the current block and sizes of P decoded blocks, and/or based on a shape of the current block and shapes of the P decoded blocks.

In some embodiments, if the N prediction blocks include the Q second prediction blocks, the construction unit 12 is specifically configured to: determine a second access order of the Q second prediction blocks; and acquire first intra prediction modes for the Q second prediction blocks according to the second access order.

In some embodiments, the construction unit 12 is specifically configured to determine the second access order based on a size of the current block and sizes of Q decoded blocks, and/or based on a shape of the current block and shapes of the Q decoded blocks.

In some embodiments, the construction unit 12 is specifically configured to: for an i-th prediction block of the N prediction blocks, determine a prediction manner used in prediction for the i-th prediction block, here i is a positive integer less than or equal to N; and determine a first intra prediction mode for the i-th prediction block based on the prediction manner.

In some embodiments, the construction unit 12 is specifically configured to: if the prediction manner is any one of a TIMD, a DIMD, a TMRL and a traditional intra prediction mode, determine an intra prediction mode derived by the prediction manner as the first intra prediction mode for the i-th prediction block; if the prediction manner is a MIP or an intra TMP, derive a first angular prediction mode by using a DIMD manner, and determine the first angular prediction mode as the first intra prediction mode for the i-th prediction block; or, determine a planar (PLANAR) mode as the first intra prediction mode for the i-th prediction block; and if the prediction manner is a GPM or an SGPM, determine an angular prediction mode corresponding to a partitioning angle of the GPM or the SGPM as the first intra prediction mode for the i-th prediction block.

In some embodiments, the construction unit 12 is further configured to: if the i-th prediction block is an inter prediction block and a prediction mode used in prediction for the i-th prediction block is not a GPM mode, determine an intra prediction mode in an intra prediction mode cache of the current block as the first intra prediction mode for the i-th prediction block.

In some embodiments, the construction unit 12 is specifically configured to: determine K first intra prediction modes based on the first intra prediction modes for the N prediction blocks, here K is a positive integer less than or equal to N; determine second intra prediction modes corresponding to the K first intra prediction modes, based on the first angular accuracy; and construct the intra prediction mode candidate list based on K second intra prediction modes.

In some embodiments, the construction unit 12 is specifically configured to: sort part or all of the first intra prediction modes for the N prediction blocks, to acquire sorted first intra prediction modes; and determine the K first intra prediction modes based on the sorted first intra prediction modes.

In some embodiments, if the N prediction blocks include the P first prediction blocks, the construction unit 12 is specifically configured to sort first intra prediction modes for the P first prediction blocks of the N prediction blocks, to acquire the sorted first intra prediction modes.

In some embodiments, if the N prediction blocks include the Q second prediction blocks, the construction unit 12 is specifically configured to sort first intra prediction modes for the Q second prediction blocks of the N prediction blocks, to acquire the sorted first intra prediction modes.

In some embodiments, the construction unit 12 is specifically configured to sort the first intra prediction modes for the N prediction blocks, to acquire the sorted first intra prediction modes.

In some embodiments, the construction unit 12 is specifically configured to: select R first intra prediction modes from the first intra prediction modes for the N prediction blocks, here R is a positive integer less than N; and sort the R first intra prediction modes, to acquire the sorted first intra prediction modes.

In some embodiments, the construction unit 12 is specifically configured to: determine first intra prediction modes corresponding to a DIMD; and determine the K first intra prediction modes based on the first intra prediction modes corresponding to the DIMD and the first intra prediction modes for the N prediction blocks.

In some embodiments, the construction unit 12 is specifically configured to: select S first intra prediction modes from the first intra prediction modes corresponding to the DIMD and the first intra prediction modes for the N prediction blocks, here S is a positive integer; sort the S first intra prediction modes, to acquire sorted S first intra prediction modes; and determine the K first intra prediction modes from the sorted S first intra prediction modes.

In some embodiments, the construction unit 12 is specifically configured to: determine respective first prediction costs when performing the prediction for template of the current block by using each of the first intra prediction modes; and sort the first intra prediction modes based on the first prediction costs.

In some embodiments, the construction unit 12 is specifically configured to: for an i-th first intra prediction mode of the K first intra prediction modes, if an angular accuracy corresponding to the i-th first intra prediction mode is different from the first angular accuracy, determine a second intra prediction mode corresponding to the i-th first intra prediction mode at the first angular accuracy, here i is a positive integer less than or equal to N.

In some embodiments, the construction unit 12 is specifically configured to: acquire M intra prediction modes from existing intra prediction modes in a current intra prediction mode candidate list, here M is a positive integer; for a j-th intra prediction mode of the M intra prediction modes, determine, based on the first angular accuracy, intra prediction modes similar to the j-th intra prediction mode, here j is a positive integer less than or equal to M; and add the similar intra prediction modes to the intra prediction mode candidate list.

In some embodiments, the construction unit 12 is specifically configured to: if a length of the current intra prediction mode candidate list is less than a preset length, acquire the M intra prediction modes from the existing intra prediction modes in the current intra prediction mode candidate list.

In some embodiments, the intra prediction modes similar to the j-th intra prediction mode include: a first similar prediction mode with an index less than a first index of the j-th intra prediction mode, and/or a second similar prediction mode with an index greater than the first index.

In some embodiments, if preset modes similar to the j-th intra prediction mode include the first similar prediction mode, the construction unit 12 is specifically configured to: if the j-th intra prediction mode is not a first angular prediction mode among prediction modes corresponding to the first angular accuracy, determine a prediction mode among the prediction modes corresponding to the first angular accuracy with an index less than the first index by a first value, as the first similar prediction mode.

In some embodiments, if the intra prediction modes similar to the j-th intra prediction mode include the first similar prediction mode, the construction unit 12 is specifically configured to: if the j-th intra prediction mode is the first angular prediction mode among the prediction modes corresponding to the first angular accuracy, determine a prediction mode (among the prediction modes corresponding to the first angular accuracy) with an index less than an index of a prediction mode in an opposite direction of the j-th intra prediction mode by the first value, as the first similar prediction mode.

In some embodiments, if the preset modes similar to the j-th intra prediction mode include the second similar prediction mode, and if the j-th intra prediction mode is not a last angular prediction mode among the prediction modes corresponding to the first angular accuracy, the construction unit 12 is specifically configured to determine a prediction mode (among the prediction modes corresponding to the first angular accuracy) with an index greater than the first index by the first value, as the second similar prediction mode.

In some embodiments, if the intra prediction modes similar to the j-th intra prediction mode include the second similar prediction mode, the construction unit 12 is specifically configured to: if the j-th intra prediction mode is a last angular prediction mode among the prediction modes corresponding to the first angular accuracy, determine a prediction mode (among the prediction modes corresponding to the first angular accuracy) with an index greater than an index of a prediction mode in an opposite direction of the j-th intra prediction mode by the first value, as the second similar prediction mode.

In some embodiments, the first value is a sum of a first preset value and 1.

In some embodiments, the construction unit 12 is specifically configured to: determine a second numerical value and/or a third numerical value based on the first angular accuracy; and determine the first similar prediction mode and/or the second similar prediction mode based on the second numerical value and/or the third numerical value.

In some embodiments, the construction unit 12 is specifically configured to determine the first similar prediction mode based on the second numerical value and the third numerical value.

In some embodiments, the construction unit 12 is specifically configured to: add the first index of the j-th intra prediction mode to the second numerical value, and then subtract a first preset value to acquire a fourth numerical value; calculate modulo of the fourth numerical value with respect to the third numerical value, and then add a second preset value to the modulo result, to acquire an index corresponding to the first similar prediction mode; and determine the first similar prediction mode from prediction modes corresponding to the first angular accuracy, based on the index corresponding to the first similar prediction mode.

In some embodiments, the construction unit 12 is specifically configured to determine the second similar prediction mode based on the third numerical value.

In some embodiments, the construction unit 12 is specifically configured to: subtract a third preset value from an index of the j-th intra prediction mode, and then add a first preset value to acquire a fifth numerical value; calculate a modulo of the fifth numerical value with respect to the third numerical value, and then add a second preset value to the modulo result, to acquire an index corresponding to the second similar prediction mode; and determine the second similar prediction mode from prediction modes corresponding to the first angular accuracy, based on the index corresponding to the second similar prediction mode.

In some embodiments, the construction unit 12 is specifically configured to: determine a value acquired by subtracting 4 from the first angular accuracy, as the second numerical value; and determine a value acquired by subtracting 1 from the first angular accuracy, as the third numerical value.

In some embodiments, the prediction unit 13 is specifically configured to: sort T candidate prediction modes in the intra prediction mode candidate list, to acquire a sorted intra prediction mode candidate list, here T is a positive integer greater than 1; and perform the prediction for the current block based on the sorted intra prediction mode candidate list, to acquire the prediction value of the current block.

In some embodiments, the prediction unit 13 is specifically configured to: for a t-th candidate prediction mode of the T candidate prediction modes, use the t-th candidate prediction mode to predict the template of the current block to acquire a second prediction cost, here t is a positive integer less than or equal to T; and sort the T candidate prediction modes based on the second prediction costs, to acquire the sorted intra prediction mode candidate list.

In some embodiments, the prediction unit 13 is specifically configured to sort the T candidate prediction modes in an ascending order of the second prediction costs, to acquire the sorted intra prediction mode candidate list.

In some embodiments, the prediction unit 13 is specifically configured to: determine at least one row and/or at least one column of reconstructed pixels neighbouring template of the current block, as reference pixel row(s) of the template of the current block; acquire a prediction value of the template corresponding to the t-th candidate prediction mode, based on the t-th candidate prediction mode and the reference pixel row(s) of the template of the current block; and determine the second prediction cost when performing prediction for the template of the current block by using the t-th candidate prediction mode, based on the prediction value of the template corresponding to the t-th candidate prediction mode and reconstruction value of the template.

In some embodiments, the prediction unit 13 is specifically configured to: determine a second angular accuracy corresponding to a default angular prediction mode; if the second angular accuracy is different from the first angular accuracy, determine a second intra prediction mode corresponding to the default angular prediction mode at the first angular accuracy; and add the second intra prediction mode corresponding to the default angular prediction mode to the intra prediction mode candidate list.

In some embodiments, the template of the current block include an upper template and/or a left template of the current block.

In some embodiments, the upper template of the current block includes one or two pixel rows, and/or the left template of the current block includes one or two pixel columns.

In some embodiments, at least one decoded block of the decoded blocks neighbouring the current block and/or the decoded blocks not neighbouring the current block, and the current block correspond to a same CTU.

It should be understood that the apparatus embodiment and the method embodiment may correspond to each other, and similar descriptions may refer to the method embodiment, which will not be elaborated here to avoid repetition. Specifically, the apparatus 10 shown in FIG. 24 may perform the decoding method at the decoding end of the embodiment of the disclosure, and the foregoing and other operations and/or functions of each unit in the apparatus 10 are respectively intended to implement corresponding flows in each method such as the above decoding method at the decoding end or the like, which will not be elaborated here for the sake of brevity.

FIG. 25 is a schematic block diagram of an apparatus for video encoding according to an embodiment of the disclosure. The apparatus for video encoding is applied to the above encoders.

As shown in FIG. 25, the apparatus 20 for video encoding includes a determination unit 21, a construction unit 22, and a prediction unit 23.

The determination unit 21 is configured to determine a first angular accuracy corresponding to an intra prediction mode candidate list for a current block, here the first angular accuracy indicates a search range of angular prediction modes in the intra prediction mode candidate list.

The construction unit 22 is configured to construct the intra prediction mode candidate list based on the first angular accuracy.

The prediction unit 23 is configured to predict the current block based on the intra prediction mode candidate list, to acquire a prediction value for the current block.

In some embodiments, the determination unit 21 is specifically configured to: determine a prediction manner used in prediction for the current block; if the prediction manner is a template matching-based prediction manner, determine an angular accuracy corresponding to the prediction manner; and determine the first angular accuracy based on the angular accuracy corresponding to the prediction manner.

In some embodiments, the determination unit 21 is specifically configured to determine the angular accuracy corresponding to the prediction manner as the first angular accuracy.

In some embodiments, the prediction manner includes at least one of a TIMD, a MPM, a TMRL, an SGPM, or a DIMD.

In some embodiments, the construction unit 22 is specifically configured to: acquire first intra prediction modes for N prediction blocks around the current block, here N is a positive integer; and construct the intra prediction mode candidate list based on the first intra prediction modes for the N prediction blocks and the first angular accuracy.

In some embodiments, the N prediction blocks include P first prediction blocks and/or Q second prediction blocks, the first prediction blocks are prediction blocks corresponding to encoded blocks neighbouring the current block, the second prediction blocks are prediction blocks corresponding to encoded blocks not neighbouring the current block, P and Q are positive integers less than or equal to N respectively, and a sum of P and Q is equal to N.

In some embodiments, if the N prediction blocks include the P first prediction blocks, the construction unit 22 is specifically configured to: determine a first access order of the P first prediction blocks; and acquire first intra prediction modes for the P first prediction blocks according to the first access order.

In some embodiments, the construction unit 22 is specifically configured to determine the first access order based on a size of the current block and sizes of P encoded blocks, and/or based on a shape of the current block and shapes of the P encoded blocks.

In some embodiments, if the N prediction blocks include the Q second prediction blocks, the construction unit 22 is specifically configured to: determine a second access order of the Q second prediction blocks; and acquire first intra prediction modes for the Q second prediction blocks according to the second access order.

In some embodiments, the construction unit 22 is specifically configured to determine the second access order based on a size of the current block and sizes of Q encoded blocks, and/or based on a shape of the current block and shapes of the Q encoded blocks.

In some embodiments, the construction unit 22 is specifically configured to: for an i-th prediction block of the N prediction blocks, determine a prediction manner used in prediction for the i-th prediction block, here i is a positive integer less than or equal to N; and determine a first intra prediction mode for the i-th prediction block based on the prediction manner.

In some embodiments, the construction unit 22 is specifically configured to: if the prediction manner is any one of a TIMD, a DIMD, a TMRL and a traditional intra prediction mode, determine an intra prediction mode derived by the prediction manner as the first intra prediction mode for the i-th prediction block; if the prediction manner is a MIP or an intra TMP, derive a first angular prediction mode by using a DIMD manner, and determine the first angular prediction mode as the first intra prediction mode for the i-th prediction block; or, determine a planar (PLANAR) mode as the first intra prediction mode for the i-th prediction block; and if the prediction manner is a GPM or an SGPM, determine an angular prediction mode corresponding to a partitioning angle of the GPM or the SGPM as the first intra prediction mode for the i-th prediction block.

In some embodiments, the construction unit 22 is further configured to: if the i-th prediction block is an inter prediction block and a prediction mode used in prediction for the i-th prediction block is not a GPM mode, determine an intra prediction mode in an intra prediction mode cache of the current block as the first intra prediction mode for the i-th prediction block.

In some embodiments, the construction unit 22 is specifically configured to: determine K first intra prediction modes based on the first intra prediction modes for the N prediction blocks, here K is a positive integer less than or equal to N; determine second intra prediction modes corresponding to the K first intra prediction modes, based on the first angular accuracy; and construct the intra prediction mode candidate list based on K second intra prediction modes.

In some embodiments, the construction unit 22 is specifically configured to: sort part or all of the first intra prediction modes for the N prediction blocks, to acquire sorted first intra prediction modes; and determine the K first intra prediction modes based on the sorted first intra prediction modes.

In some embodiments, if the N prediction blocks include the P first prediction blocks, the construction unit 22 is specifically configured to sort first intra prediction modes for the P first prediction blocks of the N prediction blocks, to acquire the sorted first intra prediction modes.

In some embodiments, if the N prediction blocks include the Q second prediction blocks, the construction unit 22 is specifically configured to sort first intra prediction modes for the Q second prediction blocks of the N prediction blocks, to acquire the sorted first intra prediction modes.

In some embodiments, the construction unit 22 is specifically configured to sort the first intra prediction modes for the N prediction blocks, to acquire the sorted first intra prediction modes.

In some embodiments, the construction unit 22 is specifically configured to: select R first intra prediction modes from the first intra prediction modes for the N prediction blocks, here R is a positive integer less than N; and sort the R first intra prediction modes, to acquire the sorted first intra prediction modes.

In some embodiments, the construction unit 22 is specifically configured to: determine first intra prediction modes corresponding to a DIMD; and determine the K first intra prediction modes based on the first intra prediction modes corresponding to the DIMD and the first intra prediction modes for the N prediction blocks.

In some embodiments, the construction unit 22 is specifically configured to: select S first intra prediction modes from the first intra prediction modes corresponding to the DIMD and the first intra prediction modes for the N prediction blocks, here S is a positive integer; sort the S first intra prediction modes, to acquire sorted S first intra prediction modes; and determine the K first intra prediction modes from the sorted S first intra prediction modes.

In some embodiments, the construction unit 22 is specifically configured to: determine respective first prediction costs when performing the prediction for template of the current block by using each of the first intra prediction modes; and sort the first intra prediction modes based on the first prediction costs.

In some embodiments, the construction unit 22 is specifically configured to: for an i-th first intra prediction mode of the K first intra prediction modes, if an angular accuracy corresponding to the i-th first intra prediction mode is different from the first angular accuracy, determine a second intra prediction mode corresponding to the i-th first intra prediction mode at the first angular accuracy, here i is a positive integer less than or equal to N.

In some embodiments, the construction unit 22 is specifically configured to: acquire M intra prediction modes from existing intra prediction modes in a current intra prediction mode candidate list, here M is a positive integer; for a j-th intra prediction mode of the M intra prediction modes, determine, based on the first angular accuracy, intra prediction modes similar to the j-th intra prediction mode, here j is a positive integer less than or equal to M; and add the similar intra prediction modes to the intra prediction mode candidate list.

In some embodiments, the construction unit 22 is specifically configured to: if a length of the current intra prediction mode candidate list is less than a preset length, acquire the M intra prediction modes from the existing intra prediction modes in the current intra prediction mode candidate list.

In some embodiments, the intra prediction modes similar to the j-th intra prediction mode include: a first similar prediction mode with an index less than a first index of the j-th intra prediction mode, and/or a second similar prediction mode with an index greater than the first index.

In some embodiments, if preset modes similar to the j-th intra prediction mode include the first similar prediction mode, the construction unit 22 is specifically configured to: if the j-th intra prediction mode is not a first angular prediction mode among prediction modes corresponding to the first angular accuracy, determine a prediction mode among the prediction modes corresponding to the first angular accuracy with an index less than the first index by a first value, as the first similar prediction mode.

In some embodiments, if the intra prediction modes similar to the j-th intra prediction mode include the first similar prediction mode, the construction unit 22 is specifically configured to: if the j-th intra prediction mode is the first angular prediction mode among the prediction modes corresponding to the first angular accuracy, determine a prediction mode (among the prediction modes corresponding to the first angular accuracy) with an index less than an index of a prediction mode in an opposite direction of the j-th intra prediction mode by the first value, as the first similar prediction mode.

In some embodiments, if the preset modes similar to the j-th intra prediction mode include the second similar prediction mode, and if the j-th intra prediction mode is not a last angular prediction mode among the prediction modes corresponding to the first angular accuracy, the construction unit 22 is specifically configured to determine a prediction mode (among the prediction modes corresponding to the first angular accuracy) with an index greater than the first index by the first value, as the second similar prediction mode.

In some embodiments, if the intra prediction modes similar to the j-th intra prediction mode include the second similar prediction mode, the construction unit 22 is specifically configured to: if the j-th intra prediction mode is a last angular prediction mode among the prediction modes corresponding to the first angular accuracy, determine a prediction mode (among the prediction modes corresponding to the first angular accuracy) with an index greater than an index of a prediction mode in an opposite direction of the j-th intra prediction mode by the first value, as the second similar prediction mode.

In some embodiments, the first value is a sum of a first preset value and 1.

In some embodiments, the construction unit 22 is specifically configured to: determine a second numerical value and/or a third numerical value based on the first angular accuracy; and determine the first similar prediction mode and/or the second similar prediction mode based on the second numerical value and/or the third numerical value.

In some embodiments, the construction unit 22 is specifically configured to determine the first similar prediction mode based on the second numerical value and the third numerical value.

In some embodiments, the construction unit 22 is specifically configured to: add the first index of the j-th intra prediction mode to the second numerical value, and then subtract a first preset value to acquire a fourth numerical value; calculate modulo of the fourth numerical value with respect to the third numerical value, and then add a second preset value to the modulo result, to acquire an index corresponding to the first similar prediction mode; and determine the first similar prediction mode from prediction modes corresponding to the first angular accuracy, based on the index corresponding to the first similar prediction mode.

In some embodiments, the construction unit 22 is specifically configured to determine the second similar prediction mode based on the third numerical value.

In some embodiments, the construction unit 22 is specifically configured to: subtract a third preset value from an index of the j-th intra prediction mode, and then add a first preset value to acquire a fifth numerical value; calculate a modulo of the fifth numerical value with respect to the third numerical value, and then add a second preset value to the modulo result, to acquire an index corresponding to the second similar prediction mode; and determine the second similar prediction mode from prediction modes corresponding to the first angular accuracy, based on the index corresponding to the second similar prediction mode.

In some embodiments, the construction unit 22 is specifically configured to: determine a value acquired by subtracting 4 from the first angular accuracy, as the second numerical value; and determine a value acquired by subtracting 1 from the first angular accuracy, as the third numerical value.

In some embodiments, the prediction unit 23 is specifically configured to: sort T candidate prediction modes in the intra prediction mode candidate list, to acquire a sorted intra prediction mode candidate list, here T is a positive integer greater than 1; and perform the prediction for the current block based on the sorted intra prediction mode candidate list, to acquire the prediction value of the current block.

In some embodiments, the prediction unit 23 is specifically configured to: for a t-th candidate prediction mode of the T candidate prediction modes, use the t-th candidate prediction mode to predict the template of the current block to acquire a second prediction cost, here t is a positive integer less than or equal to T; and sort the T candidate prediction modes based on the second prediction costs, to acquire the sorted intra prediction mode candidate list.

In some embodiments, the prediction unit 23 is specifically configured to sort the T candidate prediction modes in an ascending order of the second prediction costs, to acquire the sorted intra prediction mode candidate list.

In some embodiments, the prediction unit 23 is specifically configured to: determine at least one row and/or at least one column of reconstructed pixels neighbouring template of the current block, as reference pixel row(s) of the template of the current block; acquire a prediction value of the template corresponding to the t-th candidate prediction mode, based on the t-th candidate prediction mode and the reference pixel row(s) of the template of the current block; and determine the second prediction cost when performing prediction for the template of the current block by using the t-th candidate prediction mode, based on the prediction value of the template corresponding to the t-th candidate prediction mode and reconstruction value of the template.

In some embodiments, the prediction unit 23 is specifically configured to: determine a second angular accuracy corresponding to a default angular prediction mode; if the second angular accuracy is different from the first angular accuracy, determine a second intra prediction mode corresponding to the default angular prediction mode at the first angular accuracy; and add the second intra prediction mode corresponding to the default angular prediction mode to the intra prediction mode candidate list.

In some embodiments, the template of the current block include an upper template and/or a left template of the current block.

In some embodiments, the upper template of the current block includes one or two pixel rows, and/or the left template of the current block includes one or two pixel columns.

In some embodiments, at least one encoded block of the encoded blocks neighbouring to the current block and/or the encoded blocks not neighbouring to the current block, and the current block correspond to a same CTU.

It should be understood that the apparatus embodiment and the method embodiment may correspond to each other, and similar descriptions may refer to the method embodiment, which will not be elaborated here to avoid repetition. Specifically, the apparatus 20 shown in FIG. 25 may correspond to a corresponding subject performing the encoding method at the encoding end of the embodiment of the disclosure, and the foregoing and other operations and/or functions of each unit in the apparatus 20 are respectively intended to implement corresponding flows in each method such as the encoding method at the encoding end or the like, which will not be elaborated here for the sake of brevity.

The apparatus and system of the embodiments of the disclosure have been described as above from a perspective of functional units with reference to the drawings. It should be understood that the functional units may be implemented in a form of hardware, or may be instructions in a form of software, or may be implemented by a combination of hardware and software units. Specifically, each operation of the method embodiments in the embodiments of the disclosure may be completed by an integrated logical circuit in a form of hardware in a processor and/or instructions in a form of software, and operations in the methods disclosed in combination with the embodiments of the disclosure may be directly embodied to be executed and completed by a hardware decoding processor, or may be executed and completed by a combination of hardware in the decoding processor and software units. Optionally, the software units may be located in a mature storage medium in this field such as a Random Access Memory (RAM), a flash memory, a Read-Only Memory (ROM), a Programmable ROM (PROM) or Electrically Erasable PROM (EEPROM), a register, etc. The storage medium is located in a memory, and the processor reads information in the memory, and completes the operations in the above method embodiments in combination with the hardware thereof.

FIG. 26 is a schematic block diagram of an electronic device according to an embodiment of the disclosure.

As shown in FIG. 26, the electronic device 30 may be the video encoder or the video decoder described in the embodiments of the disclosure, and the electronic device 30 may include a memory 31 and a processor 32.

The memory 31 is configured to store a computer program 34 and transmit the program code 34 to the processor 32. In other words, the processor 32 may call and run the computer program 34 from the memory 31, to implement the methods in the embodiments of the disclosure.

For example, the processor 32 may be configured to perform operations in the above method 200 according to instructions in the computer program 34.

In some embodiments of the disclosure, the processor 32 may include, but is not limited to:

a general purpose processor, a Digital Signal Processor (DSP), an Application Specific Integrated Circuit (ASIC), a Field Programmable Gate Array (FPGA) or other programmable logical devices, a discrete gate or transistor logical device, a discrete hardware component, etc.

In some embodiments of the disclosure, the memory 31 includes, but is not limited to a volatile memory and/or a non-volatile memory.

The non-volatile memory may be a ROM, a PROM, an Erasable PROM (EPROM), an EEPROM or a flash memory. The volatile memory may be a RAM, which is used as an external high-speed cache. Through an exemplary rather than limiting description, many forms of RAMs are available, such as a Static RAM (SRAM), a Dynamic RAM (DRAM), a Synchronous DRAM (SDRAM), a Double Data Rate SDRAM (DDR SDRAM), an Enhanced SDRAM (ESDRAM), a synch link DRAM (SLDRAM) and a Direct Rambus RAM (DR RAM).

In some embodiments of the disclosure, the computer program 34 may be divided into one or more units, and the one or more units are stored in the memory 31 and executed by the processor 32, to complete the methods according to the disclosure. The one or more units may be a series of computer program instruction segments capable of completing specific functions, and the instruction segments are configured to describe execution processes of the computer program 34 in the electronic device 30.

As shown in FIG. 26, the electronic device 30 may further include a transceiver 33.

The transceiver 33 may be connected to the processor 32 or the memory 31.

The processor 32 may control the transceiver 33 to communicate with other devices. Specifically, the processor 32 may control the transceiver 33 to send information or data to other devices, or to receive information or data sent by other devices. The transceiver 33 may include a transmitter and a receiver. The transceiver 33 may further include antenna, and there may be one or more the antennas in number.

It should be understood that various components in the electronic device 30 are connected through a bus system. The bus system includes a power bus, a control bus and a status signal bus, besides a data bus.

FIG. 27 is a schematic block diagram of a video encoding and decoding system according to an embodiment of the disclosure.

As shown in FIG. 27, the video encoding and decoding system 40 may include a video encoder 41 and a video decoder 42. The video encoder 41 is configured to perform the method for video encoding involved in the embodiments of the disclosure, and the video decoder 42 is configured to perform the method for video decoding involved in the embodiments of the disclosure.

The disclosure further provides a computer storage medium, the computer storage medium has stored thereon a computer program, and the computer program enables a computer to perform the methods of the above method embodiments when the computer program is executed by the computer. In other words, embodiments of the disclosure further provide a computer program product containing instructions, and the instructions enable a computer to perform the methods of the above method embodiments when the instructions are executed by the computer.

The disclosure further provides a bitstream, the bitstream is generated according to the above encoding method.

When the disclosure is implemented by using software, it may be entirely or partially implemented in a form of a computer program product. The computer program product includes one or more computer instructions. When the computer program instructions are loaded and executed on a computer, flows or functions according to the embodiments of the disclosure are entirely or partially generated. The computer may be a general purpose computer, a special purpose computer, a computer network, or other programmable devices. The computer instructions may be stored in a computer-readable storage medium, or transmitted from a computer-readable storage medium to another computer-readable storage medium. For example, the computer instructions may be transmitted from a website, computer, server or data center to another website, computer, server or data center through a wired manner (such as a coaxial cable, an optical fiber, a Digital Subscriber Line (DSL)) or a wireless manner (such as infrared, wireless, microwave, etc.). The computer-readable storage medium may be any available medium to which the computer may access, or a data storage device containing integration of one or more available media, such as a server or data center, etc. The available medium may be a magnetic medium (such as a floppy disk, a hard disk, a magnetic tape), an optical medium (such as a Digital Video Disc (DVD)), or a semiconductor medium (such as a Solid State Disk (SSD)), etc.

It may be appreciated by those of ordinary skill in the art that the units and algorithm steps of each example described in combination with the embodiments disclosed in the disclosure may be implemented by electronic hardware or a combination of computer software and the electronic hardware. Whether these functions are performed in a hardware or software manner, depends on specific applications and design constraints of the technical solutions. Professionals may implement the described functions by using different methods for each specific application; however, such implementation should not be considered as going beyond the scope of the disclosure.

In several embodiments according to the disclosure, it should be understood that the disclosed system, apparatus and method may be implemented in other manners. For example, the above apparatus embodiments are schematic only. For example, division of the units is only a logic function division, and other division manners may be adopted in an actual implementation. For example, multiple units or components may be combined or integrated into another system, or some features may be ignored or may not be performed. In addition, coupling or direct coupling or communication connection between displayed or discussed components may be indirect coupling or communication connection of the apparatus or the units implemented through some interfaces, and may be electrical, mechanical or adopt other forms.

The units described as separate components may be or may not be physically separated, and components displayed as units may be or may not be physical units, that is, they may be located at the same place, or may be distributed to multiple network units. Part or all of the units may be selected to achieve the purpose of the solutions in the embodiments according to actual requirements. For example, each functional unit in each embodiment of the disclosure may be integrated into a processing unit, or each unit may physically exist separately, or two or more than two units may be integrated into a unit.

The above descriptions are only specific implementations of the disclosure; however, the scope of protection of the disclosure is not limited thereto. Variation or replacement easily conceived by any technician familiar with this technical field within the technical scope disclosed in the disclosure, should fall within the scope of protection of the disclosure. Therefore, the scope of protection of the disclosure shall be subject to the scope of protection of the claims.

1. A method for video decoding, comprising:
determining a first angular accuracy corresponding to an intra prediction mode candidate list for a current block, wherein the first angular accuracy indicates a search range of angular prediction modes in the intra prediction mode candidate list;
constructing the intra prediction mode candidate list based on the first angular accuracy; and
predicting the current block based on the intra prediction mode candidate list, to acquire a prediction value for the current block.

2. The method of claim 1, wherein determining the first angular accuracy corresponding to the intra prediction mode candidate list for the current block comprises:
determining a prediction manner used in prediction for the current block;
if the prediction manner is a template matching-based prediction manner, determining an angular accuracy corresponding to the prediction manner; and
determining the first angular accuracy based on the angular accuracy corresponding to the prediction manner, comprising:
determining the angular accuracy corresponding to the prediction manner as the first angular accuracy.

3. The method of claim 2, wherein the prediction manner comprises at least one of a Template-based Intra Mode Derivation (TIMD), a Most Probable Mode (MPM), a Template-based Multiple Reference Line intra prediction (TMRL), a Spatial Geometric Partition Mode (SGPM), or a Decoder-side Intra Mode Derivation (DIMD).

4. The method of claim 1, wherein constructing the intra prediction mode candidate list based on the first angular accuracy comprises:
acquiring first intra prediction modes for N prediction blocks around the current block, wherein N is a positive integer; and
constructing the intra prediction mode candidate list based on the first intra prediction modes for the N prediction blocks and the first angular accuracy;
wherein the N prediction blocks comprise P first prediction blocks and/or Q second prediction blocks, the first prediction blocks are prediction blocks corresponding to decoded blocks neighbouring the current block, the second prediction blocks are prediction blocks corresponding to decoded blocks not neighbouring the current block, P and Q are positive integers less than or equal to N respectively, and a sum of P and Q is equal to N.

5. The method of claim 4, wherein
if the N prediction blocks comprise the P first prediction blocks, acquiring the first intra prediction modes for the N prediction blocks around the current block comprises: determining a first access order of the P first prediction blocks; and acquiring first intra prediction modes for the P first prediction blocks according to the first access order;
if the N prediction blocks comprise the Q second prediction blocks, acquiring the first intra prediction modes for the N prediction blocks around the current block comprises: determining a second access order of the Q second prediction blocks; and acquiring first intra prediction modes for the Q second prediction blocks according to the second access order.

6. The method of claim 4, wherein acquiring the first intra prediction modes for the N prediction blocks around the current block comprises:
for an i-th prediction block of the N prediction blocks, determining a prediction manner used in prediction for the i-th prediction block, wherein i is a positive integer less than or equal to N; and
determining a first intra prediction mode for the i-th prediction block based on the prediction manner, comprising:
if the prediction manner is any one of a Template-based Intra Mode Derivation (TIMD), a Decoder-side Intra Mode Derivation (DIMD), a Template-based Multiple Reference Line intra prediction (TMRL) and a traditional intra prediction mode, determining an intra prediction mode derived by the prediction manner as the first intra prediction mode for the i-th prediction block;
if the prediction manner is a Matrix-based Intra Prediction mode (MIP) or an intra Template Matching Prediction mode (intraTMP), deriving a first angular prediction mode by using a DIMD manner, and determining the first angular prediction mode as the first intra prediction mode for the i-th prediction block; or, determining a planar mode as the first intra prediction mode for the i-th prediction block; and
if the prediction manner is a Geometric Partition Mode (GPM) or a Spatial Geometric Partition Mode (SGPM), determining an angular prediction mode corresponding to a partitioning angle of the GPM or the SGPM as the first intra prediction mode for the i-th prediction block.

7. The method of claim 6, further comprising:
if the i-th prediction block is an inter prediction block and a prediction mode used in prediction for the i-th prediction block is not a Geometric Partition Mode (GPM), determining an intra prediction mode in an intra prediction mode cache of the current block as the first intra prediction mode for the i-th prediction block.

8. The method of claim 4, wherein constructing the intra prediction mode candidate list based on the first intra prediction modes for the N prediction blocks and the first angular accuracy comprises:
determining K first intra prediction modes based on the first intra prediction modes for the N prediction blocks, wherein K is a positive integer less than or equal to N;
determining, based on the first angular accuracy, second intra prediction modes corresponding to the K first intra prediction modes; and
constructing the intra prediction mode candidate list based on the K second intra prediction modes.

9. The method of claim 8, wherein determining the K first intra prediction modes based on the first intra prediction modes for the N prediction blocks comprises:
determining first intra prediction modes corresponding to a Decoder-side Intra Mode Derivation (DIMD); and
determining the K first intra prediction modes based on the first intra prediction modes corresponding to the DIMD and the first intra prediction modes for the N prediction blocks, comprising:
selecting S first intra prediction modes from the first intra prediction modes corresponding to the DIMD and the first intra prediction modes for the N prediction blocks, wherein S is a positive integer;
sorting the S first intra prediction modes, to acquire sorted S first intra prediction modes; and
determining the K first intra prediction modes from the sorted S first intra prediction modes.

10. The method of claim 1, wherein constructing the intra prediction mode candidate list based on the first angular accuracy comprises:
acquiring M intra prediction modes from existing intra prediction modes in a current intra prediction mode candidate list, wherein M is a positive integer;
for a j-th intra prediction mode of the M intra prediction modes, determining, based on the first angular accuracy, intra prediction modes similar to the j-th intra prediction mode, wherein j is a positive integer less than or equal to M; and
adding the similar intra prediction modes to the intra prediction mode candidate list;
wherein the intra prediction modes similar to the j-th intra prediction mode comprise at least one of: a first similar prediction mode with an index less than a first index of the j-th intra prediction mode, or a second similar prediction mode with an index greater than the first index.

11. The method of claim 10, wherein if preset modes similar to the j-th intra prediction mode comprise the first similar prediction mode, determining, based on the first angular accuracy, the intra prediction modes similar to the j-th intra prediction mode comprises:
if the j-th intra prediction mode is not a first angular prediction mode among prediction modes corresponding to the first angular accuracy, determining a prediction mode, among the prediction modes corresponding to the first angular accuracy, with an index less than the first index by a first value, as the first similar prediction mode;
wherein if the intra prediction modes similar to the j-th intra prediction mode comprise the first similar prediction mode, determining, based on the first angular accuracy, the intra prediction modes similar to the j-th intra prediction mode comprises:
if the j-th intra prediction mode is the first angular prediction mode among the prediction modes corresponding to the first angular accuracy, determining a prediction mode, among the prediction modes corresponding to the first angular accuracy, with an index less than an index of a prediction mode in an opposite direction of the j-th intra prediction mode by the first value, as the first similar prediction mode.

12. The method of claim 11, wherein if the preset modes similar to the j-th intra prediction mode comprise the second similar prediction mode, determining, based on the first angular accuracy, the intra prediction modes similar to the j-th intra prediction mode comprises:
if the j-th intra prediction mode is not a last angular prediction mode among the prediction modes corresponding to the first angular accuracy, determining a prediction mode, among the prediction modes corresponding to the first angular accuracy, with an index greater than the first index by the first value, as the second similar prediction mode;
wherein if the intra prediction modes similar to the j-th intra prediction mode comprise the second similar prediction mode, determining, based on the first angular accuracy, the intra prediction modes similar to the j-th intra prediction mode comprises:
if the j-th intra prediction mode is a last angular prediction mode among the prediction modes corresponding to the first angular accuracy, determining a prediction mode, among the prediction modes corresponding to the first angular accuracy, with an index greater than an index of a prediction mode in an opposite direction of the j-th intra prediction mode by the first value, as the second similar prediction mode.

13. The method of claim 10, wherein determining, based on the first angular accuracy, the intra prediction modes similar to the j-th intra prediction mode comprises:
determining a second numerical value and/or a third numerical value based on the first angular accuracy; and
determining the first similar prediction mode and/or the second similar prediction mode based on the second numerical value and/or the third numerical value.

14. The method of claim 13, wherein determining the first similar prediction mode and/or the second similar prediction mode based on the second numerical value and/or the third numerical value comprises:
calculating a sum of the first index of the j-th intra prediction mode and the second numerical value, and then subtracting a first preset value from the sum, to acquire a fourth numerical value; calculating a modulo of the fourth numerical value with respect to the third numerical value, and then adding a second preset value to the calculated modulo result, to acquire an index corresponding to the first similar prediction mode; and determining the first similar prediction mode from prediction modes corresponding to the first angular accuracy, based on the index corresponding to the first similar prediction mode; and
determining the second similar prediction mode based on the third numerical value.

15. The method of claim 13, wherein determining the second numerical value and/or the third numerical value based on the first angular accuracy comprises:
determining a value acquired by subtracting 4 from the first angular accuracy, as the second numerical value; and
determining a value acquired by subtracting 1 from the first angular accuracy, as the third numerical value.

16. The method of claim 1, wherein if a length of the intra prediction mode candidate list does not reach a preset length, the method further comprises:
determining a second angular accuracy corresponding to a default angular prediction mode;
if the second angular accuracy is different from the first angular accuracy, determining a second intra prediction mode corresponding to the default angular prediction mode at the first angular accuracy; and
adding the second intra prediction mode corresponding to the default angular prediction mode to the intra prediction mode candidate list.

17. A method for video encoding, comprising:
determining a first angular accuracy corresponding to an intra prediction mode candidate list for a current block, wherein the first angular accuracy indicates a search range of angular prediction modes in the intra prediction mode candidate list;
constructing the intra prediction mode candidate list based on the first angular accuracy; and
predicting the current block based on the intra prediction mode candidate list, to acquire a prediction value for the current block.

18. The method of claim 17, wherein determining the first angular accuracy corresponding to the intra prediction mode candidate list for the current block comprises:
determining a prediction manner used in prediction for the current block;
if the prediction manner is a template matching-based prediction manner, determining an angular accuracy corresponding to the prediction manner; and
determining the first angular accuracy based on the angular accuracy corresponding to the prediction manner, comprising:
determining the angular accuracy corresponding to the prediction manner as the first angular accuracy.

19. An apparatus for video decoding, comprising:
a processor, and
a memory, configured to store a computer program capable of running on the processor;
wherein the processor is configured to:
determine a first angular accuracy corresponding to an intra prediction mode candidate list for a current block, wherein the first angular accuracy indicates a search range of angular prediction modes in the intra prediction mode candidate list;
construct the intra prediction mode candidate list based on the first angular accuracy; and
predict the current block based on the intra prediction mode candidate list, to acquire a prediction value for the current block.

20. A non-transitory computer-readable storage medium storing a computer program that enables a computer to perform the method of claim 17 to generate and store a bitstream.
